(19) United States
(12) Patent Application Publication
(10) Pub. No.: US 2022/0292971 A1
(43) Pub. Date: Sep. 15, 2022

(54) ELECTRONIC APPARATUS, CONTROL METHOD OF ELECTRONIC APPARATUS, COMPUTER PROGRAM, AND COMPUTER-READABLE RECORDING MEDIUM

(71) Applicant: JIOH PARK, Seoul (KR)

(72) Inventor: JIOH PARK, Seoul (KR)

(21) Appl. No.: 17/694,360

(22) Filed: Mar. 14, 2022

(30) Foreign Application Priority Data
Mar. 14, 2021 (KR) 10-2021-0033061

(51) Int. Cl. G08G 1/14; G06V 20/58; G06T 17/00

(52) U.S. Cl. CPC G08G 1/143; G06V 20/586; G06T 17/00

(57) ABSTRACT

Disclosed herein is a method for providing a parking lot guidance service of a server. The method includes: receiving parking lot data including information of a parking space in a parking lot from an image capturing apparatus for a vehicle provided in the vehicle; generating a parking lot model representing a real-time parking situation of the parking lot as an image based on the received parking lot data; and providing the parking guidance service to a user terminal apparatus using the generated parking lot model.

### TECHNICAL FIELD

The following description relates to an electronic apparatus for autonomous driving/autonomous flight, a control method thereof, a computer program, and a computer readable recording medium.

### BACKGROUND ART

In accordance with the increase of computing power and development of a wireless communication technology and an image processing technology, there is a change in a transportation paradigm that transports passengers/cargos on the land and in the air. Accordingly, many studies and technology developments to perform autonomous driving/autonomous flight without intervention of a driver/piolet on the land or in the air are being made in various technical fields.

First, the autonomous driving refers to running of a vehicle without having a user input of a driver or a passenger. Such autonomous driving is classified into levels of monitoring a driving environment by a driver or a passenger and levels of monitoring a driving environment by an autonomous driving system related to a vehicle. For example, at levels in which the driver or the passenger monitors the driving environment includes Level 1 (a driver assistance level) corresponding to a level that a steering assistance system or acceleration/deceleration assistance system is executed in the vehicle, but the driver performs all the functions for dynamical driving task and Level 2 (partial automation level) that the steering assistance system or acceleration/deceleration system is executed in the vehicle, but the driving environment monitoring is performed by the manipulation of the driver. For example, levels of monitoring the driving environment by the autonomous driving system related to the vehicle include Level 3 (conditional automation level) that the autonomous driving system controls all the aspects of the manipulation related to the driving, but when the autonomous driving system requests the intervention of the driver, the user needs to control the vehicle, Level 4 (high automation level) that the autonomous driving system related to the vehicle performs the core control for driving, monitoring of a driving environment, and handles the emergency, but the driver is required to partially intervene, Level 5 (full automation) that the autonomous driving system related to the vehicle drives the vehicle in all roadway and environment conditions all the time.

However, even though the autonomous driving is developed, there may be still many limitations in transporting people or cargo through mobility that operates on the ground or underground due to the increase in population and traffic congestion in the urban area so that many attention is being paid to the development of the technology to transport people or cargo via AIR mobility in the urban area.

### DISCLOSURE

### Technical Problem

An object of the present invention is to provide an electronic apparatus, method, and system which update learning data for autonomous driving of a vehicle using vision data acquired by a camera and acquired driver manipulation data and provide vehicle autonomous driving function using the updated learning data in accordance with the development of computing power for the autonomous driving of the mobility such as a vehicle and the development of the machine learning technique.

An object of the present invention is to generate a parking lot model representing a real-time situation of a parking lot as an image using an image captured from an image capturing apparatus for a vehicle and provide a parking lot guidance service to a user terminal apparatus based on the generated parking lot model.

An object of the present invention is to provide an electronic apparatus, method, and system for providing an automatic parking function and a parked vehicle hailing service of the vehicle.

An object of the present invention is to provide an electronic apparatus, method, and system for providing a vehicle communication system for safe driving of the vehicle.

An object of the present invention is to provide a concept of an urban aircraft mobility structure, an urban aircraft mobility operation method, and an urban aircraft mobility control method.

### Technical Solution

According to an aspect of the present invention, a method for providing a parking lot guidance service of an image capturing apparatus for a vehicle may include: obtaining a parking lot image according to image capturing; generating parking lot data including information of a parking space in a parking lot using the parking lot image; and transmitting the generated parking lot data to a server for providing a parking lot guidance service, wherein the parking lot data is used to generate a parking lot model for service provision in the server for providing a parking lot guidance service.

The generating of the parking lot data may include: recognizing a location identifier making a location of the parking space in the parking lot identifiable and a parked vehicle parked in the parking space from the parking lot image; generating location information of the parking space based on the recognized location identifier; and generating information on whether or not the vehicle has been parked in a parking slot included in the parking space according to a location of the recognized parked vehicle.

The generating of the parking lot data may further include generating parked vehicle information including at least one of vehicle type information and vehicle number information for the recognized parked vehicle, and the parked vehicle information may be generated separately for each of a plurality of parking slots constituting the parking space.

The method for providing a parking lot guidance service may further include determining whether or not the parking lot data needs to be updated by sensing a change in the parking lot image as a parked vehicle exits from a parking slot included in the parking space or another vehicle enters a parking slot included in the parking space.

The method for providing a parking lot guidance service may further include: determining whether or not an impact event has occurred in a parked vehicle parked in the surrounding of an own vehicle; updating the parking lot data when it is determined that the impact event has occurred in the parked vehicle; and transmitting the updated parking lot data to the server for providing a parking lot guidance service, wherein the updated parking lot data includes data a predetermined time before and after an occurrence point in time of the impact event.

According to another aspect of the present invention, an image capturing apparatus for a vehicle may include: a communication unit; an image capturing unit obtaining a parking lot image according to image capturing; a parking lot data generation unit generating parking lot data including information of a parking space in a parking lot using the parking lot image; and a control unit controlling the communication unit to transmit the generated parking lot data to a server for providing a parking lot guidance service, wherein the parking lot data is used to generate a parking lot model for service provision in the server for providing a parking lot guidance service.

The parking lot data generation unit may include: an image processor recognizing a location identifier making a location of the parking space in the parking lot identifiable and a parked vehicle parked in the parking space from the parking lot image; and a parking lot location information generator generating location information of the parking space based on the recognized location identifier and generating information on whether or not the vehicle has been parked in a parking slot included in the parking space according to a location of the recognized parked vehicle.

The parking lot data generation unit may further include: a parked vehicle information generator generating parked vehicle information including at least one of vehicle type information and vehicle number information for the recognized parked vehicle, and the parked vehicle information may be generated separately for each of a plurality of parking slots constituting the parking space.

The control unit may determine whether or not the parking lot data needs to be updated by sensing a change in the parking lot image as a parked vehicle exits from a parking slot included in the parking space or another vehicle enters a parking slot included in the parking space.

The control unit may determine whether or not an impact event has occurred in a parked vehicle parked in the surrounding of an own vehicle, control the parking lot data generation unit to update the parking lot data when it is determined that the impact event has occurred in the parked vehicle, and control the communication unit to transmit the updated parking lot data to the server for providing a parking lot guidance service, and the updated parking lot data may include data a predetermined time before and after an occurrence point in time of the impact event.

According to still another aspect of the present invention, a method for providing a parking lot guidance service of a server includes: receiving parking lot data including information of a parking space in a parking lot from an image capturing apparatus for a vehicle provided in the vehicle; generating a parking lot model representing a real-time parking situation of the parking lot as an image based on the received parking lot data; and providing the parking guidance service to a user terminal apparatus using the generated parking lot model.

The information of the parking space may include location information of the parking space and information on whether or not a vehicle has been parked in a parking slot constituting the parking space, and the generating of the parking lot model may include: determining a location of the parking space in the parking lot based on the location information of the parking space; determining whether or not to dispose a vehicle model in the parking slot based on the information on whether or not the vehicle has been parked in the parking slot; and generating a parking lot model in which the vehicle model is disposed in the parking slot according to a determination result.

The parking lot data may include parked vehicle information including at least one of type information of a parked vehicle and number information of the parked vehicle, and the generating of the parking lot model may further include: generating a vehicle model reflecting at least one of a license plate and a vehicle type based on the parked vehicle information.

The generated parking lot model may be a three-dimensional (3D) model.

The method for providing a parking lot guidance service may further include updating the generated parking lot model, wherein in the updating, the parking lot model is updated by extracting only a difference portion between the generated parking lot model and a subsequently generated parking lot model and reflecting only the extracted difference portion.

The providing of the parking guidance service may include: detecting the parking lot model and the parking lot data corresponding to a parking lot in which a vehicle of a user of the user terminal apparatus that has accessed the server is parked; and providing at least one of a parking possible location guidance service, a vehicle parking location guidance service, and a parking lot route guidance service to the user terminal apparatus using the detected parking lot model and parking lot data.

The providing of the parking guidance service may include: transmitting a first vehicle impact event occurrence notification to an image capturing apparatus for a vehicle of a second vehicle located in the surrounding of a first vehicle parked in the parking lot when an impact event occurs in the first vehicle; receiving parking data from the image capturing apparatus for a vehicle of the second vehicle according to the notification; generating impact information on an impact situation of the first vehicle based on the parking data from the image capturing apparatus for a vehicle of the second vehicle; and providing a parking impact event guidance service based on the generated impact information.

According to yet still another aspect of the present invention, a server for providing a parking lot guidance service includes: a communication unit receiving parking lot data including information of a parking space in a parking lot from an image capturing apparatus for a vehicle provided in the vehicle; a parking lot model generation unit generating a parking lot model representing a real-time parking situation of the parking lot as an image based on the received parking lot data; and a control unit providing the parking guidance service to a user terminal apparatus using the generated parking lot model.

The information of the parking space may include location information of the parking space and information on whether or not a vehicle has been parked in a parking slot constituting the parking space, and the parking lot model generation unit may determine a location of the parking space in the parking lot based on the location information of the parking space, determine whether or not to dispose a vehicle model in the parking slot based on the information on whether or not the vehicle has been parked in the parking slot, and generate a parking lot model in which the vehicle model is disposed in the parking slot according to a determination result.

The parking lot data may include parked vehicle information including at least one of type information of a parked vehicle and number information of the parked vehicle, and the parking lot model generation unit may generate a vehicle model reflecting at least one of a license plate and a vehicle type based on the parked vehicle information.

The generated parking lot model may be a 3D model.

The parking lot model generation unit may update the parking lot model by extracting only a difference portion between the generated parking lot model and a subsequently generated parking lot model and reflecting only the extracted difference portion.

The control unit may detect the parking lot model and the parking lot data corresponding to a parking lot in which a vehicle of a user of the user terminal apparatus that has accessed the server is parked, and provide at least one of a parking possible location guidance service, a vehicle parking location guidance service, and a parking lot route guidance service to the user terminal apparatus using the detected parking lot model and parking lot data.

The communication unit may transmit a first vehicle impact event occurrence notification to an image capturing apparatus for a vehicle of a second vehicle located in the surrounding of a first vehicle parked in the parking lot when an impact event occurs in the first vehicle and receive parking data from the image capturing apparatus for a vehicle of the second vehicle according to the notification, and the control unit may generate impact information on an impact situation of the first vehicle based on the parking data from the image capturing apparatus for a vehicle of the second vehicle and provide a parking impact event guidance service based on the generated impact information.

According to yet still another aspect of the present invention, a method for providing a parking lot guidance service of a user terminal apparatus may include: accessing a server for providing a parking lot guidance service that provides a parking lot guidance service based on an image capturing apparatus for a vehicle; receiving a parking lot model representing a real-time parking situation of a parking lot as an image and parking lot data from the server for providing a parking lot guidance service; and generating a user interface based on the received parking lot model and parking lot data and displaying the generated user interface, wherein the user interface includes at least one of a parking possible location guidance user interface, a vehicle parking location guidance user interface, a parking lot route guidance user interface, and a parking impact event guidance user interface.

The parking possible location guidance user interface may be an interface that displays parking possible location information of a parking lot in which the user terminal apparatus is located on the parking lot model based on the parking lot data.

The parking lot route guidance user interface may be an interface that displays a route from a current location of a user to a parking location on the parking lot model based on parking location information of the user and location information of the user terminal apparatus in the parking lot.

The vehicle parking location guidance user interface may be an interface that displays parking location information of a user on the parking lot model based on the parking lot data.

The parking impact event guidance user interface may be an interface that displays impact information on a generated impact situation on the parking lot model based on parking lot data of an image capturing apparatus for a vehicle provided in another vehicle.

According to yet still another aspect of the present invention, a user terminal apparatus may include: a display unit; a communication unit accessing a server for providing a parking lot guidance service that provides a parking lot guidance service based on an image capturing apparatus for a vehicle and receiving a parking lot model representing a real-time parking situation of a parking lot as an image and parking lot data from the server for providing a parking lot guidance service; and a control unit generating a user interface based on the received parking lot model and parking lot data and controlling the display unit to display the generated user interface, wherein the user interface includes at least one of a parking possible location guidance user interface, a vehicle parking location guidance user interface, a parking lot route guidance user interface, and a parking impact event guidance user interface.

The parking possible location guidance user interface may be an interface that displays parking possible location information of a parking lot in which the user terminal apparatus is located on the parking lot model based on the parking lot data.

The parking lot route guidance user interface may be an interface that displays a route from a current location of a user to a parking location on the parking lot model based on parking location information of the user and location information of the user terminal apparatus in the parking lot.

The vehicle parking location guidance user interface may be an interface that displays parking location information of a user on the parking lot model based on the parking lot data.

The parking impact event guidance user interface may be an interface that displays impact information on a generated impact situation on the parking lot model based on parking lot data of an image capturing apparatus for a vehicle provided in another vehicle.

According to yet still another embodiment of the present invention, a computer-readable recording medium may record a program for executing the method for providing a parking lot guidance service described above.

According to yet still another embodiment of the present invention, a program stored in a recording medium may include a program code for executing the method for providing a parking lot guidance service described above.

### Advantageous Effects

According to various embodiments, the electronic apparatus, method, and computer readable storage medium use information acquired at a time when an autonomous driving disengagement event occurs as learning data for autonomous driving to improve a performance of a deep learning model for an autonomous vehicle.

According to various embodiments, the electronic apparatus, method, and computer readable storage medium efficiently provide an autonomous parking function of a vehicle and a parked vehicle hailing service to a user.

According to various embodiments, the electronic apparatus, method, and computer readable storage medium provide a vehicle communication service for safety driving of the vehicle to have a high security.

According to various embodiments, the electronic apparatus, method, and computer readable storage medium provide a safe urban air mobility structure, a safe urban air mobility operation method, and an urban air mobility control method.

A technical object to be achieved by the present disclosure is not limited to the aforementioned effects, and another not-mentioned effects will be obviously understood by those skilled in the art from the description below.

### DESCRIPTION OF THE DRAWINGS

FIG. 1 is a block diagram illustrating a parking lot guidance service system according to an embodiment of the present invention;

FIG. 2 is a block diagram illustrating an image capturing apparatus for a vehicle according to an embodiment of the present invention;

FIG. 3 is a block diagram illustrating a parking lot data generation unit according to an embodiment of the present invention in more detail;

FIG. 4 is a view illustrating a configuration of a neural network according to an embodiment of the present invention;

FIG. 5 is a view illustrating an image of a parking lot according to an embodiment of the present invention;

FIG. 6 is a block diagram illustrating a server for providing a parking lot guidance service according to an embodiment of the present invention;

FIG. 7 is a view illustrating a parking lot model according to an embodiment of the present invention;

FIG. 8 is an illustrative view illustrating a parking impact event occurrence situation according to an embodiment of the present invention;

FIG. 9 is a block diagram illustrating a user terminal apparatus according to an embodiment of the present invention;

FIG. 10 is a timing diagram illustrating a method for providing a parking lot guidance service according to an embodiment of the present invention;

FIG. 11 is a timing diagram illustrating a method for providing a parking lot guidance service according to another embodiment of the present invention;

FIGS. 12 to 13B are views illustrating a user interface according to an embodiment of the present invention;

FIG. 14 is a timing diagram illustrating a method for providing a parking lot payment service according to still another embodiment of the present invention;

FIG. 15 is a block diagram illustrating an autonomous driving system of a vehicle according to an embodiment of the present invention;

FIG. 16 is a block diagram of an autonomous driving system according to another embodiment of the present invention;

FIG. 17 is a block diagram of a user terminal apparatus according to another embodiment of the present invention;

FIG. 18 is a block diagram of a server for providing a service according to another embodiment of the present invention;

FIG. 19 is a flowchart for describing a flow of operations of an autonomous parking system according to another embodiment of the present invention;

FIG. 20 is a flowchart for describing a flow of autonomous parking operations of a user terminal apparatus according to another embodiment of the present invention;

FIG. 21 is a flowchart for describing a flow of autonomous parking operations of a server for providing a service according to another embodiment of the present invention;

FIGS. 22A and 22B are flowcharts for describing a flow of operations for providing a vehicle hailing service or a passenger pick-up service of an autonomous driving system according to another embodiment of the present invention;

FIG. 23 is a view for describing a process in which an autonomous driving system of a vehicle performs autonomous parking according to another embodiment of the present invention;

FIG. 24 is a view illustrating a UX screen displayed on a user terminal apparatus when an autonomous parking system of the vehicle performs autonomous parking according to another embodiment of the present invention;

FIG. 25 is a view illustrating an example of a push notification or a push message displayed on a user terminal apparatus of a user using an autonomous parking service/vehicle hailing service of a vehicle according to another embodiment of the present invention;

FIG. 26 is a view illustrating an example of a push notification or a push message displayed on a user terminal apparatus of a user using an autonomous parking service of a vehicle according to another embodiment of the present invention; and

FIG. 27 is a view for describing an example in which a server for providing an autonomous parking service identifies a parking possible space through deep learning analysis when an autonomous parking service of a vehicle is requested according to another embodiment of the present invention.

FIG. 28 is a block diagram illustrating an autonomous driving system 2800 of a vehicle according to an embodiment.

FIG. 29 is a block diagram of an electronic device 2900 according to an embodiment.

FIG. 30 is a block diagram of a server 3000 according to an embodiment.

FIG. 31 is a flowchart of a signal for describing an operation of an autonomous driving system according to various embodiments.

FIG. 32 is a flowchart of a signal for describing an operation of a server according to various embodiments.

FIG. 33 is a block diagram of an autonomous driving system according to an embodiment.

FIG. 34 is a block diagram of a server according to an embodiment.

FIG. 35 is an operation flowchart of an autonomous driving system according to an embodiment.

FIG. 36 is an operation flowchart of an electronic apparatus according to an embodiment.

FIG. 37 is a block diagram of an object detection module that detects an object through image data acquired from a vision sensor mounted in a vehicle by an electronic apparatus according to an embodiment.

FIG. 38 is an operation flowchart of a server according to an embodiment.

FIG. 39 is a view for illustrating a conception of transmitting/receiving information about a generated event when an event occurs in a vehicle driving on a road according to an embodiment.

FIG. 40 is an operation flowchart of a source vehicle in which event occurs according to an embodiment.

FIG. 41 is an operation flowchart of a receiving vehicle according to an embodiment.

FIG. 42 is a view for explaining a vehicle communication system structure according to an embodiment.

FIG. 43 is an operation flowchart of a receiving vehicle according to an embodiment.

FIG. 44 is an operation flowchart of a receiving vehicle according to an embodiment.

FIG. 45 is an operation flowchart of a receiving vehicle according to an embodiment.

FIG. 46 is an operation flowchart of a source vehicle according to an embodiment.

FIG. 47 is an operation flowchart of a RSU according to an embodiment.

FIG. 48 is a block diagram of a RSU according to an embodiment.

FIG. 49 is a block diagram of an electronic device of a vehicle according to an embodiment.

FIG. 50 illustrates an example of a vehicle including an electronic device according to various embodiments.

FIG. 51 illustrates an example of a functional configuration of an electronic device according to various embodiments.

FIG. 52 illustrates an example of a gateway related to an electronic device according to various embodiments.

FIG. 53 is an operation flowchart of an autonomous driving system of a vehicle according to an embodiment.

FIG. 54 is a view illustrating a screen that displays information required for flight and a flight route in UAM according to an embodiment.

FIG. 55 illustrates that weather information (for example, gale) which may affect the flight of UAM is represented by AR according to an embodiment.

FIG. 56 is a view for describing that as a flight route of the UAM, a corridor 5602 which is a flight passage for every altitude is set and UAM flies only through the set flight passage 5602 according to an embodiment.

FIG. 57 is a view for describing a flight passage allocated to allow the UAM to take off and land at a vertiport according to an embodiment.

FIG. 58 is a view illustrating that a flight route recommended to the UAM is represented by way points 5810 at every interval according to an embodiment.

FIG. 59 is a view illustrating that flight passages 5930 and 5950 having different flight altitudes are set to every UAM departing from vertiports 5970 and 5980 according to an embodiment.

FIG. 60 is a view illustrating a flight route allocated to an UAM flying between vertiports 6002 and 6004 according to an embodiment.

FIG. 61 is a block diagram illustrating a configuration of an unmanned aerial vehicle according to an embodiment.

FIG. 62 is a view for describing an architecture of a system for managing flight of an UAM according to an embodiment.

FIG. 63 is a view illustrating an UX screen for reserving an UAM operating to a location desired by a user through an electronic apparatus according to an embodiment.

FIG. 64 is a view illustrating an UX screen for providing information related to an UAM reserved by a user through an electronic apparatus according to an embodiment.

### DETAILED DESCRIPTION

The following description illustrates only a principle of the present invention. Therefore, those skilled in the art may implement the principle of the present invention and invent various apparatuses included in the spirit and scope of the present invention although not clearly described or illustrated in the present specification. In addition, it is to be understood that all conditional terms and embodiments mentioned in the present specification are obviously intended only to allow those skilled in the art to understand a concept of the present invention in principle, and the present invention is not limited to embodiments and states particularly mentioned as such.

Further, it is to be understood that all detailed descriptions mentioning specific embodiments of the present invention as well as principles, aspects, and embodiments of the present invention are intended to include structural and functional equivalences thereof. Further, it is to be understood that these equivalences include an equivalence that will be developed in the future as well as an equivalence that is currently well-known, that is, all elements invented so as to perform the same function regardless of a structure.

Therefore, it is to be understood that, for example, block diagrams of the present specification illustrate a conceptual aspect of an illustrative circuit for embodying a principle of the present invention. Similarly, it is to be understood that all flowcharts, state transition diagrams, pseudo-codes, and the like, illustrate various processes that may be tangibly embodied in a computer-readable medium and that are executed by computers or processors regardless of whether or not the computers or the processors are clearly illustrated.

Functions of various elements including processors or functional blocks represented as concepts similar to the processors and illustrated in the accompanying drawings may be provided using hardware having capability to execute appropriate software as well as dedicated hardware. When the functions are provided by the processors, they may be provided by a single dedicated processor, a single shared processor, or a plurality of individual processors, and some of them may be shared with each other.

In addition, it is to be understood that terms mentioned as a processor, control, or a concept similar to the processor or the control are not interpreted to exclusively cite hardware having capability to execute software, and are implicitly include digital signal processor (DSP) hardware and a read only memory (ROM), a random access memory (RAM), and a non-volatile memory for storing software without being limited thereto. The abovementioned terms may also include well-known other hardware.

In the claims of the present specification, components represented as means for performing functions mentioned in a detailed description are intended to include all methods of performing functions including all types of software including, for example, a combination of circuit elements performing these functions, firmware/micro codes, or the like, and are coupled to appropriate circuits for executing the software so as to execute these functions. It is to be understood that since functions provided by variously mentioned means are combined with each other and are combined with a method demanded by the claims in the present invention defined by the claims, any means capable of providing these functions are equivalent to means recognized from the present specification.

The abovementioned objects, features, and advantages will become more obvious from the following detailed description associated with the accompanying drawings. Therefore, those skilled in the art to which the present invention pertains may easily practice a technical idea of the present invention. Further, in describing the present invention, when it is decided that a detailed description of the well-known technology associated with the present invention may unnecessarily make the gist of the present invention unclear, it will be omitted.

Hereinafter, various embodiments of the present invention will be described in detail with reference to the accompanying drawings.

It should be understood that various embodiments of the specification and terms used therefor are not intended to limit the technology described in the specification to specific embodiments, but include various changes, equivalents and/or substitutions of the embodiments. With regard to the description of drawings, like reference numerals denote like components. A singular form may include a plural form if there is no clearly opposite meaning in the context. In the specification, the terms “A or B”, “at least one of A or/and B”, or “at least one or more of A or/and B” may include all possible combinations of enumerated items. Although the terms “first”, “second”, and the like, may be used to describe various components regardless of an order and importance, the components are not limited by these terms. These terms are only used to distinguish one component from another. For example, when it is mentioned that some (for example, a first) component is “(functionally or communicably) “connected” or “coupled” to the other (for example, a second) component, some component may be connected to the other component directly or through another component (for example, a third component).

The term used in the specification “module” includes a unit configured by hardware, software, or firmware and for example, may be exchangeably used with a term such as a logic, a logic block, a part, or a circuit. The module may be an integrally configured component, or a minimum unit which performs one or more functions, or a part thereof. For example, the module may be configured by an application-specific integrated circuit (ASIC).

### I. Autonomous Parking System and Vehicle Summon Service

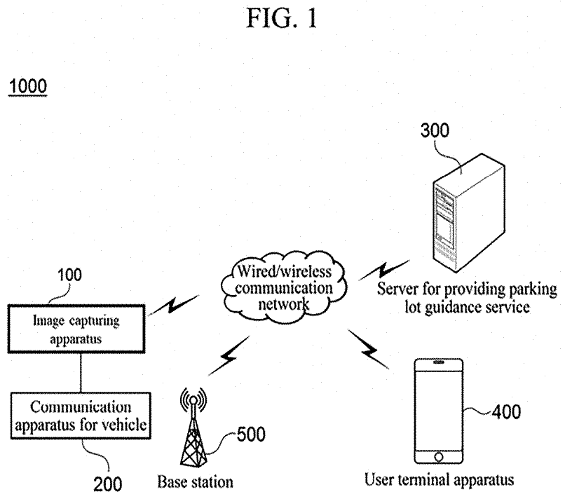

FIG. 1 is a block diagram illustrating a parking lot guidance service system according to an embodiment of the present invention. Referring to FIG. 1, a parking lot guidance service system 1000 includes an image capturing apparatus 100 for a vehicle, a communication apparatus 200 for a vehicle, a server 300 for providing a parking lot guidance service, a user terminal apparatus 400, and a base station 500.

Such a parking lot guidance service system 1000 may generate a parking lot model representing a real-time situation for a parking lot by using an image captured by the image capturing apparatus 100 for a vehicle, and provide a parking lot guidance service to the user terminal apparatus 400 based on the generated parking lot model.

Here, the parking lot may be a concept including both an indoor parking lot and an outdoor parking lot.

In addition, the parking lot may include one or more floors, each floor may include a plurality of parking spaces, and each of the parking spaces may include a plurality of parking slots.

In the present invention, the vehicle is an example of a moving body, but the moving body according to the present invention is not limited to the vehicle. The moving body according to the present invention may include various objects that may move, such as a vehicle, a person, a bicycle, a ship, and a train. Hereinafter, for convenience of explanation, a case where the moving object is the vehicle will be described by way of example.

The base station 500 is a wireless communication facility connecting a network and various terminals to each other for a wireless communication service, and may enable communication between the image capturing apparatus 100 for a vehicle, the communication apparatus 200 for a vehicle, the server 300 for providing a parking lot guidance service, and the user terminal apparatus 400 that constitute the parking lot guidance service system 1000 according to the present invention. As an example, the communication apparatus 200 for a vehicle may be wirelessly connected to a communication network through the base station 500, and when the communication apparatus 200 for a vehicle is connected to the communication network, the communication apparatus 200 for a vehicle may exchange data with other devices (e.g., the server 300 for providing a parking lot guidance service and the user terminal apparatus 400) connected to the communication network.

The image capturing apparatus 100 for a vehicle may be provided in the vehicle to capture an image in a situation such as driving, stopping, or parking of the vehicle and store the captured image.

In addition, the image capturing apparatus 100 for a vehicle may be controlled by a user control input through the user terminal apparatus 400. For example, when a user selects an executable object installed in the user terminal apparatus 400, the image capturing apparatus 100 for a vehicle may perform operations corresponding to an event generated by a user input for the executable object. Here, the executable object may be a kind of application that may be installed in the user terminal apparatus 400 to remotely control the image capturing apparatus 100 for a vehicle.

In addition, in the present specification, an action that triggers an operation of the image capturing apparatus 100 for a vehicle is defined as an event. For example, a type of the event may be impact sensing, noise sensing, motion sensing, user gesture sensing, user touch sensing, reception of a control command from a remote place, and the like. Here, the image capturing apparatus 100 for a vehicle may include all or some a front image capturing apparatus of capturing an image of the front of the vehicle, a rear image capturing apparatus of capturing an image of the rear of the vehicle, side image capturing apparatuses of capturing images of left and right sides of the vehicle, an image capturing apparatus of capturing an image of a face of a vehicle driver, and an interior image capturing apparatus of capturing an image of the interior of the vehicle.

In the present specification, an infrared (Infra-Red) camera for a vehicle, a black-box for a vehicle, a car dash cam, or a car video recorder are other expressions of the image capturing apparatus 100 for a vehicle and may have the same meaning.

The communication apparatus 200 for a vehicle is an apparatus connected to the image capturing apparatus 100 for a vehicle to enable communication of the image capturing apparatus 100 for a vehicle, and the image capturing apparatus 100 for a vehicle may perform communication with an external server through the communication apparatus 200 for a vehicle. Here, the communication apparatus 200 for a vehicle may use various wireless communication connection methods, for example, a cellular mobile communication method such as long term evolution (LTE) and a wireless local area network (WLAN) method such as wireless fidelity (WiFi).

In addition, according to an embodiment of the present invention, the communication apparatus 200 for a vehicle that performs wireless communication with the server may be implemented as a communication module using a low-power wide-area (LPWA) technology. Here, as an example of the low-power wide-area communication technology, a low-power wide-band wireless communication module such as long range (LoRa), narrow band-Internet of things (NB-IoT), or Cat M1 may be used.

Meanwhile, the communication apparatus 200 for a vehicle according to an embodiment of the present invention may also perform a location tracking function like a global positioning system (GPS) tracker.

In addition, it has been described by way of example in FIG. 1 that the communication apparatus 200 for a vehicle is an external apparatus provided separately from the image capturing apparatus 100 for a vehicle, but the communication apparatus 200 for a vehicle is not limited thereto, and may be implemented as an internal communication module provided inside the image capturing apparatus 100 for a vehicle.

In the present specification, a dongle is another expression of the communication apparatus 200 for a vehicle, and the dongle and the communication apparatus 200 for a vehicle may have the same meaning.

The server 300 for providing a parking lot guidance service may relay various data between the communication apparatus 200 for a vehicle and the user terminal apparatus 400 to enable a parking lot guidance service to be described later.

Specifically, the server 300 for providing a parking lot guidance service may receive data including an image captured by the image capturing apparatus 100 for a vehicle and various information generated by the image capturing apparatus 100 for a vehicle from the communication apparatus 200 for a vehicle.

In addition, the server 300 for providing a parking lot guidance service may match and store the received data to parking lot identification information. Here, the parking lot identification information may refer to information that makes a plurality of parking lots distinguishable from each other, such as a parking lot ID, a parking lot name, a parking lot phone number, and a parking lot location.

In addition, the server 300 for providing a parking lot guidance service may generate a parking lot model representing a real-time situation of a parking lot as an image based on the received data, and transmit various data for providing the parking lot guidance service to the user terminal apparatus 400 subscribed to the parking lot guidance service based on the generated parking lot model.

Here, the parking lot guidance service may include a parking slot location guidance service, a parking possible location guidance service, a vehicle parking location guidance service, a parking lot route guidance service, and a parking impact event guidance service.

The parking possible location guidance service may be a service that guides a parking possible location such as a parking possible space of a parking lot, the number of parking possible floors, and a parking possible slot to a user who wants to park the vehicle.

In addition, the vehicle parking location guidance service may be a service that guides a vehicle parking location to a user who wants to find a parked vehicle.

In addition, the parking lot route guidance service may be a service that guides a route from a parking location of the vehicle to a destination (e.g., an exit of the parking lot, etc.).

In addition, the parking impact event guidance service may be a service that provides information regarding a parking impact based on an image captured by an adjacent surrounding vehicle when an impact event occurs in a parked vehicle.

The user terminal apparatus 400 may display, on a screen, a user interface providing various meaningful information based on the data received from the server 300 for providing a parking lot guidance service.

Specifically, an application according to the present invention (hereinafter, referred to as a “parking lot guidance service application”) may be installed in the user terminal apparatus 400, the user may execute the parking lot guidance service application installed in the user terminal apparatus 400, and a user interface may be configured and displayed on the screen based on various data received from the server 300 for providing a parking lot guidance service according to the execution of the application.

Here, the user interface may include a user interface corresponding to the parking possible location guidance service, a user interface corresponding to the vehicle parking location guidance service, a user interface corresponding to the parking lot route guidance service, and a user interface corresponding to the parking impact event guidance service.

Here, the user terminal apparatus 400 may be implemented as a smartphone, a tablet personal computer, a laptop computer, a personal digital assistant (PDA), a portable multimedia player (PMP), or the like, or be implemented as a wearable device such as a smart glasses or a head mounted display (HMD) that may be worn on a user's body.

Here, the user may be a person having management authority for the vehicle and/or image capturing apparatus 100 for a vehicle, such as a vehicle owner, a vehicle driver, an owner of the image capturing apparatus 100 for a vehicle, or a supervisor of the image capturing apparatus 100 for a vehicle.

Hereinafter, the image capturing apparatus 100 for a vehicle, the server 300 for providing a parking lot guidance service and the user terminal apparatus 400 according to an embodiment of the present invention will be described in more detail with reference to the drawings.

It has been described that the server 300 for providing a parking lot guidance service according to an embodiment of the present invention described above determines the parking possible location through analysis of the image obtained through the image capturing apparatus 100 for a vehicle mounted in the vehicle, but in another embodiment of the present invention, a parking possible space may be identified through deep learning analysis of a parking lot image obtained through a fixed image obtaining apparatus such as a closed circuit television (CCTV) installed in the parking lot, and an autonomous parking service may be provided to a user terminal apparatus and/or an autonomous driving system using the identified parking possible space.

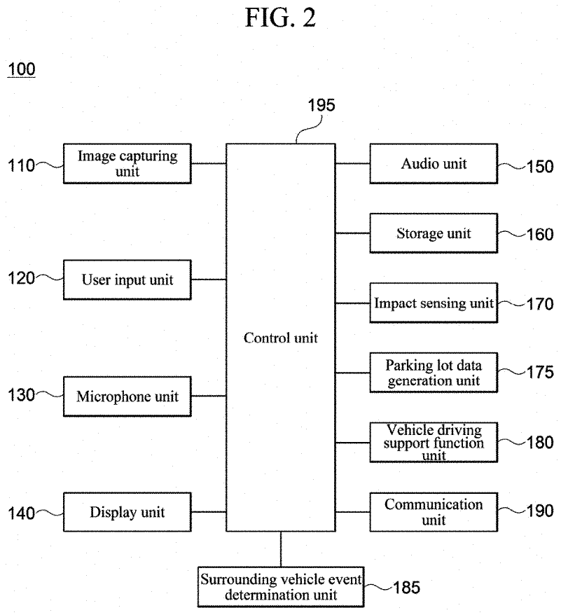

FIG. 2 is a block diagram illustrating an image capturing apparatus for a vehicle according to an embodiment of the present invention. Referring to FIG. 2, the image capturing apparatus 100 for a vehicle may include an image capturing unit 110, a user input unit 120, a microphone unit 130, a display unit 140, an audio unit 150, a storage unit 160, an impact sensing unit 170, a parking lot data generation unit 175, a vehicle driving support function unit 180, a surrounding vehicle event determination unit 185, a communication unit 190, and a control unit 195.

The image capturing unit 110 may capture an image in at least one situation of parking, stopping, and driving of the vehicle.

Here, the captured image may include a parking lot image, which is a captured image regarding the parking lot. The parking lot image may include an image captured during a period from a point in time when the vehicle enters the parking lot to a point in time when the vehicle exits from the parking lot. That is, the parking lot image may include an image captured from the point in time when the vehicle enters the parking lot to a point in time when the vehicle is parked (e.g., a point in time when an engine of the vehicle is turned off in order to park the vehicle), an image captured during a period in which the vehicle is parked, and an image captured from a parking completion point in time of the vehicle (e.g., a point in time when the engine of the vehicle is turned on in order for the vehicle to exit from the parking lot) to the point in time when the vehicle exits from the parking lot.

In addition, the captured image may include an image of at least one of the front, the rear, the sides, and the interior of the vehicle.

In addition, the image capturing unit 110 may include an infrared camera capable of monitoring a driver's face or pupil, and the control unit 195 may determine a driver's state including whether or not the driver is drowsy by monitoring the driver's face or pupil through the infrared camera.

Such an image capturing unit 110 may include a lens unit and an image capturing element. The lens unit may perform a function of condensing an optical signal, and the optical signal transmitted through the lens unit arrives at an image capturing area of the image capturing element to form an optical image. Here, as the image capturing element, a charge coupled apparatus (CCD), a complementary metal oxide semiconductor image sensor (CIS), a high-speed image sensor, or the like, that converts an optical signal into an electrical signal may be used. In addition, the image capturing unit 110 may further include all or some of a lens unit driving unit, a diaphragm, a diaphragm driving unit, an image capturing element control unit, and an image processor.

The user input unit 120 is a component that receives various user inputs for operating the image capturing apparatus 100 for a vehicle, and may receive various user inputs such as a user input for setting an operation mode of the image capturing apparatus 100 for a vehicle, a user input for displaying a recorded image on the display unit 140, and a user input for setting manual recording.

Here, the operation mode of the image capturing apparatus 100 for a vehicle may include a continuous recording mode, an event recording mode, a manual recording mode, and a parking recording mode.

The continuous recording mode is a mode executed when the user turns on the engine of the vehicle and starts to drive the vehicle, and may be maintained while the vehicle continues to be driven. In the continuous recording mode, the image capturing apparatus 100 for a vehicle may perform recording in a predetermined time unit (e.g., 1 to 5 minutes). In the present invention, the continuous recording mode and a regular mode may be used as the same meaning.

The parking recording mode may refer to a mode operated in a parked state of the vehicle in which the engine of the vehicle is turned off or the supply of power from a battery for driving the vehicle is stopped. In the parking recording mode, the image capturing apparatus 100 for a vehicle may operate in a parking continuous recording mode of performing regular recording during parking of the vehicle. In addition, in the parking recording mode, the image capturing apparatus 100 for a vehicle may operate in a parking event recording mode of performing recording when an impact event is sensed during the parking of the vehicle. In this case, recording for a predetermined period from a predetermined time before the occurrence of the event to a predetermined time after the occurrence of the event (e.g., recording from 10 seconds before the occurrence of the event to 10 seconds after the occurrence of the event) may be performed. In the present invention, the parking recording mode and a parking mode may be used as the same meaning.

The event recording mode may refer to a mode operated when various events occur during driving of the vehicle.

As an example, when the impact event is sensed by the impact sensing unit 170 or an advanced driving assistance system (ADAS) event is sensed by the vehicle driving support function unit 180, the event recording mode may operate.

In the event recording mode, the image capturing apparatus 100 for a vehicle may perform recording from a predetermined time before the occurrence of the event to a predetermined time after the occurrence of the event (e.g., recording from 10 seconds before the occurrence of the event to 10 seconds after the occurrence of the event).

The manual recording mode may refer to a mode in which the user manually operates recording. In the manual recording mode, the image capturing apparatus 100 for a vehicle may perform recording from a predetermined time before the occurrence of a manual recording request of the user to a predetermined time after the occurrence of the manual recording request of the user (e.g., recording from 10 seconds before the occurrence of the event to 10 seconds after the occurrence of the event).

Here, the user input unit 120 may be configured in various manner capable of receiving a user input, such as a keypad, a dome switch, a touch pad, a jog wheel, and a jog switch.

The microphone unit 130 may receive a sound generated outside or inside the vehicle. Here, the received sound may be a sound generated by an external impact or a human voice related to a situation inside/outside the vehicle, and may help to recognize the situation at that time together with the image captured by the image capturing unit 110. The sound received through the microphone unit 130 may be stored in the storage unit 160.

The display unit 140 may display various information processed by the image capturing apparatus 100 for a vehicle. As an example, the display unit may display a “live view image”, which is an image captured in real time by the image capturing unit 110, and may display a setting screen for setting an operation mode of the image capturing apparatus 100 for a vehicle.

The audio unit 150 may output audio data received from an external apparatus or stored in the storage unit 140. Here, the audio unit 150 may be implemented as a speaker outputting audio data. As an example, the audio unit 150 may output audio data indicating that a parking event has occurred.

The storage unit 160 stores various data and programs necessary for an operation of the image capturing apparatus 100 for a vehicle. In particular, the storage unit 160 may store the image captured by the image capturing unit 110, voice data input through the microphone unit 130, and parking data generated by the parking lot data generation unit 175.

In addition, the storage unit 160 may classify and store data obtained according to an operation mode of the image capturing apparatus 100 for a vehicle into and in different storage areas.

Such a storage unit 160 may be configured inside the image capturing apparatus 100 for a vehicle, may be detachably configured through a port provided in the image capturing apparatus 100 for a vehicle, or may exist outside the image capturing apparatus 100 for a vehicle. When the storage unit 160 is configured inside the image capturing apparatus 100 for a vehicle, the storage unit 160 may exist in the form of a hard disk drive or a flash memory. When the storage unit 160 is detachably configured in the image capturing apparatus 100 for a vehicle, the storage unit 160 may exist in the form of a secure digital (SD) card, a micro SD card, a universal serial bus (USB) memory, or the like. When the storage unit 160 is configured outside the image capturing apparatus 100 for a vehicle, the storage unit 160 may exist in a storage space provided in another apparatus or a database server through the communication unit 190.

The impact sensing unit 170 may sense an impact applied to the vehicle or sense a case where an amount of change in acceleration is a predetermined value or more. Here, the impact sensing unit 170 may include an acceleration sensor, a geomagnetic sensor, or the like in order to sense the impact or the acceleration.

The vehicle driving support function unit 180 may determine whether or not a driving assistance function is necessary for the driver of the vehicle based on a driving image captured by the image capturing unit 110.

For example, the vehicle driving support function unit 180 may sense the start of a vehicle located in front of the vehicle based on the driving image captured by the image capturing unit 110, and determine whether or not a forward vehicle start alarm (FVSA) is required for the driver. When a predetermined time elapses after a forward vehicle has started, the vehicle driving support function unit 180 may determine that a forward vehicle start alarm is necessary.

In addition, the vehicle driving support function unit 180 may sense whether or not a signal has been changed based on the driving image captured by the image capturing unit 110, and determine whether a traffic light change alarm (TLCA) is necessary for the driver. As an example, when a stop state (0 km/h) is maintained for 4 seconds in a state in which the signal is changed from a stop signal to a straight movement signal, the vehicle driving support function unit 180 may determine that the traffic light change alarm is necessary.

In addition, the vehicle driving support function unit 180 may sense whether or not the vehicle departs from a lane based on the driving image captured by the image capturing unit 110, and determine whether a lane departure warning system (LDWS) is required for the driver. As an example, when the vehicle deviates from the lane, the vehicle driving support function unit 180 may determine that the lane departure warning system is necessary.

In addition, the vehicle driving support function unit 180 may sense a risk of collision between the vehicle and the forward vehicle based on the driving image captured by the image capturing unit 110, and determine whether or not a forward collision warning system (FCWS) is necessary for the driver. As an example, the vehicle driving support function unit 180 may determine that a primary forward collision warning system is necessary when sensing an initial forward collision risk, and determine that a secondary forward collision warning system is necessary when an interval between the vehicle and the forward vehicle is further reduced after sensing the initial forward collision risk.

Here, the forward collision warning system may further include an urban FCWS (uFCWS) that provides the forward collision warning system at a lower driving speed so as to be suitable for an environment in which a driving speed is low.

Meanwhile, the parking lot data generation unit 175 may generate parking lot data during a period from a point in time when the vehicle enters the parking lot (in other words, an entry point in time) to a point in time when the vehicle exits from the parking lot (in other words, an exit point in time).

Here, the parking lot data may include at least one of parking lot location information, parking space information, parked vehicle information, own vehicle location information, time information, and a parking lot image.

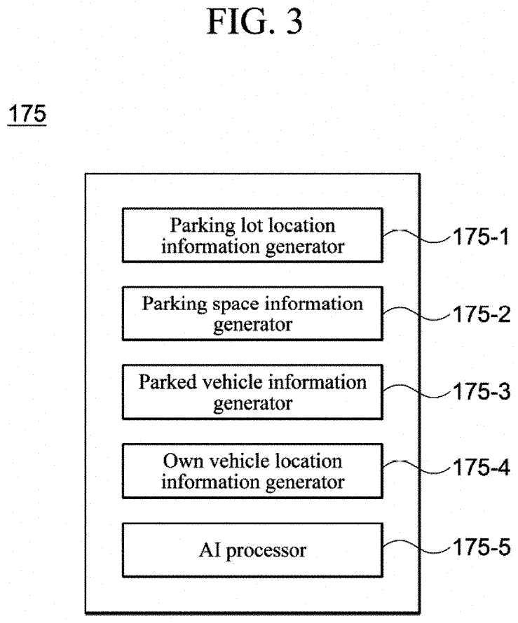

Specifically, referring to FIG. 3, the parking lot data generation unit 175 may include a parking lot location information generator 175-1, a parking space information generator 175-2, a parked vehicle information generator 175-3, an own vehicle location information generator 175-4, and an artificial intelligence (AI) processor 175-5.

The parking lot location information generator 175-1 may determine a location of the parking lot and generate the parking lot location information. As an example, when the vehicle is located in an outdoor parking lot, the parking lot location information generator 175-1 may generate location information of the outdoor parking lot using satellite positioning data. As another example, when the vehicle is located in an indoor parking lot, the parking lot location information generator 175-1 may generate location information of the indoor parking lot based on the last reception point of satellite positioning data, generate location information of the indoor parking lot based on positioning information using base stations of a cellular network located in the indoor parking lot, or generate location information of the indoor parking lot based on positioning information using access points of a WiFi network located in the indoor parking lot.

The parking space information generator 175-2 may include location information of a parking space and parking slot information of the parking space for a parking space included in the parking lot image. Here, the parking slot information may be extracted by identifying parking slots existing in the parking space from the parking lot image, and may include information on the number of parking slots, parking slot identification information, and information on whether or not the vehicles are parked in the parking slots. The parking space information generator 175-2 according to an embodiment of the present invention may identify the parking slot information using edge detection, feature point detection, a deep learning result for marked lines of the parking slots, or a deep learning result for parked vehicles in an image included in the parking lot image.

Specifically, the parking space information generator 175-2 may generate the location information of the parking space included in the parking lot image based on a location identifier included in the parking lot image.

Here, the location identifier is information included in the parking lot image to enable identification of the location of the parking space in the parking lot, and may include at least one of a text (e.g., a text such as a “parking lot entrance”, a “3rd floor”, or “3B-2”), a structure (e.g., a parking crossing gate, a parking tollbooth, etc.), and a unique identification symbol (e.g., a specific QR code, a specific sticker, a specific text, etc.) with a defined location.

That is, the parking space information generator 175-2 may generate the location information of the parking space included in the parking lot image based on the location identifier recognized through analysis of the captured image. As an example, when location identifiers of “3B-1” and “3B-2” are marked on both side pillars of the parking space, the parking space information generator 175-2 may generate information of a parking space between “3B-1” and “3B-2” as location information of the corresponding parking space.

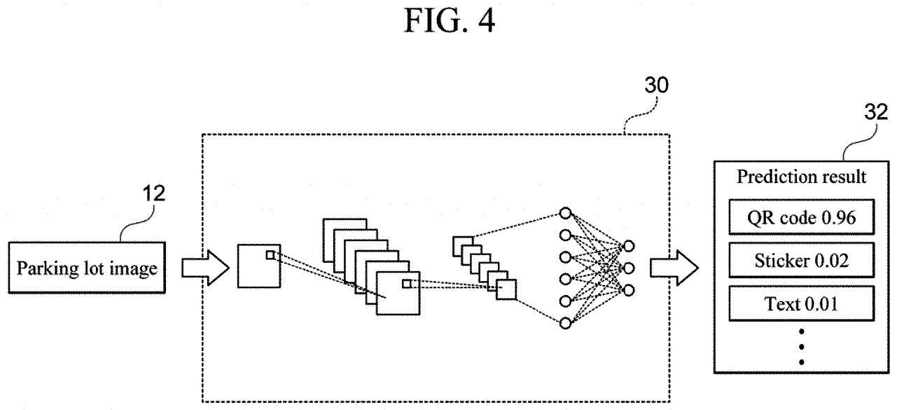

In this case, the parking space information generator 175-2 may recognize the location identifier using a learned neural network of the AI processor 175-5 so as to calculate a prediction result for whether or not the location identifier exists in the captured image. An example of such an artificial neural network will be described in more detail with reference to FIG. 4.

FIG. 4 is an illustrative view illustrating a configuration of a neural network according to an embodiment of the present invention.

Referring to FIG. 4, a neural network 30 according to the present embodiment may be configured as a convolution neural network (CNN) model including layers performing a plurality of convolution operations.

When a parking lot image 12 is input to the neural network 30, feature values according to a unique shape or color indicating a location identifier included in the parking lot image while passing through the layers inside the neural network 30 may be emphasized through convolution.

Various feature values included in the parking lot image as the location identifier may be output in the form of a new feature map through an operation with a filter determined for each convolution layer, and a final feature map generated through an iterative operation for each layer may be input to and flattened in a fully-connected layer. A difference between the flattened feature information and reference feature information defined for each location identifier may be calculated, and an existence probability of the location identifier may be output as a prediction result 32 according to the calculated difference.

In this case, in order to increase accuracy, the parking lot image may be divided and input to the neural network 30. As an example, since the location identifier is generally marked in a non-parking space (e.g., a pillar, etc.) rather than a parking space in which the vehicle is parked, according to the present invention, only a non-parking space image in the parking lot image may be divided and input to the neural network 30.

The learning of the neural network 30 may be performed using a learning data set classified for each location identifier as labeling data including parking lot image data and a determination result for whether or not the location identifier exists. For example, the neural network may be learned using a plurality of driving image data labeled as data in which each of a specific QR code, a specific sticker, and the like, exists as the location identifier in the parking lot image, as learning data.

The learned neural network 30 may determine whether or not the location identifier exists with respect to the input parking lot image, and provide a prediction probability value for each location identifier as a prediction result 32.

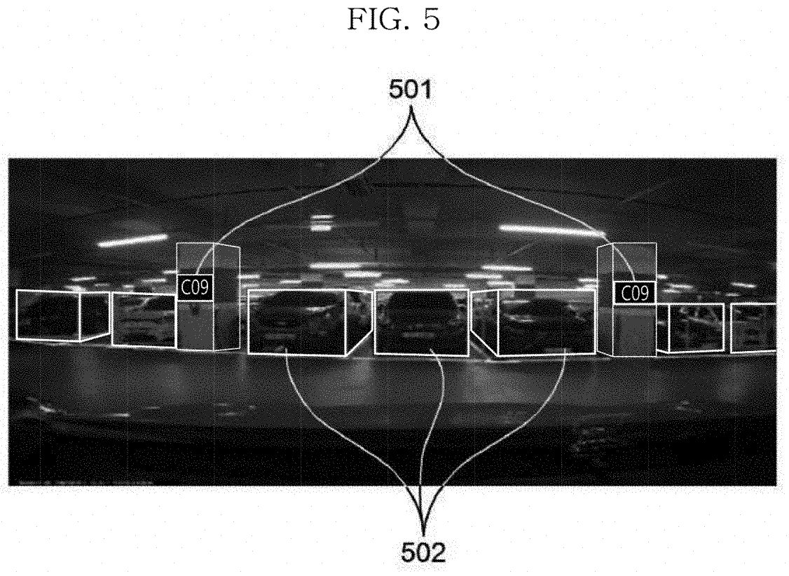

That is, FIG. 5 is a view illustrating a parking lot image according to an embodiment of the present invention. Referring to FIG. 5, a parking lot image captured by the image capturing apparatus 100 for a vehicle of a parked vehicle may include a plurality of location identifiers 501 and a plurality of vehicles 502.

The AI processor 175-5 according to the present invention may recognize the location identifiers 501 from the parking lot image using the artificial neural network.

Meanwhile, the parking space information generator 175-2 may generate information on the number of parking slots of the parking space included in the parking lot image by analyzing the parking lot image. Specifically, the parking space information generator 175-2 may detect line markings of the parking space, generate information on the number of parking slots in the parking space based on the detected line markings, and generate parking slot identification information making a plurality of parking slots distinguishable from each other.

In addition, the parking space information generator 175-2 may generate information on whether or not the vehicle is parked in parking slot included in the parking space. Specifically, the parking space information generator 175-2 may analyze the parking lot image to detect the vehicle, determine where the detected vehicle is located among the plurality of parking slots constituting the parking space, and generate information on whether or not the vehicle is parked in the parking slot included in the parking space. Here, the information on whether or not the vehicle is parked in the parking slot may be generated for each of the plurality of parking slots constituting the parking space, and may be generated separately for each floor of the parking lot.

In this case, the parking space information generator 175-2 may recognize the vehicle in the parking lot image using the learned neural network of the AI processor 175-5. In this regard, a principle is the same as that of the neural network 30 learned in order to recognize the location identifier in FIG. 4, and a detailed description thereof will thus be omitted.

That is, FIG. 5 is a view illustrating a parking lot image according to an embodiment of the present invention, and the AI processor 175-5 according to the present invention may recognize the plurality of vehicles 502 from the parking lot image using the artificial neural network.

Meanwhile, the parked vehicle information generator 175-3 may generate parked vehicle information on a plurality of parked vehicles parked in the surrounding of an own vehicle by analyzing the parking lot image. Here, the parked vehicle information may include vehicle type information and vehicle number information. In addition, the parked vehicle information may be generated separately for each of the plurality of parking slots constituting the parking space.

The vehicle type information may include classification information according to the use purpose of the vehicle, such as a sedan, hatchback, wagon, and SUV, and classification information for each brand of the vehicle. In addition, the vehicle number information may be number information written on a vehicle license plate.

In this case, the parked vehicle information generator 175-3 may use the learned neural network of the AI processor 175-5 in order to recognize surrounding vehicles from the captured image. Accordingly, the learned neural network 30 may determine whether or not the vehicles exist with respect to the input parking lot image, and provide a type of each vehicle, a number of each vehicle, and the like as a prediction result.

Meanwhile, the own vehicle location information generator 175-4 may generate location information of the vehicle in which the image capturing apparatus 100 for a vehicle is mounted.

Specifically, when the vehicle is located in the outdoor parking lot, the own vehicle location information generator 175-4 may generate own vehicle location information in the outdoor parking lot using satellite positioning data received from a global navigation satellite system (GNSS).

In addition, when the vehicle is located in the indoor parking lot, the own vehicle location information generator 175-4 may generate location information of the own vehicle in the indoor parking lot using the location identifier described above.

However, the present invention is not limited thereto, and according to another embodiment of the present invention, even when the vehicle is located in the outdoor parking lot, the own vehicle location information generator 175-4 may generate location information of the own vehicle in the outdoor parking lot using the location identifier.

In addition, the own vehicle location information generator 175-4 may generate location information of the own vehicle based on whether or not the own vehicle has been parked. Here, the own vehicle location information generator 175-4 may determine whether or not the own vehicle has been parked, based on one of turn-off of an engine of the own vehicle, turn-off power of a battery, parking (P stage) gear shift, whether or not the passenger has gotten off the vehicle, a location of a vehicle key (when the vehicle key is located outside the vehicle), whether or not side mirrors have been folded, and whether or not Bluetooth connection between the user terminal apparatus 400 and the vehicle has been made.

For example, when the parking gear shift of the own vehicle is made and the Bluetooth connection between the user terminal apparatus 400 and the vehicle are released, the own vehicle location information generator 175-4 may determine that the vehicle has been parked at a corresponding location of the own vehicle and generate vehicle location information of the own vehicle.

Meanwhile, when the parking lot location information, the parking space information, the surrounding parked vehicle information, and the own vehicle location information are generated according to the processes described above, the parking lot data generation unit 175 may generate parking lot data by combining time information matched to the generated information and a parking lot image matched to the generated information.

Meanwhile, the surrounding vehicle event determination unit 185 may determine whether or not an event of another vehicle parked in the surrounding of the own vehicle has occurred. Here, the surrounding vehicle event may refer to an event situation in which an impact is applied to another vehicle parked in the surrounding of the own vehicle by a vehicle, a person, or any object.

The surrounding vehicle event determination unit 185 may determine whether or not the event of another vehicle parked in the surrounding of the own vehicle has occurred based on a sound, a motion of a front object, and the like.

As an example, when a scream sound, an impact sound, a tire sound, a conversation sound including a specific word, or the like, is input from the microphone unit 130, the surrounding vehicle event determination unit 185 may determine that the event of another vehicle parked in the surrounding of the own vehicle has occurred.

Alternatively, the nearby vehicle event determination unit 185 may determine whether or not the surrounding vehicle event has occurred according to a request from a remote place. As an example, when an impact event is detected in another vehicle parked in the surrounding of the own vehicle and the image capturing apparatus 100 for a vehicle mounted on another vehicle transmits an impact notification of the server 300 for providing a parking lot guidance service or the user terminal apparatus 400, the server 300 for providing a parking lot guidance service or the user terminal apparatus 400 may notify the image capturing apparatus 100 for a vehicle of the own vehicle located in the surrounding of the vehicle in which the impact has occurred, of the occurrence of the event. In addition, when the notification is received, the surrounding vehicle event determination unit 185 may recognize that the event has occurred in the surrounding vehicle.

Meanwhile, the communication unit 190 may enable the image capturing apparatus 100 for a vehicle to communicate with other devices. Here, the communication unit 190 may be implemented as various known communication modules such as communication modules that use various wireless communication connection methods, for example, a cellular mobile communication method such as long term evolution (LTE) and a wireless local area network (WLAN) method such as wireless fidelity (WiFi), and a low-power wide-area (LPWA) technology. In addition, the communication unit 190 may also perform a location tracking function like a global positioning system (GPS) tracker.

Accordingly, the image capturing apparatus 100 for a vehicle may perform communication with the server 300 for providing a parking lot guidance service and/or the user terminal apparatus 400 through the communication unit 190.

Here, the communication unit 190 may refer to the same thing as the communication apparatus 200 for a vehicle of FIG. 1.

The control unit 195 controls overall operations of the image capturing apparatus 100 for a vehicle. Specifically, the control unit 195 may control all or some of the image capturing unit 110, the user input unit 120, the microphone unit 130, the display unit 140, the audio unit 150, the storage unit 160, the impact sensing unit 170, the parking lot data generation unit 175, the vehicle driving support function unit 180, the surrounding vehicle event determination unit 185, and the communication unit 190.

In particular, the control unit 195 may set the operation mode of the image capturing apparatus 100 for a vehicle to one of the continuous recording mode, the event recording mode, the parking recording mode, and the manual recording mode based on at least one of whether or not the engine of the vehicle is turned on, a vehicle battery voltage measurement result, a sensing result of the impact sensing unit 170, a determination result of the vehicle driving support function unit 180, and an operation mode setting value. In addition, when a battery voltage of the vehicle falls to a threshold value or less, the control unit 195 may control the image capturing apparatus 100 for a vehicle to stop an operation of the image capturing apparatus 100 for a vehicle.

In addition, the control unit 195 may determine whether or not the parking lot data needs to be updated, control the parking lot data generation unit 175 to update the parking lot data when the parking lot data needs to be updated, and control the communication unit 190 to transmit the updated parking lot data to the server 300 for providing a parking lot guidance service.

Here, an update condition of the parking lot data may include a case where a change occurs in the parking lot image as a parked vehicle located in the surrounding of the own vehicle exits from a parking slot of the parking space or another vehicle enters the parking slot of the parking space.

In addition, the update condition of the parking lot data may include a case where a preset period has arrived.

In addition, the update condition of the parking lot data may include a case where the degree of completeness of the parking data is lower than a preset reference value. Here, the case where the degree of completeness is lower than the preset reference value may include a case where resolution of the parking lot image is low or there is incomplete data.

In addition, the update condition of the parking lot data may include a case where an update request from a remote place (e.g., the server 300 for providing a parking lot guidance service or the user terminal apparatus 400) is received. Here, the update request from the remote place may be performed by determining the necessity for the update in the server 300 for providing a parking lot guidance service or the user terminal apparatus 400 based on the update condition of the parking lot data described above.

In addition, when it is determined in the surrounding vehicle impact event determination unit 185 that a surrounding vehicle impact event has occurred, the control unit 195 may control the parking lot data generation unit 175 to update the parking lot data, and control the communication unit 190 to transmit the updated parking lot data to the server 300 for providing a parking lot guidance service. Here, the updated parking lot data may include data a predetermined time before and after an occurrence point in time of the surrounding vehicle impact event.

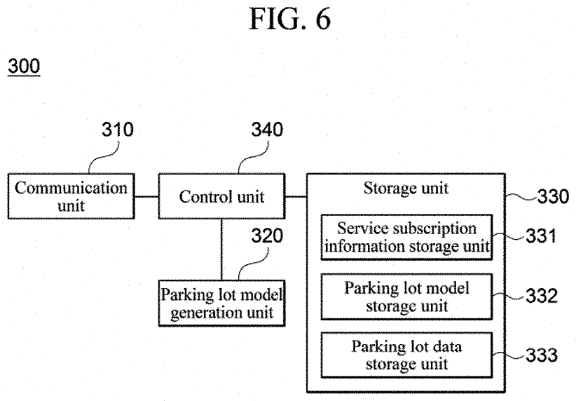

FIG. 6 is a block diagram illustrating a server for providing a parking lot guidance service according to an embodiment of the present invention. Referring to FIG. 6, the server 300 for providing a parking lot guidance service may include a communication unit 310, a parking lot model generation unit 320, a storage unit 330, and a control unit 340.

Before describing FIG. 6, according to the image capturing apparatus 100 for a vehicle described above, it has been described by way of example that operations of the parking lot data generation unit 175 and the surrounding vehicle event determination unit 185 are performed in the image capturing apparatus 100 for a vehicle, but all or some of these operations may also be performed in the server 300 for providing a parking lot guidance service.

The communication unit 310 may be provided for the server 300 for providing a parking lot guidance service to communicate with other devices. Specifically, the communication unit 310 may transmit and receive data to and from at least one of the image capturing apparatus 100 for a vehicle and the user terminal apparatus 400. Here, the communication unit 310 may be implemented as various known communication modules.

The parking lot model generation unit 320 may generate a parking lot model representing a real-time situation of the parking lot as an image using the parking lot data received from the image capturing apparatus 100 for a vehicle.

Specifically, the parking lot model generation unit 320 may perform modeling on the parking lot using the parking space information and the surrounding parked vehicle information of the parking data received from the image capturing apparatus 100 for a vehicle, and perform modeling for each floor of the parking lot.

That is, the parking lot model generation unit 320 may determine a location of the corresponding parking space in the parking lot based on the location information of the parking space, and perform modeling of the parking slots for the parking space based on information on the number of parking slots in the parking space. In addition, the parking lot model generation unit 320 may determine whether or not to dispose a vehicle model in the parking slot based on information on whether or not the vehicle is parked in the parking slot.

In addition, the parking lot model generation unit 320 may generate a vehicle model reflecting a license plate and a vehicle type based on type information of the parked vehicle and number information of the parked vehicle, and dispose the generated vehicle model in the corresponding parking slot.

Additionally, the parking lot model generation unit 320 may analyze the parking lot image received from the image capturing apparatus 100 for a vehicle to generate at least one of spatial shape information and road surface information, and generate a parking lot model based on the generated information.

Here, the spatial shape information may refer to information on a shape of a structure in the parking lot, such as a wall, a pillar, a parking space, and a parking barrier. In addition, the spatial shape information may further include color information of the structure.

In addition, a road surface mark is an indicator for guiding the movement of the vehicle in the parking lot, and may include a passage direction of the vehicle, and the like. Here, a direction of the route may be determined with reference to the road surface mark at the time of guiding a vehicle route in the parking lot.

Such spatial shape information and road surface information may be generated by the image capturing apparatus 100 for a vehicle and transmitted to the server 300 for providing a parking lot guidance service or may be generated through image processing of the parking lot image by the server 300 for providing a parking lot guidance service.

In addition, the parking lot model generation unit 320 may analyze the parking lot image of the parking lot data received from the image capturing apparatus 100 for a vehicle, compare the parking lot data received from the image capturing apparatus 100 for a vehicle and parking lot data generated through image analysis of the parking lot model generation unit 320 with each other, and generate a parking lot model by giving priority to the parking lot data generated by the server 300 for providing a parking lot guidance service when there is a difference between these parking lot data.

Meanwhile, the parking lot model generation unit 320 may hold a basic parking lot model for each of a plurality of parking lots. Here, the basic parking lot model is a model in which a real-time parking situation of the corresponding parking lot is not reflected, and may be a model in which a wall, a pillar, a parking space, and the like, indicating a spatial shape of the corresponding parking lot are reflected. In this case, the parking lot model generation unit 320 may generate a parking lot model by updating the basic parking lot model using the parking lot data received from the image capturing apparatus 100 for a vehicle.

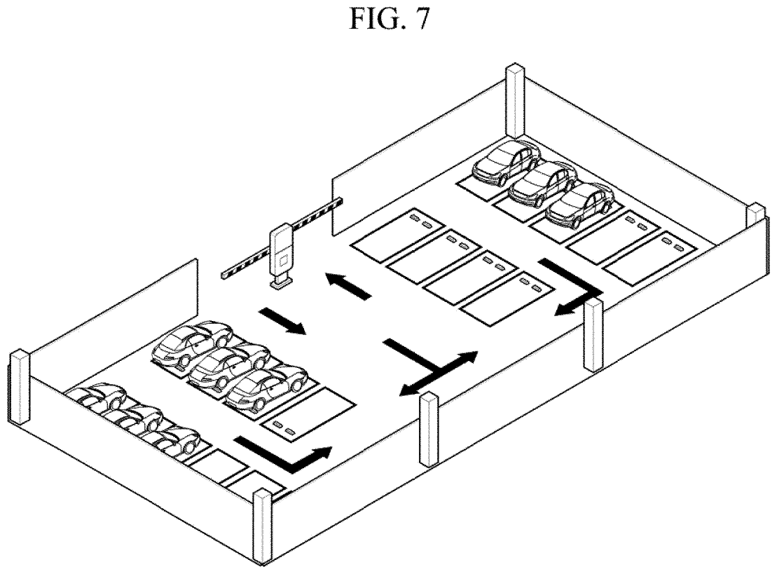

Such a parking lot model generated by the parking lot model generation unit 320 may be a three-dimensional (3D) model. This will be described in more detail with reference to FIG. 7.

FIG. 7 is a view illustrating a parking lot model according to an embodiment of the present invention. Referring to FIG. 7, the parking lot model generation unit 320 may model a parking slot for a parking space based on information on the number of parking slots of the parking space, and determine whether or not to disposed a vehicle model in the parking slot based on information on whether or not the vehicle is parked in the parking slot to generate a parking lot model in which the vehicle model is disposed.

In addition, the parking lot model generation unit 320 may reflect entrance and exit management equipment and road surface markings disposed in entrance and exit passages of the parking lot to generate a parking lot model.

Such a parking lot model may be transmitted in an expressible format to the user terminal apparatus 400 and displayed on a screen of the user terminal apparatus 400.

Meanwhile, the parking lot model generation unit 320 may continuously receive the parking lot data from the image capturing apparatus 100 for a vehicle to update the parking lot model.

In this case, the parking lot model generation unit 320 may update the parking lot model based on the parking lot location information and parking space location information included in the parking lot data.

For example, when parking lot data for a parking space between “3B-1” and “3B-2” of a first parking lot is received from a first image capturing apparatus 100-1 for a vehicle, the parking lot model generation unit 320 may perform modeling on the corresponding parking space using the received parking lot data, and generate a parking lot model. Thereafter, when parking lot data for the parking space between “3B-1” and “3B-2” of the same first parking lot is received from a second image capturing apparatus 100-2 for a vehicle, the parking lot model generation unit 320 may perform modeling on the corresponding parking space using the parking lot data received from the second image capturing apparatus 100-2 for a vehicle, and update the generated parking lot model.

In this case, the parking lot model generation unit 320 may update the parking lot model by reflecting the latest parking lot data in the time order of the received parking lot data.

In addition, the parking lot model generation unit 320 may update the parking lot model by extracting only a difference portion between the generated parking lot model and a subsequently generated parking lot model and then reflecting only the difference portion, at the time of updating the parking lot model.

Through this, a parking lot model representing the entire interior of the parking lot may be generated, and a change inside the parking lot may be quickly reflected in the parking lot model.

The storage unit 330 may store various data and programs for an operation of the server 300 for providing a parking lot guidance service. Here, the storage unit 330 may include a service subscription information storage unit 331, a parking lot model storage unit 332, and a parking lot data storage unit 333.

Specifically, when a user who wants to receive the parking lot guidance service subscribes to the parking lot guidance service using his/her terminal apparatus 400, the service subscription information storage unit 331 may store service subscription information generated based on information input through the subscription.

Here, the service subscription information storage unit 331 may store subscriber information on a subscriber who has subscribed to the parking lot information service, and apparatus information of the corresponding subscriber. The subscriber information may include subscriber identification information and subscription service information.

The subscription service information is information indicating a service to which the corresponding subscriber subscribes in detail, and may include service application details, a rate plan, a service validity period, a data rate, a service type, and the like.

The subscriber identification information is information making each of a plurality of subscribers identifiable, and may include a subscriber ID, a subscriber's password, a subscriber's resident registration number, a subscriber's name, a subscriber's nickname, a subscriber's personal identification number (PIN), and the like.

In addition, the subscriber apparatus information may include at least one of identification information of the image capturing apparatus 100 for a vehicle and identification information of the communication apparatus 200 for a vehicle purchased by the corresponding subscriber. Here, the identification information of the image capturing apparatus 100 for a vehicle is information making each of a plurality of image capturing apparatus for a vehicle identifiable, and may include a model name of the image capturing apparatus for a vehicle, a unique serial number of the image capturing apparatus for a vehicle, and the like. In addition, the identification information of the communication apparatus 200 for a vehicle is information making each of a plurality of communication apparatuses for a vehicle identifiable, and may include a dongle model name, a dongle phone number, a dongle serial number, a universal subscriber identity module (USIM) serial number, and the like.

In addition, the subscriber apparatus information may further include identification information of the user terminal apparatus 400 of the subscriber, and the identification information of the user terminal apparatus 400 may include an international mobile subscriber identity (IMSI), an integrated circuit card ID (ICCID), and an international mobile equipment identity (IMEI), which are unique information given in the network in order to identify the user terminal apparatus 400.

In this case, the service subscription information storage unit 331 may match and store subscriber information and subscriber apparatus information to each other for each subscriber who has subscribed to the service.

Meanwhile, the parking lot model storage unit 332 may store the parking lot model generated by the parking lot model generation unit 320.

In addition, the parking lot data storage unit 333 may store the parking lot data received from the image capturing apparatus 100 for a vehicle.

In this case, the parking lot model storage unit 332 and the parking lot data storage unit 333 may match and store the parking lot model and the corresponding parking lot data to each other.

Specifically, the parking lot model storage unit 332 may match and store the parking lot model and the corresponding parking lot location information, parking space information, surrounding parked vehicle information, own vehicle location information, time information, and parking lot image to each other.

Here, the storage unit 330 may be implemented as a built-in module of the server 300 for providing a parking lot guidance service or be implemented as a separate database (DB) server.

Meanwhile, the control unit 340 may control overall operations of the server 300 for providing a parking lot guidance service so that the parking lot guidance service according to the present invention is provided.

Such an operation of the server 300 for providing a parking lot guidance service may be divided into a “new subscription process”, a “registration process of a black-box”, a “registration process of a user”, and a “parking lot guidance service provision process” of providing a parking lot guidance service to a subscriber who has subscribed to the service.

In the “new subscription process”, when a service member subscription is requested from a subscriber, the control unit 340 may initiate a service subscription procedure, obtain subscriber information of the subscriber who has subscribed to the parking lot guidance service and apparatus information of the subscriber, and perform control so that the obtained information is classified and stored in the storage unit 330. Accordingly, the storage unit 330 may construct a service subscriber information database.

When a “registration process of the image capturing apparatus for a vehicle” is performed, the control unit 340 may receive unique information for identifying a communication apparatus, such as a universal subscriber identity module (USIM) chip embedded in the communication apparatus 200 for a vehicle through communication with the communication apparatus 200 for a vehicle, and compare the unique information with information stored in the storage unit 330 to confirm validity of the communication apparatus 200 for a vehicle.

Similarly, in the “registration process of a user”, when the user terminal apparatus 400 accesses the server 300 for providing a parking lot guidance service, the control unit 340 may obtain user identification information such as USIM embedded in the user terminal apparatus 400, and then compare the obtained user identification information with information stored in the storage unit 330 to confirm whether or the user terminal apparatus 400 has subscribed to the service, a type of service to which or the user terminal apparatus 400 has subscribed, and the like. When authentication for the user is successfully completed, the control unit 340 may provide various information on the image capturing apparatus 100 for a vehicle in various UX forms based on authority assigned to the user.

In the “parking lot guidance service provision process”, when the user terminal apparatus 400 accesses the server 300 for providing a parking lot guidance service, the control unit 340 may detect a parking lot model and parking lot data for a parking lot in which a vehicle of a user of the user terminal apparatus 400 that has accessed the server 300 for providing a parking lot guidance service is parked, and then provide the parking lot guidance service to the user terminal apparatus 400. Here, the parking lot guidance service may include a parking possible location guidance service, a vehicle parking location guidance service, a parking lot route guidance service, and a parking lot payment service.

As an example, in a case of providing the parking possible location guidance service, the control unit 340 may detect information of a parking lot entered by a user when the user enters the parking lot based on location information of the user terminal apparatus 400, and detect the number of parking possible floors of the corresponding parking lot, a location of a parking possible space in each floor, a location of a parking possible slot in the parking possible space, the number of parking possible slots in the parking possible space, and the like, based on the parking lot data stored in the parking lot data storage unit 333. In addition, the control unit 340 may provide a parking possible location guidance service that displays a parking possible location such as the parking possible space, the number of parking possible floors, and the parking possible slot of the parking lot on the parking lot model to the terminal apparatus 400 of the user who wants to park the vehicle, based on the detected information.

As another example, in a case of providing the vehicle parking location guidance service, the control unit 340 may detect parking location information of the user of the user terminal apparatus 400 based on the parking lot data stored in the parking lot data storage unit 333, and provide the vehicle parking location guidance service that displays the detected parking location information on the parking lot model.

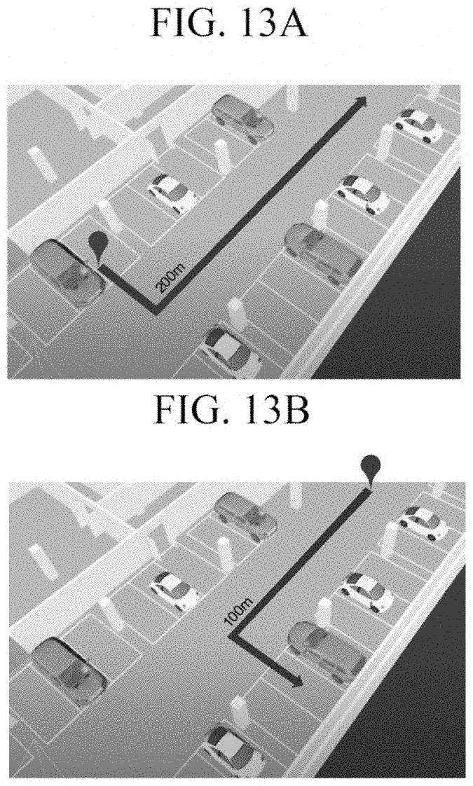

Additionally, the server 300 for providing a parking lot guidance service may determine location information of the user terminal apparatus 400 in the parking lot. In this case, the control unit 340 may provide the vehicle parking location guidance service that displays an optimal moving route and a distance from a current location of the user to a parking location on the parking lot model, based on the parking location information of the user and the location information of the user terminal apparatus 400 in the parking lot. Here, the optical moving route may be displayed in the shape of an arrow in consideration of a passage direction in the parking lot. As an example, the user terminal apparatus 400 may display a user interface for a vehicle parking location guidance service as illustrated in FIG. 13B.

As another example, in a case of providing the parking lot route guidance service, the control unit 340 may detect parking location information of the user of the user terminal apparatus 400 based on the parking lot data stored in the parking lot model storage unit 332, detect exit information of the corresponding parking lot, and provide the parking lot route guidance service that displays a route and a distance from the parking location of the user terminal apparatus 400 to an exit of the parking lot on the parking lot model based on the detected information. Here, the optical moving route may be displayed in the shape of an arrow in consideration of a passage direction in the parking lot. As an example, the user terminal apparatus 400 may display a user interface for a parking lot route guidance service as illustrated in FIG. 13A.

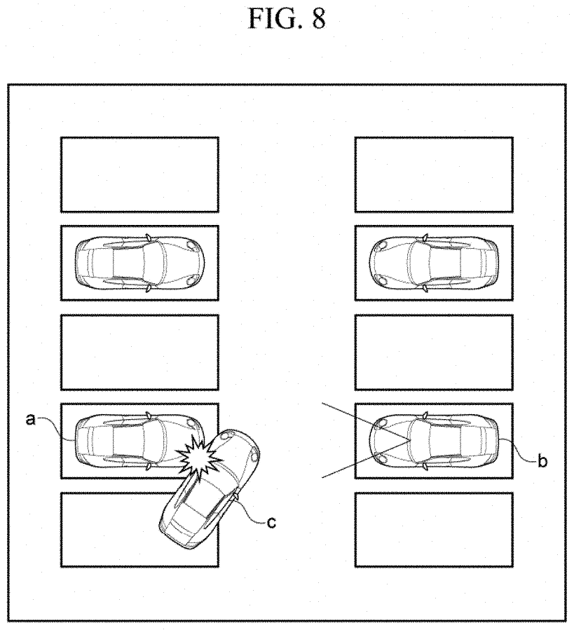

In addition, the parking lot guidance service may further include a parking impact event guidance service. Here, the parking impact event guidance service will be described in more detail with reference to FIG. 8.

FIG. 8 is an illustrative view illustrating the occurrence of a parking impact event according to an embodiment of the present invention. Referring to FIG. 8, an impact may occur in a first vehicle a parked in a parking lot due to a collision with another vehicle c parked next to the first vehicle.

In this case, the surrounding vehicle event determination unit 185 of a second vehicle b may determine that a parking impact event has occurred in the first vehicle a based on a sound, a motion of a front object, and the like.

Alternatively, the impact sensing unit 170 of the first vehicle may sense an impact from a collision with another vehicle c, and the image capturing apparatus 100 for a vehicle of the first vehicle may notify the server 300 for providing a parking lot guidance service or the user terminal apparatus 400 of the first vehicle a of the occurrence of the impact event. In this case, the server 300 for providing a parking lot guidance service or the user terminal apparatus 400 may notify the image capturing apparatus 100 for a vehicle for a vehicle located in the surrounding of the first vehicle a, for example, the second vehicle b (i.e., a vehicle capturing an image of the first vehicle) of the occurrence of the event, and the surrounding vehicle event determination unit 185 of the second vehicle b may recognize that the event has occurred in the first vehicle a.

Meanwhile, when it is recognized that the parking impact event has occurred in the first vehicle a, the image capturing apparatus 100 for a vehicle of the second vehicle b may transmit the parking data generated by the parking lot data generation unit 175 to the server 300 for providing a parking lot guidance service. In this case, the server 300 for providing a parking lot guidance service may provide the parking impact event guidance service. Specifically, the control unit 340 may detect a license plate of the vehicle c that has generated the impact to the first vehicle a from the parking lot image of the parking data. In addition, the control unit 340 may detect location information of the parking lot in which the impact has occurred, information on the number of floors, location information of the parking space, and location information of the parking slot from the parking data. In addition, the control unit 340 may provide the parking impact event guidance service that guides the number of the vehicle generating the impact, an impact generation location, and the like, to the parking lot model based on the detected information.

In addition, the parking lot guidance service may further include a guidance service before entering the parking lot. That is, in a case of providing the guidance service before entering the parking lot, the control unit 340 may detect parking data of a parking lot located in the vicinity of the user terminal apparatus 400 among parking data on a plurality of parking lots stored in the parking lot model storage unit 332 using the location information of the user terminal apparatus 400. In addition, the control unit 340 may detect parking possible space information of the corresponding parking lot from the detected parking data, and provide the guidance service before entering the parking lot that displays the number of parking slots of the corresponding parking lot and a parking fee of the corresponding parking lot to the user terminal apparatus 400 based on the detected information.

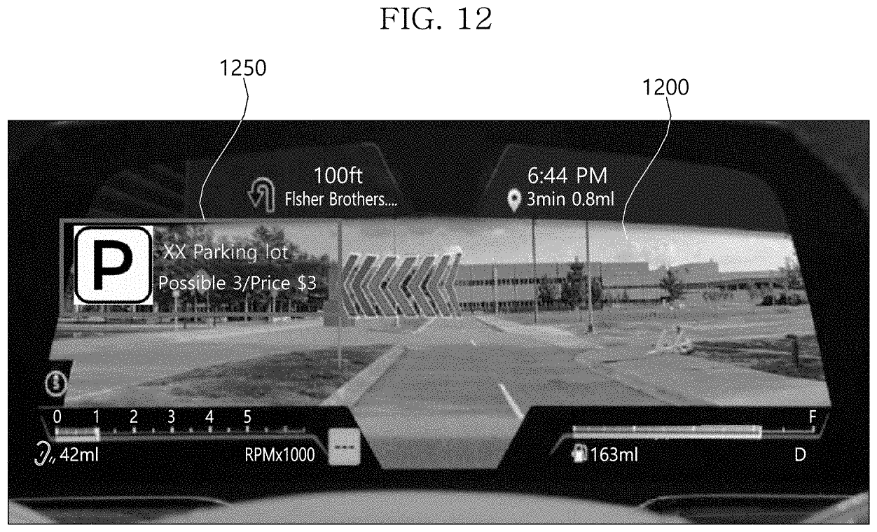

In this case, the user terminal apparatus 400 may display a guidance user interface before entering the parking lot as illustrated in FIG. 12. That is, referring to FIG. 12, the user terminal apparatus 400 may display a user interface including the number of parking possible slots of the corresponding parking lot and a parking fee of the corresponding parking lot. Additionally, the user interface may display a parking lot entry direction with an arrow in consideration of a location of the corresponding parking lot.

Meanwhile, the control unit 340 may provide various services to the user terminal apparatus 400 by analyzing the parking lot model configured by the parking lot model generation unit 320.

As an example, the control unit 340 may generate the total number of parking slots, a degree of congestion, a main congestion time, real-time remaining parking slot information, and own vehicle parking location information of the parking lot based on the parking lot model configured in the parking lot model generation unit 320, match the generated information to the parking lot model, and store the matched information in the storage unit 330.

In this case, the control unit 340 may calculate a degree of congestion by comparing a value obtained by dividing the number of occupied parking slots in the parking lot by the total number of parking slots in the parking lot with a preset value, and determine, for example, that a range of 0-30% is a low degree of congestion, a range of 30-60% is a medium degree of congestion, and a range of 60-100% is a high degree of congestion. Then, the control unit 340 may calculate a main congestion time of the corresponding parking lot based on the calculated degree of congestion and time information at that time.

In addition, the control unit 340 may generate parking fee information of the parking lot, operating hours of the parking lot, electric vehicle charging station information, and the like, match the generated information with the parking lot model, and store the matched information in the storage unit 330. Here, the electric vehicle charging station information may include whether the parking lot possesses an electric vehicle parking slot, the number of electric vehicle parking slots, an electric vehicle charging fee, electric vehicle charging station operating hours, and the like.

In this case, the control unit 340 may provide the total number of parking slots, a degree of congestion, a main congestion time, fee information, operating hours, electric vehicle charging station information, and the like, to the user terminal apparatus 400 connected to the server 300 for providing a parking lot guidance service.

In addition, when it is determined that the parking location is outdoors based on the parking location information on a location at which the vehicle is parked, the control unit 340 may determine whether or not the parking location is a back road parking slot and/or whether or not the parking location is an on-street parking slot based on analysis of the captured image data and/or the location information, and store a determination result in the storage unit 330. In this case, the control unit 340 may provide information whether or not the parking location of the user is the back road parking slot and/or whether or not the parking location of the user is the on-street parking slot, to the user terminal apparatus 400 that has accessed the server 300 for providing a parking lot guidance service.

In addition, the control unit 340 may analyze a commercial area located within a predetermined distance range based on the location of the parking lot in which the vehicle is parked. Specifically, the control unit 340 may analyze the trend of the commercial area based on types (e.g., restaurants, PC rooms, auto repair shops, etc.) of shops located within a predetermined distance based on the location of the parking lot in which the vehicle is parked, rental rates of the shops, maintenance periods of the shops, and the like. In this case, the control unit 340 may provide an analysis result of the trend of the commercial area in the vicinity of the parking location at which the user parks the vehicle, to the terminal apparatus 400 of the user who wants to visit the corresponding parking lot.

In addition, the control unit 340 may predict a parking lot in which the vehicle is expected to be parked and an expected parking time based on a destination of the vehicle, a location of the vehicle, a traffic situation, and the like, and guide a linked and/or alternative parking lot to the user terminal apparatus 400 in consideration of a situation of the expected parking lot. As an example, when a degree of congestion is high or the vehicle cannot be parked in the expected parking lot of the vehicle at the expected parking time, the control unit 340 may guide another parking lot linked to the expected parking lot to the user terminal apparatus 400. As another example, when there is a history of another vehicle parked in a nearby parking lot of the same parking lot as the expected parking lot of the vehicle after another vehicle visits the same parking lot as the expected parking lot, the control unit 340 may guide the nearby parking lot to the user terminal apparatus 400 as an alternative parking lot.

In addition, the control unit 340 may determine whether or not a dangerous situation (e.g., a fire, an accident in the parking lot, etc.) of the parking lot has occurred based on the images captured by the image capturing apparatus 100 for a vehicle, and store a determination result in the storage unit 330. In this case, the control unit 340 may provide information on whether or not the dangerous situation has occurred to the terminal apparatus 400 of the user who wants to visit the corresponding parking lot.

Meanwhile, the control unit 340 may relay data communication between a plurality of image capturing apparatuses 100 for a vehicle each provided in different vehicles to allow the plurality of image capturing apparatuses 100 for a vehicle to be communicatively connected to each other. As an example, the server 300 for providing a parking lot guidance service may be implemented as a cloud server.

Specifically, the control unit 340 may perform an event monitoring function between users. That is, the image capturing apparatus 100 for a vehicle may determine whether or not an event has occurred in another vehicle. As an example, the image capturing apparatus 100 for a vehicle may determine whether or not a situation requiring notification to another vehicle, such as an impact event or an accident event, has occurred in another vehicle through image analysis. When it is determined that the event has occurred, the image capturing apparatus 100 for a vehicle may upload an event image to the server 300 for providing a parking lot guidance service, and the control unit 340 of the server 300 for providing a parking lot guidance service may determine the user terminal apparatus 400 of a user who is the person involved in the occurrence of the event, transmit images captured by the image capturing apparatuses 100 for a vehicle vehicles located in the surrounding of another vehicle to the user terminal apparatus 400 of the corresponding user, and provide a relay service capable of transacting image data.

Furthermore, the control unit 340 may provide a relay service in the same manner for a human accident or theft accident event in addition to the vehicle.

In addition, the control unit 340 may provide a relay service in the same manner as to whether or not a crackdown event has occurred in another vehicle.

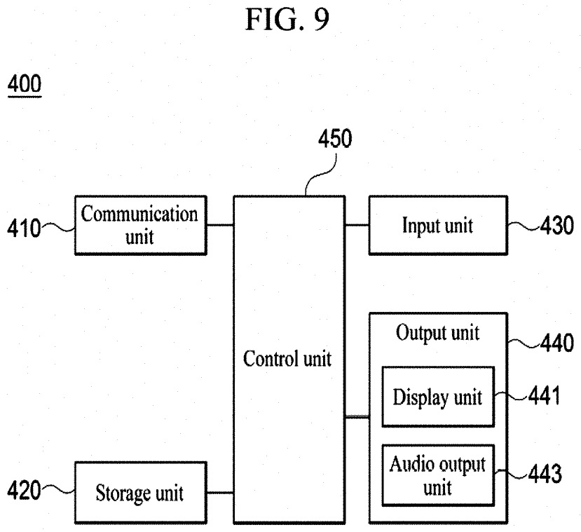

FIG. 9 is a block diagram illustrating a user terminal apparatus according to an embodiment of the present invention. Referring to FIG. 9, the user terminal apparatus 400 may include all or some of a communication unit 410, a storage unit 420, an input unit 430, an output unit 440, and a control unit 450.

The communication unit 410 may be provided for the user terminal apparatus 400 to communicate with other devices. Specifically, the user terminal apparatus 400 may transmit and receive data to and from at least one of the image capturing apparatus 100 for a vehicle, the communication apparatus 200 for a vehicle, and the server 300 for providing a parking lot guidance service through the communication unit 410.

For example, the communication unit 410 may access the server 300 for providing a parking lot guidance service storing the data generated by the image capturing apparatus 100 for a vehicle, and receive various data for the parking lot guidance service from the server 300 for providing a parking lot guidance service.

Here, the communication unit 410 may be implemented using various communication manners such as a connection form in a wireless or wired manner through a local area network (LAN) and the Internet network, a connection form through a USB port, a connection form through a mobile communication network such as 3G and 4G mobile communication networks, and a connection form through a short range wireless communication manner such as near field communication (NFC), radio frequency identification (RFID), and Wi-Fi.

The storage unit 420 serves to store various data and applications required for an operation of the user terminal apparatus 400. In particular, the storage unit 420 may store a “parking lot guidance service providing application” according to an embodiment of the present invention.

Here, the storage unit 420 may be implemented as a detachable storing element such as a universal serial bus (USB) memory, or the like, as well as an embedded storage element such as a random access memory (RAM), a flash memory, a read only memory (ROM), an erasable programmable ROM (EPROM), an electronically erasable and programmable ROM (EEPROM), a register, a hard disk, a removable disk, a memory card, or a universal subscriber identity module (USIM).

The input unit 430 serves to convert a physical input from the outside of the user terminal apparatus 400 into a specific electrical signal. Here, the input unit 430 may include both or one of a user input unit and a microphone unit.

The user input unit may receive a user input such as a touch, a gesture, or a push operation. Here, the user input unit may be implemented as various buttons, a touch sensor receiving a touch input, a proximity sensor receiving an approaching motion, or the like. In addition, the microphone unit may receive a voice of the user and a sound generated in the inside and the outside of the vehicle.

The output unit 440 is a component outputting data of the user terminal apparatus 400, and may include a display unit 441 and an audio output unit 443.

The display unit 441 may output data that may be visually recognized by the user of the user terminal apparatus 400. In particular, the display unit 441 may display a user interface corresponding to the parking lot guidance service according to the execution of the “parking lot guidance service providing application” according to an embodiment of the present invention.

Here, the parking lot guidance service user interface may include a parking possible location guidance user interface, a vehicle parking location guidance user interface, a parking lot route guidance user interface, and a parking impact event guidance user interface.

Meanwhile, the audio output unit 443 may output data that may be auditorily recognized by the user of the user terminal apparatus 400. Here, the audio output unit 443 may be implemented as a speaker representing data that is to be notified to the user of the user terminal apparatus 400 as a sound.

The control unit 450 controls overall operations of the user terminal apparatus 400. Specifically, the control unit 450 may control all or some of the communication unit 410, the storage unit 420, the input unit 430, and the output unit 440. In particular, when various data are received from the image capturing apparatus 100 for a vehicle, the communication apparatus 200 for a vehicle and/or the server 300 for providing a parking lot guidance service through the communication unit 410, the control unit 450 may process the received data to generate a user interface, and control the display unit 441 to display the generated user interface.

The control unit 450 may execute applications that provide advertisements, the Internet, games, moving images, and the like. In various embodiments, the control unit 450 may include one processor core or include a plurality of processor cores. For example, the control unit 450 may include a multi-core such as a dual-core, a quad-core, or a hexa-core. According to embodiments, the control unit 450 may further include a cache memory located inside or outside.

The control unit 450 may receive commands of other components of the user terminal apparatus 400, interpret the received commands, and perform calculation or process data according to the interpreted commands

The control unit 450 may process data or signals generated in an application. For example, the control unit 450 may request the storage unit 420 to transmit an instruction, data, or a signal in order to execute or control the application. The control unit 450 may cause the storage unit 420 to write (or store) or update an instruction, data, or a signal in order in order to execute or control the application.

The control unit 450 may interpret and process messages, data, instructions, or signals received from the communication unit 410, the storage unit 420, the input unit 430, and the output unit 440. In addition, the control unit 450 may generate a new message, data, instruction, or signal based on the received messages, data, instructions, or signals. The control unit 450 may provide the processed or generated messages, data, instructions, or signals to the communication unit 410, the storage unit 420, the input unit 430, the output unit 440, and the like.

All or some of the control unit 450 may be electrically or operably coupled with or connected to other components (e.g., the communication unit 410, the storage unit 420, the input unit 430, and the output unit 440) in the user terminal apparatus 400.

According to embodiments, the control unit 450 may include one or more processors. For example, the control unit 450 may include an application processor (AP) that controls an upper layer program such as an application program, a communication processor (CP) that performs control for communication, or the like.

Meanwhile, the input unit 430 described above may receive an instruction, an interaction, or data from a user. The input unit 430 may sense a touch or hovering input of a finger and a pen. The input unit 430 may sense an input caused through a rotatable structure or a physical button. The input unit 430 may include sensors for sensing various types of inputs. The input received by the input unit 430 may have various types. For example, the input received by the input unit 430 may include a touch and release, a drag and drop, a long touch, a force touch, and a physical depression, and the like. The input unit 430 may provide the received input and data related to the received input to the control unit 450. In various embodiments, although not illustrated in FIG. 9, the input unit 430 may include a microphone (or transducer) capable of receiving a user's voice command. In various embodiments, although not illustrated in FIG. 9, the input unit 430 may include an image sensor or a camera capable of receiving a user's motion.

Meanwhile, the display unit 441 described above may output a content, data, or a signal. In various embodiments, the display unit 441 may display an image signal processed by the control unit 450. As an example, the display unit 441 may display a captured or still image. As another example, the display unit 441 may display a moving image or a camera preview image. As still another example, the display unit 441 may display a graphical user interface (GUI) so that the user may interact with the user terminal apparatus 400.

The display unit 441 may be configured with a liquid crystal display (LCD) or an organic light emitting diode (OLED).

According to embodiments, the display unit 441 may be configured with an integrated touch screen by being coupled with a sensor capable of receiving a touch input or the like.

In various embodiments, the control unit 450 may map at least one function to the input unit 430 so that the input unit 430 has at least one function of a plurality of functions that the user terminal apparatus 400 may provide to the user. For example, the at least one function may include at least one of an application execution function, a parking location guidance function of the vehicle, a live view viewing function that is a viewing function of a real-time captured image of the image capturing apparatus 100 for a vehicle, a power turn-on/off control function of the image capturing apparatus 100 for a vehicle, a power turn-on/off function of the vehicle, a parking/driving mode guidance function of the vehicle, an event occurrence guidance function, a current vehicle location inquiry function, a vehicle parking location and parking time guidance function, a parking history guidance function, a driving history guidance function, an image sharing function, an event history function, a remote playback function, and an image viewing function.

In various embodiments, the input unit 430 may receive configuration information from the control unit 450. The input unit 430 may display an indication for indicating the function based on the configuration information.

In various embodiments, the control unit 450 may transmit the configuration information to the input unit 430 in order to indicate what the at least one function is mapped the input unit 430 is. The configuration information may include data for displaying an indication for indicating which function of the plurality of functions is provided through the input unit 430, through the display unit 411. The configuration information may include data for indicating a function selected by the control unit 450 among the plurality of functions.

In addition, the control unit 450 may generate a user interface based on the data received from the server 300 for providing a parking lot guidance service and control the display unit 441 to display the generated user interface.

Meanwhile, when parking of the own vehicle is completed, the control unit 450 may automatically generate parking location information of the own vehicle, generate a user interface based on the automatically generated parking location information, and control the display unit 441 to display the generated user interface. In this case, the control unit 450 may generate the parking location information of the own vehicle using a satellite navigation apparatus such as a GPS provided in the user terminal apparatus 400.

Specifically, the control unit 450 may generate the parking location information of the own vehicle based on whether or not a Bluetooth connection between the user terminal apparatus 400 and the own vehicle has been made or whether a connection of an application for a vehicle (e.g., Apple™, Carplay™, Auto™ of Android™, navigation, parking guidance service providing application, etc.) has been made.

For example, the control unit 450 may generate a location of the user terminal apparatus 400 at a point in time when the Bluetooth connection between the user terminal apparatus 400 and the own vehicle is released as the parking location information of the own vehicle.

Through this, the user terminal apparatus 400 may provide the vehicle parking location guidance service to the user even when the parking location information of the own vehicle is not generated or is erroneously generated in the server 300 for providing a parking lot guidance service.

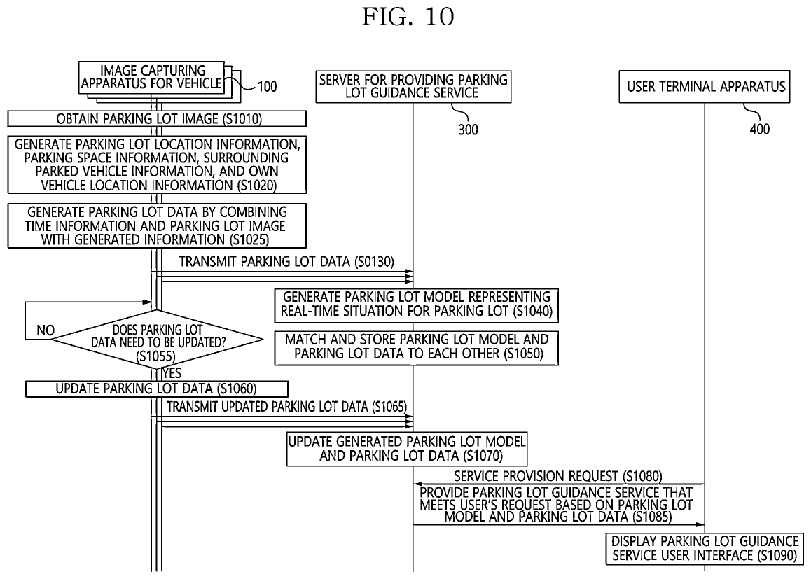

FIG. 10 is a timing diagram illustrating a method for providing a parking lot guidance service according to an embodiment of the present invention.

Referring to FIG. 10, each of a plurality of image capturing apparatuses 100 for a vehicle may obtain a parking lot image by performing image capturing (S1010). Here, the parking lot image may include an image captured during a period from a point in time when the vehicle enters the parking lot to a point in time when the vehicle exits from the parking lot.

Then, each of the plurality of image capturing apparatuses 100 for a vehicle may generate at least one of parking lot location information, parking space information, surrounding parked vehicle information, and own vehicle location information (S1020). Here, S1020 may be performed by the parking lot location information generator 175-1, the parking space information generator 175-2, the parked vehicle information generator 175-3, the own vehicle location information generator 175-4, and the AI processor 175-5.

Then, each of the plurality of image capturing apparatuses 100 for a vehicle may generate parking lot data by combining time information and the parking lot image with the generated information (S1025), and transmit the generated parking lot data to the server 300 for providing a parking lot guidance service (S1030).

In this case, the server 300 for providing a parking lot guidance service may generate a parking lot model representing a real-time situation for the parking lot using the received parking lot data (S1040). Here, the parking lot model generated by the parking lot model generation unit 320 may be a three-dimensional (3D) model.

Then, the server 300 for providing a parking lot guidance service may match and store the generated parking lot model and parking lot data to each other (S1050). Specifically, in S1050, the parking lot model and the corresponding parking lot location information, parking space information, surrounding parked vehicle information, own vehicle location information, time information, and parking lot image may be matched and stored to each other.

Meanwhile, each of the plurality of image capturing apparatuses 100 for a vehicle may determine whether or not the parking lot data needs to be updated (S1055), update the parking lot data (S1060) when the parking lot data needs to be updated (S1055:Y), and transmit the updated parking lot data to the server 300 for providing a parking lot guidance service (S1065).

Here, an update condition of the parking lot data may include a case where a change occurs in the parking lot image due to an exit of a surrounding vehicle of the own vehicle, a case where a preset period has arrived, or the like.

Meanwhile, the server 300 for providing a parking lot guidance service may update the generated parking lot model and parking lot data using the received parking lot data (S1070). Specifically, the parking lot model generation unit 300 may update the parking lot model by extracting only a difference portion between the generated parking lot model and a subsequently generated parking lot model and then reflecting only the difference portion.

Meanwhile, the server 300 for providing a parking lot guidance service may receive a service provision request from the user terminal apparatus 400 that has accessed the server for providing a parking lot guidance service (S1080).

In this case, the server 300 for providing a parking lot guidance service may provide a parking lot guidance service that meets a user's request based on the parking lot model and the parking lot data (S1085).

In this case, the user terminal apparatus 400 may display a parking lot guidance service user interface corresponding to the parking lot guidance service provided by the server 300 for providing a parking lot guidance service (S1090). Here, the parking lot guidance service user interface may include a parking possible location guidance user interface, a vehicle parking location guidance user interface, and a parking lot route guidance user interface.

Meanwhile, the server 300 for providing a parking lot guidance service may provide a service related alarm to the user terminal apparatus 400 according to a specific condition even though there is no user's service provision request. In this case, the service related alarm is an alarm related to the parking location guidance service, and may be link data linked to a parking location of the own vehicle or a vehicle parking location guidance user interface.

Specifically, the specific condition may include a case where getting-off of the user from the vehicle is sensed, a case where a user's action for finding the parked vehicle is sensed (for example, a case where the user moves to the parking lot, a case where an engine of the vehicle is remotely turned on, a case where navigation is executed, etc.), a predetermined time interval after parking, and the like. Here, the specific condition may be received from the user terminal apparatus 400 or the image capturing apparatus 100 for a vehicle.

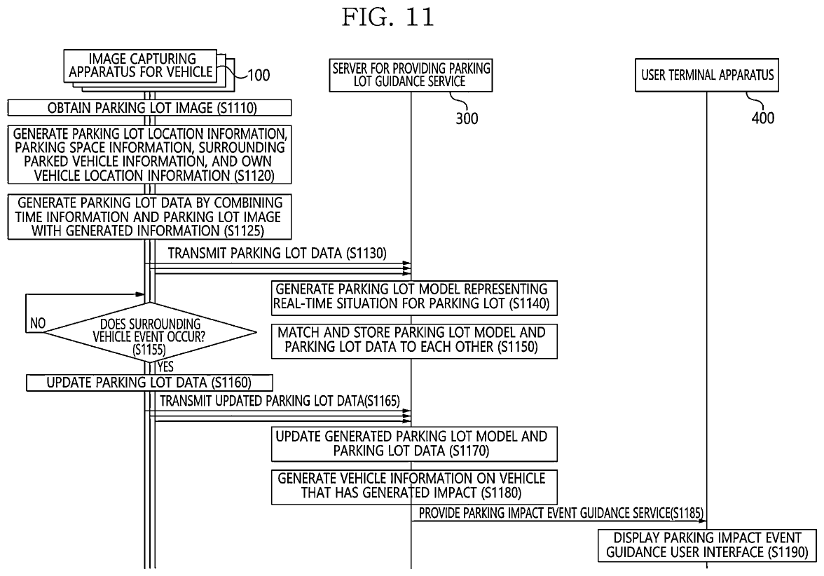

FIG. 11 is a timing diagram illustrating a method for providing a parking lot guidance service according to another embodiment of the present invention.

Referring to FIG. 11, each of a plurality of image capturing apparatuses 100 for a vehicle may obtain a parking lot image by performing image capturing (S1110). Then, each of the plurality of image capturing apparatuses 100 for a vehicle may generate at least one of parking lot location information, parking space information, surrounding parked vehicle information, and own vehicle location information (S1120).

Then, each of the plurality of image capturing apparatuses 100 for a vehicle may generate parking lot data by combining time information and the parking lot image with the generated information (S1125), and transmit the generated parking lot data to the server 300 for providing a parking lot guidance service (S1130).

In this case, the server 300 for providing a parking lot guidance service may generate a parking lot model representing a real-time situation for the parking lot using the received parking lot data (S1140). Then, the server 300 for providing a parking lot guidance service may match and store the generated parking lot model and parking lot data to each other (S1150).

Meanwhile, each of the plurality of image capturing apparatuses 100 for a vehicle may determine whether or not an event has occurred in another vehicle parked in the surrounding of the own vehicle (S1155).

As an example, each of the plurality of image capturing apparatuses 100 for a vehicle may determine whether or not the event has occurred in the surrounding vehicle based on a sound, a motion of a front object, and the like. Alternatively, each of the plurality of image capturing apparatuses 100 for a vehicle may determine whether or not the event has occurred in the surrounding vehicle according to a request from a remote place.

When it is determined that a surrounding vehicle impact event has occurred (S1155:Y), each of the plurality of image capturing apparatuses 100 for a vehicle may update the parking lot data (S1160), and transmit the updated parking lot data to the server 300 for providing a parking lot guidance service (S1165). Here, the updated parking lot data may include data a predetermined time before and after an occurrence point in time of the surrounding vehicle impact event.

Meanwhile, the server 300 for providing a parking lot guidance service may update the generated parking lot model and parking lot data using the received parking lot data (S1170).

Then, the server 300 for providing a parking lot guidance service may generate vehicle information on a vehicle that has generated the impact from the updated parking lot data (S1180). Here, the vehicle information on the vehicle that has generated the impact may include vehicle number information, location information of a parking lot in which the impact has been generated, information on the number of floors, location information of a parking space, and location information of a parking slot.

Then, the server 300 for providing a parking lot guidance service may provide a parking impact event guidance service to the user terminal apparatus 400 of a user of a vehicle to which the impact has been applied based on the vehicle information on the vehicle that has generated the impact (S1185).

In this case, the user terminal apparatus 400 may display a parking impact event guidance user interface corresponding to the parking impact event guidance service provided by the server 300 for providing a parking lot guidance service (S1190). Here, the parking impact event guidance service user interface may display the number of the vehicle generating the impact, an impact generation location, and the like.

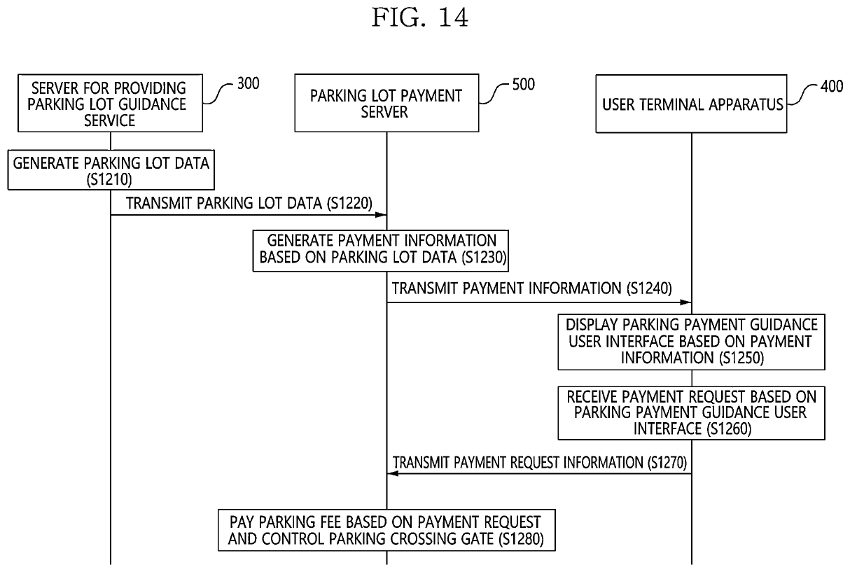

FIG. 14 is a timing diagram illustrating a method for providing a parking lot payment service according to still another embodiment of the present invention.

Referring to FIG. 14, the server 300 for providing a parking lot guidance service may obtain a parking lot image, generate parking lot location information, parking space information, surrounding parked vehicle information, and own vehicle location information, and generate parking lot data by combining time information and the parking lot image to the generated information (S1210).

Then, the server 300 for providing a parking lot guidance service may transmit the generated parking lot data to a parking lot payment server 500 (S1220), and the parking lot payment server 500 may generate payment information based on the parking lot data (S1230). Here, the payment information may include parking rate, parking time, vehicle type, penalty, and incentive information of the corresponding vehicle.

Specifically, the parking lot payment server 500 may calculate penalty information or incentive information based on the own vehicle location information in the parking lot data, and calculate a parking fee of the corresponding vehicle based on the calculated penalty or incentive information and the time information to generate the payment information. Here, the penalty information or the incentive information is information related to an addition/reduction rate of the parking fee according to a parking location of the corresponding vehicle, and may be determined differently depending on the parking location and the parking time of the vehicle.

As an example, when a vehicle of a non-handicapped person is parked in a handicapped parking area, the parking lot payment server 500 may calculate penalty information for a parking fee reduction rate proportional to a parking time, and apply the penalty information to a parking fee according to the parking time to calculate a parking fee.

As another example, when a vehicle is parked in a non-parking area, when a medium-size vehicle is parked in a light-weight vehicle area, or when a vehicle is parked to obstruct parking of other vehicles (is parked partially out of a parking area), the parking lot payment server 500 may calculate penalty information and generate the payment information.

In addition, the parking lot payment server 500 may calculate incentive information based on discount information and calculate a parking fee of the corresponding vehicle based on the calculated incentive information and time information to generate the payment information. Here, the discount information may include various information related to parking fee discounts such as card payment details in a building in which the corresponding parking lot is located, a parking discount coupon, a discount for a person having many children, an electric vehicle discount, and a discount for a handicapped person. Such discount information may be input from the server 300 for providing a parking lot guidance service or be received from the user terminal apparatus 400.

In addition, the parking lot payment server 500 may transmit the generated payment information to the user terminal apparatus 400 (S1240), and the user terminal apparatus 400 may display a parking payment guidance user interface based on the payment information (S1250). Here, the parking payment guidance user interface may include a parking situation (a parking time, a parking area, etc.), parking fee inquiry, parking fee payment, and the like.

In addition, the user terminal apparatus 400 may receive a payment request from the user based on the parking payment guidance user interface (S1260), and transmit the payment request to the parking lot payment server 500 (S1270). In this case, the payment request may include card information for paying the parking fee.

Then, the parking lot payment server 500 may pay the parking fee of the corresponding vehicle based on the payment request, and control a parking crossing gate of the corresponding parking lot (S1280).

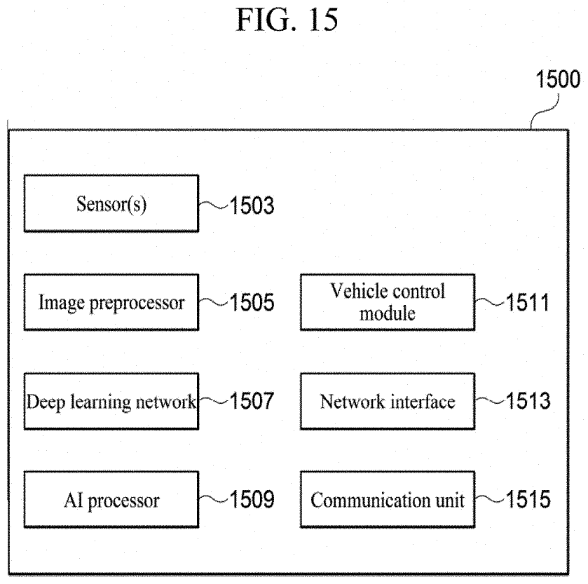

FIG. 15 is a block diagram illustrating an autonomous driving system 1500 of a vehicle according to an embodiment of the present invention.

The autonomous driving system 1500 of a vehicle illustrated in FIG. 15 is a deep learning network including sensors 1503, an image preprocessor 1505, a deep learning network 1507, an artificial intelligence (AI) processor 1509, a vehicle control module 1511, a network interface 1513, and a communication unit 1515. In various embodiments, the respective components may be connected to each other through various interfaces. For example, sensor data sensed and output by the sensors 1503 is fed to the image preprocessor 1505. The sensor data processed by the image preprocessor 1505 is fed to the deep learning network 1507 running on the AI processor 1509. An output of the deep learning network 1507 running on the AI processor 1509 is fed to the vehicle control module 1511. Intermediate results of the deep learning network 1507 running on the AI processor 1507 are fed to the AI processor 1509. In various embodiments, the network interface 1513 performs communication with remote servers based on an autonomous driving operation of the vehicle, and transfers information transmitted and received through the communication with the remote servers to internal block components. In addition, the network interface 1513 is used to transmit sensor data acquired from the sensor(s) 1503 to a remote server or internal block components. In some embodiments, the autonomous driving system 1500 may include additional or fewer components as appropriate. For example, in some embodiments, the image preprocessor 1505 is an optional component. According to another example, in some embodiments, a post-processing component (not illustrated) is used to perform post-processing on an output of the deep learning network 1507 before the output is provided to the vehicle control module 1511.

In some embodiments, the sensors 1503 include one or more sensors. In various embodiments, the sensors 1503 may be attached to different locations of the vehicle and/or so as to face one or more different directions. For example, the sensors 1503 may be directed to a front, sides, a rear, and/or a roof of the vehicle in directions such as forward-facing, rear-facing, side-facing, and the like. In some embodiments, the sensors 1503 may be image sensors such as high dynamic range cameras. In some embodiments, the sensors 1503 include non-visual sensors. In some embodiments, the sensors 1503 include a radio detection and ranging (RADAR), a light detection and ranging (LiDAR), and/or an ultrasonic sensor in addition to the image sensors. In some embodiments, the sensors 1503 are not mounted on a vehicle having the vehicle control module 1511. For example, the sensors 1503 may be included as a part of a deep learning system for capturing sensor data, and may be attached to an environment or a road and/or mounted on surrounding vehicles.

In some embodiments, the image pre-processor 1505 is used to preprocess the sensor data of the sensors 1503. For example, the image preprocessor 1505 may be used to preprocess the sensor data, split the sensor data into one or more components, and/or post-process one or more components. In some embodiments, the image preprocessor 1505 may be a graphics processing unit (GPU), a central processing unit (CPU), an image signal processor, or a specialized image processor. In various embodiments, the image preprocessor 1505 may be a tone-mapper processor for processing high dynamic range data. In some embodiments, the image preprocessor 1505 may be a component of the AI processor 1509.

In some embodiments, the deep learning network 1507 is a deep learning network for implementing control commands for controlling an autonomous vehicle. For example, the deep learning network 1507 may be an artificial neural network, such as a convolutional neural network (CNN) trained using the sensor data, and an output of the deep learning network 1507 is provided to the vehicle control module 1511.

In some embodiments, the artificial intelligence (AI) processor 1509 is a hardware processor for running the deep learning network 1507. In some embodiments, the AI processor 1509 is a specialized AI processor for performing inference using convolutional neural networks (CNNs) on the sensor data. In some embodiments, the AI processor 1509 is optimized for a bit depth of the sensor data. In some embodiments, the AI processor 1509 is optimized for deep learning operations, such as operations of a neural network including convolution, dot product, vector, and/or matrix operations, among others. In some embodiments, the AI processor 1509 may be implemented using a plurality of graphic processing units (GPUs) that may effectively perform parallel processing.

In various embodiments, the AI processor 1509 is coupled to a memory configured to provide an AI processor having instructions causing deep learning analysis to be performed on the sensor data received from the sensor(s) 1503 and causing a machine learning result used to at least partially autonomously operate the vehicle to be determined when executed, through an input/output interface. In some embodiments, the vehicle control module 1511 is used to process commands for vehicle control output from the artificial intelligence (AI) processor 1509 and to translate an output of the AI processor 1509 into instructions for controlling modules of each vehicle in order to control various modules of the vehicle. In some embodiments, the vehicle control module 1511 is used to control a vehicle for autonomous driving. In some embodiments, the vehicle control module 1511 may adjust steering and/or speed of the vehicle. For example, the vehicle control module 1511 may be used to control driving of the vehicle, such as deceleration, acceleration, steering, lane change, and lane maintenance. In some embodiments, the vehicle control module 1511 may generate control signals for controlling vehicle lighting, such as brake lights, turns signals, and headlights. In some embodiments, the vehicle control module 1511 is used to control vehicle audio related systems such as a vehicle's sound system, vehicle's audio warnings, a vehicle's microphone system, and a vehicle's horn system.

In some embodiments, the vehicle control module 1511 is used to control notification systems including warning systems for notifying passengers and/or driver of driving events, such as an approach to an intended destination or a potential collision. In some embodiments, the vehicle control module 1511 is used to adjust sensors such as the sensors 1503 of the vehicle. For example, the vehicle control module 1511 may modify the orientation of the sensors 1503, change output resolution and/or a format type of the sensors 1503, increase or decrease a capture rate, adjust a dynamic range, and adjust a focus of a camera. In addition, the vehicle control module 1511 may individually or collectively turn on/off operations of the sensors.

In some embodiments, the vehicle control module 1511 may be used to change parameters of the image preprocessor 1505 in a manner such as a manner of modifying frequency ranges of filters, adjusting features and/or edge detection parameters for object detection, or adjusting channels and bit depth. In various embodiments, the vehicle control module 1511 is used to control autonomous driving of the vehicle and/or a driver assistance function of the vehicle.

In some embodiments, the network interface 1513 is in charge of an internal interface between block components of the autonomous driving system 1500 and the communication unit 1515. Specifically, the network interface 1513 is an intercommunication interface for receiving and/or sending data including voice data. In various embodiments, the network interface 1513 interfaces with external servers in order to connect voice calls, receive and/or sends text messages, transmit the sensor data, updates software of the vehicle with the autonomous driving system, or to update software of the autonomous driving system of the vehicle through the communication unit 1515.

In various embodiments, the communication unit 1515 includes various wireless interfaces in a cellular or WiFi manner. For example, the network interface 1513 may be used to receive an update for operating parameters and/or instructions for the sensors 1503, the image preprocessor 1505, the deep learning network 1507, the AI processor 1509, and the vehicle control module 1511 from servers connected through the communication unit 1515. For example, a machine learning model of the deep learning network 1507 may be updated using the communication unit 1515. According to another example, the communication unit 1515 may be used to update operating parameters of the image preprocessor 1505 such as image processing parameters and/or firmware of the sensors 1503.

In another embodiment, the communication unit 1515 is used to activate communication for emergency services and emergency contact in an accident or a near-accident event. For example, in a crash event, the communication unit 1515 may be used to hail emergency services for assistance, and may notify the outside of emergency services of crash details and a location of the vehicle. In various embodiments, the communication unit 1515 may update or obtain an expected arrival time and/or a destination location.

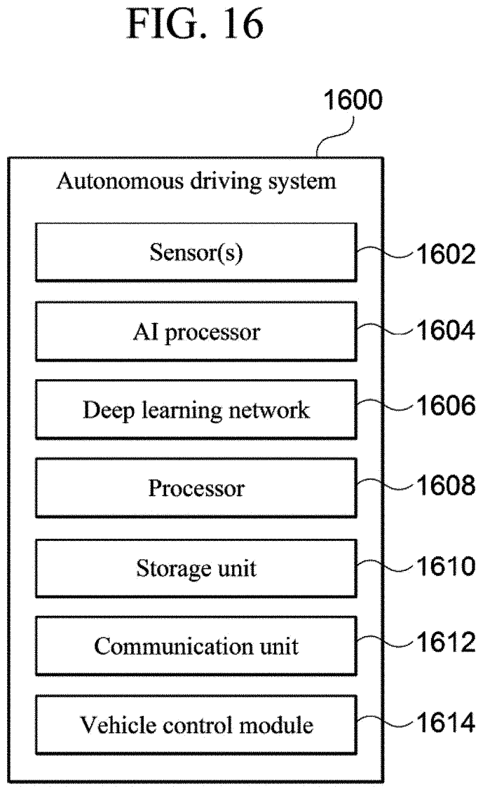

FIG. 16 is a block diagram of an autonomous driving system 1600 according to another embodiment of the present invention.

Referring to FIG. 16, sensors 1602 include one or more sensors. In various embodiments, the sensors 1602 may be attached to different locations of the vehicle and/or so as to face one or more different directions. For example, the sensors 1602 may be directed to a front, sides, a rear, and/or a roof of the vehicle in directions such as forward-facing, rear-facing, side-facing, and the like. In some embodiments, the sensors 1503 may include image sensors such as high dynamic range cameras and/or non-visual sensors. In some embodiments, the sensors 1602 may include a RADAR, a LiDAR, and/or an ultrasonic sensor in addition to the image sensors.

An AI processor 1604 may include a high-performance processor capable of accelerating learning of an AI algorithm such as deep learning by efficiently processing a large amount of data required in order to perform autonomous driving and autonomous parking of the vehicle.

A deep learning network 1606 is a deep learning network for implementing control commands for controlling autonomous driving and/or autonomous parking of the vehicle. For example, the deep learning network 1606 may be an artificial neural network, such as a convolutional neural network (CNN) trained using the sensor data, and an output of the deep learning network 1606 is provided to a vehicle control module 1614.

The processor 1608 may control overall operations of the autonomous driving system 1600, and control the sensor(s) 1602 to acquire sensor information necessary for the autonomous driving and/or the autonomous parking of the vehicle according to an output result of the deep learning network 1606. In addition, the processor 1608 may generate control information of the vehicle for performing the autonomous driving and/or the autonomous parking of the vehicle using the acquired sensor information and a deep learning result, and output the control information to the vehicle control module 1614.

In addition, when an autonomous parking request is input by the user, the processor 1608 may transfer an autonomous parking service request (parking lot empty space request message) to a server 1800 for providing a service through a communication unit 1612, and control the vehicle control module 1614 to perform autonomous driving and autonomous parking to a parking possible space according to an autonomous parking service response (parking empty space response message) received from the server 1800 for providing a service. In this case, the autonomous parking request by the user may be performed through a user's touch gesture input through a display unit (not illustrated) or a voice command input through a voice input unit.

In addition, the processor 1608 may perform control to download an application and/or map data for a service possible area from the server for providing a service through the communication unit 1612 when the vehicle enters a parking lot guidance service and/or autonomous parking service possible area.

In addition, when the vehicle arrives at a parking possible area and the autonomous parking of the vehicle is completed, the processor 1608 transmits a parking completion message to the server 1800 for providing a service through the communication unit 1612, and turns off an engine of the vehicle, or turns off power of the vehicle. In this case, the parking completion message may include parking completion time and location information of the vehicle, wake-up time information of the autonomous driving system 1600, and the like.

In addition, when an autonomous vehicle enters a parking space, a processor 1608 generates a control command for performing autonomous parking using various sensor information obtained from the sensors 1602 and outputs the control command to the vehicle control module 1614. For example, the processor 1608 may identify a parking slot located in a parking lot from a parking lot image obtained through an image obtaining sensor, and also identify whether or not a vehicle is parked in the parking slot. For example, when a parking line marked in the parking lot is detected through analysis of the parking lot image obtained through the image obtaining sensor, the processor 1608 may identify a detected area as a parking slot, and determine whether or not parking is possible according to whether or not a vehicle exists in the identified parking slot. In addition, the processor 1608 outputs a control command for parking the vehicle while preventing a collision with an obstacle using a direction and a location of the obstacle obtained from the sensors 1602 (ultrasonic sensor, RADAR, LiDAR, etc.) of the vehicle to the vehicle control module 1614 in order to autonomously park the vehicle in a parking possible slot.

In another embodiment, when the autonomous vehicle enters the parking space, the processor 1608 uses the sensor data of the sensors 1602 so as to move and park the vehicle to and at a location corresponding to location information of a parking possible slot received from the server 1800 for providing a service. Specifically, the processor 1608 outputs a control command for performing autonomous parking while avoiding collision with walls and pillars of the parking lot and other vehicles parked in other parking slots of the parking lot using the sensor data of the sensors 1602 to the vehicle control module 1614.

The storage unit 1610 may store training data for a deep learning network for performing the autonomous driving and/or the autonomous parking of the vehicle and/or software for performing the autonomous driving and/or the autonomous parking of the vehicle, and electronic map data for route guidance and the autonomous driving.

The communication unit 1612 transmits and receives data through a wireless communication network between the autonomous driving system 1600 and a user terminal apparatus 1700 and/or the server 1800 for providing a service.

The vehicle control module 1614 may output control commands for controlling acceleration, deceleration, steering, gear shift, and the like, of the vehicle for performing an autonomous driving function of the vehicle and/or an autonomous parking function of the vehicle to respective components. For example, the vehicle control module 1614 outputs an acceleration command to an engine and/or an electric motor of the vehicle when the acceleration of the vehicle is required, outputs a brake command to the engine and/or the electric motor or a braking device of the vehicle when the deceleration of the vehicle is required, and generates and outputs a control command for moving the vehicle in a determined vehicle traveling direction to a vehicle steering wheel or a vehicle wheel when a change of a vehicle traveling direction is required.

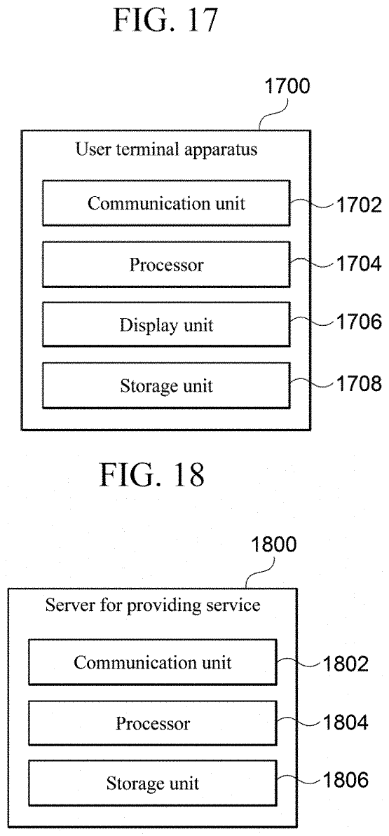

FIG. 17 is a block diagram of a user terminal apparatus 1700 according to another embodiment of the present invention.

The user terminal apparatus 1700 according to another embodiment of the present invention includes a communication unit 1702, a processor 1704, a display unit 1706, and a storage unit 1708. The communication unit 1702 is connected to and transmits and receives data to and from the autonomous driving system 1600 and/or the server 1800 for providing a service through a wireless network.

The processor 1704 controls overall functions of the user terminal apparatus 1700, and transmits an autonomous driving command and/or an autonomous parking command input from a user to the autonomous driving system 1600 through the communication unit 1702 according to another embodiment of the present invention. When a push notification message related to autonomous driving and/or autonomous parking is received from the server 1800 for providing a service, the processor 1704 controls the display unit 1706 to display the push notification message to the user. In this case, the push notification message may include autonomous driving information, autonomous parking completion, parking location information, fee information, and the like. In addition, when a parking fee payment request input is received by the user, the processor 1704 may run an application for payment of a parking fee to confirm payment information (credit card information, account number, etc.) of the user, and request a server (not illustrated) for providing a payment service of the user to pay a parking fee charged by the server 1800 for providing a service.

In addition, when a vehicle hailing service provision is requested from the user, the processor 1704 according to another embodiment of the present invention drives a vehicle hailing application and outputs the vehicle hailing application through the display unit 1706, and transmits a vehicle hailing service request message to the server 1800 for providing a service through the communication unit 1702 when a vehicle hailing location is input and a vehicle hailing command is then input from the user. In addition, when a vehicle hailing request success message is received from the server 1800 for providing a service through the communication unit 1702, the processor 1704 according to another embodiment of the present invention provides a notification for notifying the user that the vehicle hailing request has been successfully made to the user through the vehicle hailing application.

In addition, when various information (vehicle departure notification, estimated time of arrival and current location of a vehicle, and arrival notification information) according to a vehicle hailing service is received from the server 1800 for providing a service, the processor 1704 according to another embodiment of the present invention provides the various information to the user through a push notification message or the like.

In addition, when it is determined that current location information of the vehicle has deviated from a service possible area, the processor 1704 according to another embodiment of the present invention may perform control to transmit a notification for notifying the user that the vehicle has deviated from the service possible area to the server 1800 for providing a service through the communication unit 1702, and perform control to delete the vehicle hailing application and/or an autonomous parking application downloaded from the server 1800 for providing a service and stored in the storage unit 1708.

In addition, the storage unit 1708 of the user terminal apparatus 1700 may store at least one data of an application for an autonomous parking service and/or a vehicle hailing service, a route guidance application, map data, and user payment information.

When a user gesture for the autonomous parking service application displayed through the display unit 1706 is input, the processor 1704 may perform an operation corresponding to the user gesture. For example, when a selection gesture for selecting an autonomous parking service providing parking lot and parking slot is input from the user through an user experience (UX) of the display unit 1706, the processor 1704 may transmit an autonomous parking service request including a vehicle ID, a parking lot ID, and a parking slot ID to the server 1800 for providing a service through the communication unit 1702. In this case, the parking lot ID is information for identifying a parking lot supporting the autonomous parking service, and location information of the corresponding parking lot may also be mapped and stored in the storage unit 1806.

Through this process, in another embodiment of the present invention, it is also possible for the user to reserve a space in which the vehicle is to be autonomously parked in the parking lot through the user terminal apparatus 1700. In addition, when parking is impossible for the parking lot ID included in the autonomous parking service request and the parking spot ID of the parking lot ID, the server 1800 for providing a service may transmit a parking impossible message to the user terminal apparatus 1700 or transmit another parking possible parking lot ID and/or parking possible slot ID to the user terminal apparatus 1700. The user terminal apparatus 1700 may visually display a parking slot corresponding to a parking possible slot ID, a parking slot corresponding to a parking impossible slot ID, and the like, on an autonomous parking service providing application through the display unit 1706.

In the present specification, the parking lot ID is information given in order to identify a parking lot, and may be set to be mapped to location information on a location at which a parking lot is located, and the parking slot ID is information for identifying a plurality of parking slots included in a corresponding parking lot, and may be set to be mapped to relative location information of each parking slot.

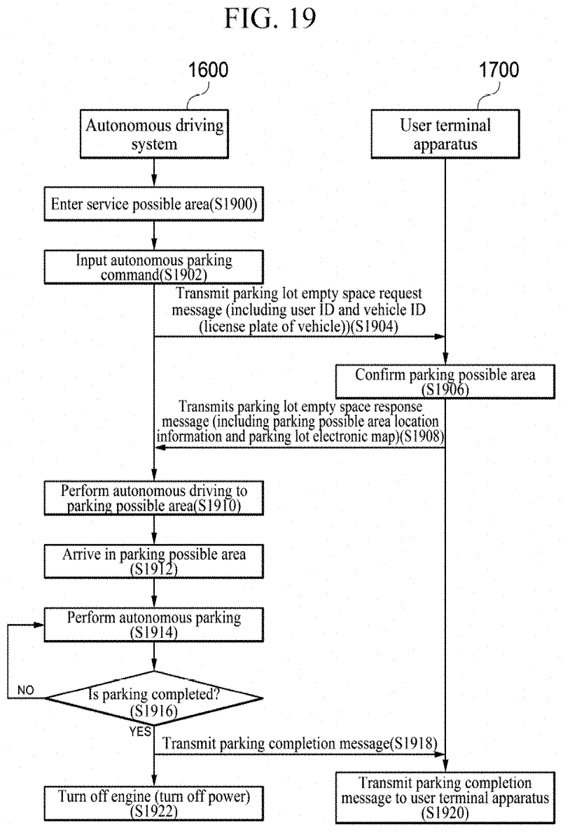

FIG. 18 is a block diagram of a server 1800 for providing a service according to another embodiment of the present invention.

The server 1800 for providing a service according to another embodiment of the present invention includes a communication unit 1802, a processor 1804, and a storage unit 1806. The communication unit 1802 of the server 1800 for providing a service according to another embodiment of the present invention is connected to and transmits and receives data to and from the autonomous driving system 1600 and/or the user terminal apparatus 1700 through a wireless network.

The processor 1804 of the server 1800 for providing a service according to another embodiment of the present invention confirms a parking possible area when a parking lot empty space request message is received from the autonomous driving system 1600 through the communication unit 1802, and transmits location information of the parking possible area and digital map data of the parking lot to the autonomous driving system through the communication unit 1802 when the parking possible area is confirmed. At this time, the processor 1804 of the server 1800 for providing a service confirms a parking possible area through parking lot images obtained from a closed circuit television (CCTV) located in the parking lot and image capturing apparatuses of vehicles parked in the parking lot, a parking lot model generated in order to represent a real-time situation of the parking lot, and sensor information obtained from sensors located in parking slots. Specifically, empty parking slots in the parking lot and parking slots in which vehicles are parked may be distinguished from each other through analysis of parking lot images obtained from the CCTV located in the parking lot and an image capturing apparatus of a parked vehicle. In addition, sensors installed in each parking slot within the parking lot may sense whether or not a vehicle has been parked in the corresponding parking slot, and the processor 1804 of the server 1800 for providing a service may identify empty parking slots in the parking lot and parking slots in which the vehicles are parked using the sensed information. In addition, the processor 1804 of the server 1800 for providing a service according to another embodiment of the present invention may include the confirmed parking possible area in a parking lot empty space response message and then transmit the parking lot empty space response message to the autonomous driving system 1600 or the user terminal apparatus 1700 through the communication unit 1802. In addition, when a parking completion message is received from the autonomous driving system 1600, the processor 1802 transmits the parking completion message to the user terminal apparatus 1700 through the communication unit 1802.

When a vehicle hailing service request is received from the user terminal apparatus 1700 through the communication unit 1802, the processor 1804 of the server 1800 for providing a service according to another embodiment of the present invention searches for a parking location corresponding to a vehicle identifier (VID) in the parking lot, transfers the vehicle hailing service request to an autonomous driving system 1600 of a vehicle parked at the searched parking location, and transmits information received as a response to the vehicle hailing service from the autonomous driving system 1600 to the user terminal apparatus 1700.

The processor 1804 of the server 1800 for providing a service according to another embodiment of the present invention stores a location of a parking lot providing an autonomous parking service, map data, a parking lot model representing a real-time situation of the parking lot, parking lot data, a parking lot image, and parking space information in the storage unit 1806. In addition, when the vehicle of the user who has requested the vehicle hailing service and the autonomous parking service deviates from the service possible area, the processor 1804 of the server 1800 for providing a service according to another embodiment of the present invention deletes a vehicle ID, a user ID, and related information stored in the storage unit 1806.

When autonomous parking service requests are received from a plurality of user terminal apparatuses 1700 through the communication unit 1802, the processor 1804 of the server 1800 for providing a service may schedule an order in which the autonomous parking services of the respective vehicles are to be performed, and transmit an autonomous parking service response for each vehicle according to the scheduled order.

In addition, when an autonomous parking service request message is received from the user terminal apparatus 1700, the processor 1804 of the server 1800 for providing a service according to another embodiment may retrieve parking lot ID and parking slot ID information included in the autonomous parking service request message from the map data stored in the storage unit 1806, and transmit location information of the retrieved parking lot ID and location information of the retrieved parking slot ID to the autonomous driving system 1600 to cause the autonomous driving system 1600 to perform autonomous driving and/or autonomous parking to the corresponding parking lot location.

The processor 1804 of the server 1800 for providing a service according to another embodiment of the present invention may store parking lot-related information in the form illustrated in the following Table 1 in the storage unit 1806 in order to provide the autonomous parking service.

TABLE 1

| | Parking | | Parking | Parking slot | Parking | Parking | | User | Vehicle |
|---|---|---|---|---|---|---|---|---|---|
| Field | lot ID | Floor | Slot ID | state | Time | Date | Fare | ID | ID |
| 1 | 69 | B3 | 74 | Full | 1 hour | Sep. 30, 2020 | $4 | Junseo | FN3542 |
| . . . | . . . | . . . | . . . | . . . | . . . | . . . | . . . | . . . | . . . |
| | 80 | 1^{st} | 84 | Empty | — | — | — | — | — |
| | | Floor | | | | | | | |
| | 42 | B2 | 34 | Reserved | — | — | — | Jioh | DHI6802 |

The processor 1804 of the server 1800 for providing a service according to another embodiment of the present invention may store a database having the form as illustrated in the above Table 1 in the storage unit 1806 in order to provide the autonomous parking service, and update data of the database whenever a parked state of a vehicle for a corresponding parking slot is changed.

For example, when the autonomous parking service request message is received from the user terminal apparatus 1700, the processor 1804 of the server 1800 for providing a service retrieves information on a parking possible lot and parking slots from the database, and then transmits the retrieved parking lot ID, parking slot ID, and corresponding location information to the autonomous driving system 1600 of the vehicle connected to the user terminal apparatus 1700. In addition, when it is confirmed that the vehicle has entered the parking lot for autonomous parking and confirms that parking has been completed in the parking slot, the processor 1804 of the server 1800 for providing a service changes parking slot state information to Full, and updates a parking time, a parking date, fee information, user ID, and vehicle ID information.

On the other hand, when a vehicle hailing request from the user terminal apparatus 1800 for the autonomously parked vehicle is received, the processor 1804 of the server 1800 for providing a service updates a data field of the above Table 1 stored in the database. For example, when the vehicle is changed to an autonomous driving state and then deviates from the parking slot, the processor 1804 changes the parking slot state to Empty, and initializes the parking time, the parking date, the parking fee information, and the like, for the corresponding parking slot when the user pays a parking fee.

On the other hand, when a parking slot in which the autonomous vehicle is to be parked is selected from the user terminal apparatus 1700, the processor 1804 of the server 1800 for providing a service may change the selected parking slot ID field in the database to a reserved state and update user ID and vehicle ID fields to prevent the autonomous parking service for a duplicate parking slot ID from being provided to other users.

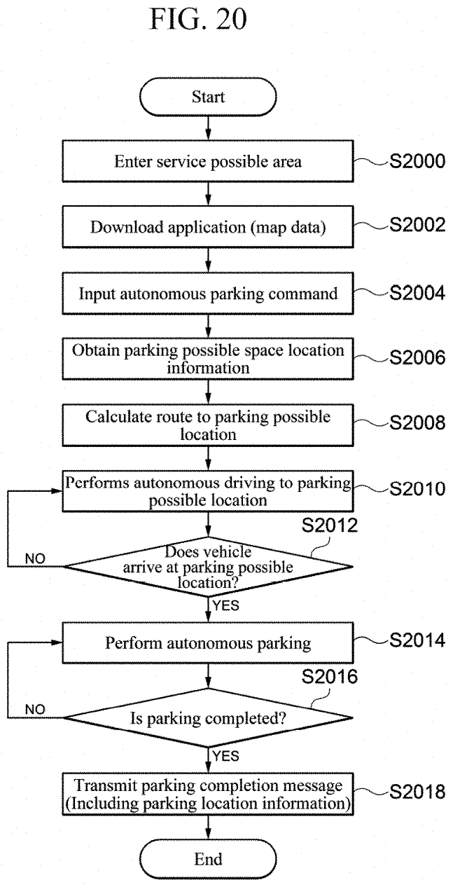

FIG. 19 is a flowchart for describing a flow of operations of an autonomous parking system according to another embodiment of the present invention.

First, when the vehicle enters the service possible area (S1900) and an autonomous parking command is input from the user (S1902), the autonomous driving system 1600 transmits a parking lot empty space request message to the server 1800 for providing a service (S1904). In this case, the parking lot empty space request message may include a user ID and a vehicle ID requesting the autonomous parking service. In this case, the user ID may include information that may identify the user, such as an ID subscribed to the autonomous parking service or a social security number, and the vehicle ID may include information that may identify the vehicle, such as a license plate of the vehicle or a vehicle identification number (VIN).

In addition, the server 1800 for providing a service which has received the parking lot empty space request message confirms a parking possible area in the parking lot in which the vehicle is to be parked (S1906), and transmits a parking lot empty space response message to the autonomous driving system 1600 (S1908). In this case, the parking lot empty space response message may include parking possible area location information and a parking lot electronic map. In the confirming (S1906) of the parking possible area by the server 1800 for providing a service, parking possible states for each parking slot may be identified through an image obtained from a CCTV installed in the parking lot, images obtained from image capturing apparatuses installed in vehicles parked in respective parking slots of the parking lot, and sensed data sensed by sensors installed in the respective parking slots.

The autonomous driving system 1600 which has received the parking lot empty space response message in S1908 calculates a route from a current location of the vehicle to the confirmed parking possible area location information, and then performs autonomous driving to the parking possible area (S1910).

Then, when the vehicle arrives in the parking possible area (S1912), the autonomous driving system 1600 performs autonomous parking (S1914), transmits a parking completion message to the server 1800 for providing a service (S1918) when the parking is completed (“Yes” in S1916), and turns off an engine of the vehicle or turns off power of the vehicle (S1922). In this case, the parking completion message may include location information on a location at which the vehicle is parked and time information on a time when the vehicle is parked.

The server 1800 for providing a service that has received the parking completion message in S1918 transmits the parking completion message to the user terminal apparatus 1700 (S1920).

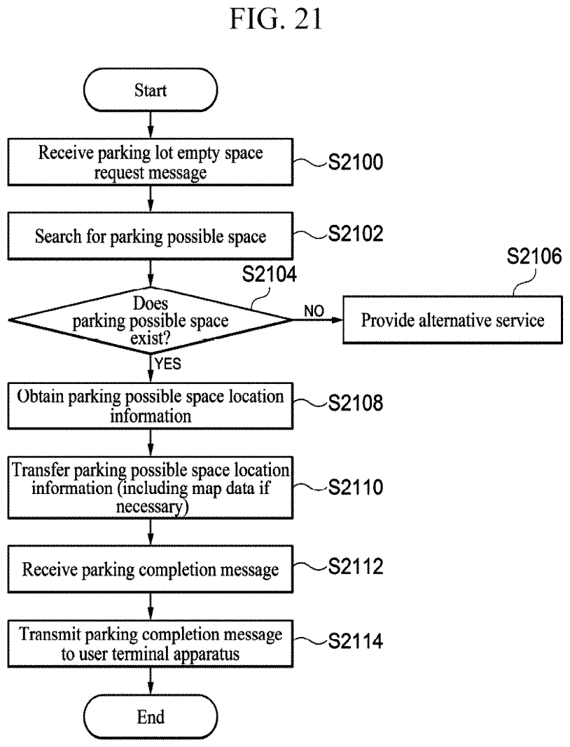

FIG. 20 is a flowchart for describing a flow of autonomous parking operations of the user terminal apparatus 1700 according to another embodiment of the present invention.

First, when the vehicle enters a service possible area (S2000), the user terminal apparatus 1700 downloads an application for providing an autonomous parking service from the server for providing a service (S2002). In this case, when the user terminal apparatus 1700 downloads the application, the user terminal apparatus 1700 may also download map data for a parking lot. Then, when an autonomous parking command is input from the user (S2004), the user terminal apparatus 1700 obtains parking possible space location information (S2006), calculates a route from a current location of the vehicle on the map data to a location of the obtained parking possible space (S2008), and performs autonomous driving to the parking possible location according to the calculated route (S2010). When the autonomous vehicle arrives at the parking possible location (“Yes” in S2012), the user terminal apparatus 1700 performs autonomous parking (S2014), and transmits a parking completion message to the server for providing a service (S2018) when the parking is completed (“Yes” in S2016). In this case, the parking completion message may include parking location information and parking completion time information. In this case, the parking location information may also include a parking lot ID, a parking lot location, and a parking slot (parking space) ID, and location information of the parking slot.

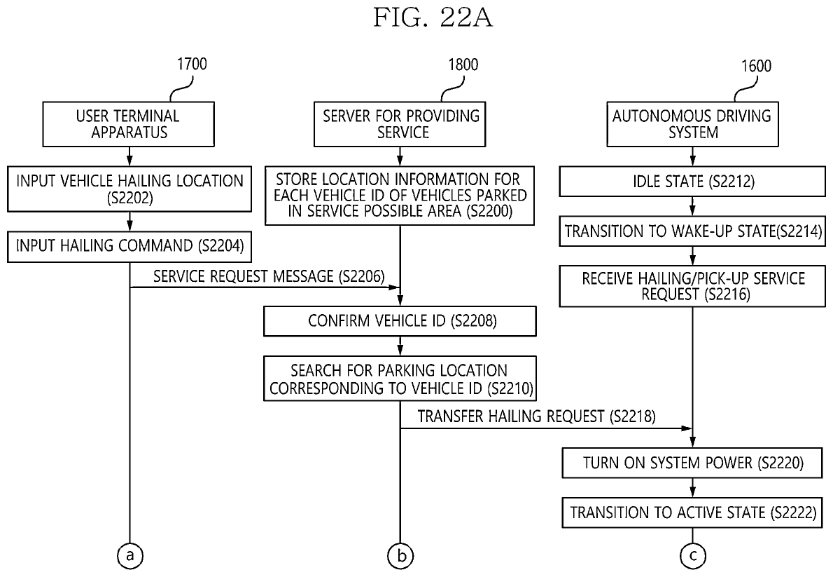

FIG. 21 is a flowchart for describing a flow of autonomous parking operations of the server 1800 for providing a service according to another embodiment of the present invention.

First, when a parking lot empty space request message is received (S2100), the server 1800 for providing a service searches for a parking possible space (S2102). When the parking possible space exists as a search result (“Yes” in S2104), the server 1800 for providing a service obtains parking possible space location information (S2108), and when the parking possible space does not exist (“No” in S2104), the server 1800 for providing a service provides an alternative service (S2106). In this case, the alternative service includes a function of searching for and guiding a nearby parking lot location and parking possible space or notifying the user that there is no parking possible space.

Then, the server 1800 for providing a service transfers the parking possible space location information to the autonomous driving system 1600 (S2110), and transmits a parking completion message to the user terminal apparatus 1700 (S2114) when the parking completion message is received from the autonomous driving system 1600 (S2112).

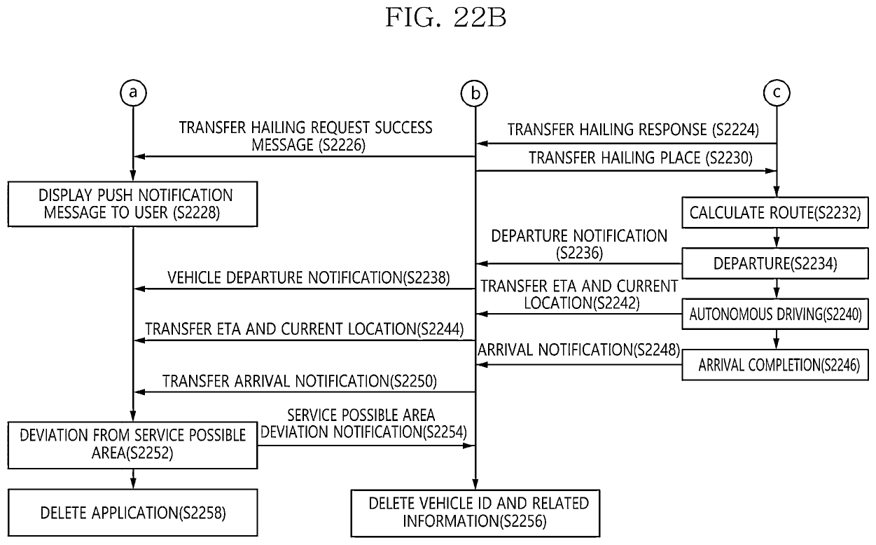

FIGS. 22A and 22B are flowcharts for describing a flow of operations for providing a vehicle hailing service or a passenger pick-up service of an autonomous driving system according to another embodiment of the present invention.

First, the server 1800 for providing a service stores location information for each vehicle ID of vehicles parked in a service possible area (S2200). Then, when a vehicle hailing location is input from a user (S2202) and a vehicle hailing command is input from the user (S2204), the user terminal apparatus 1700 transmits a vehicle hailing service request message to the server 1800 for providing a service (S2206). The server 1800 for providing a service that has received the vehicle hailing request message in S2206 confirms a vehicle ID (ID of a target vehicle to be hailed) included in the vehicle hailing request message (S2208), searches for a parking location corresponding to the confirmed vehicle ID (S2210) when it is identified that the vehicle ID is a vehicle of a user who is a vehicle hailing service providing target, and transfers a hailing request to the autonomous driving system 1600 of the hailed vehicle (S2218).

Then, the autonomous driving system 1600 transitions from an idle state (step S2212) to a wake-up state (S2214). In this case, the transition from the idle state to the wake-up state may occur per predetermined period or at a predetermined time. The reason why the autonomous driving system 1600 transitions from the idle state to the wake-up state whenever necessary is to save power of a battery of the vehicle. The processor 1608 of the autonomous driving system 1600 transitioning to the wake-up state in S2214 may supply power to the communication unit 1612 to demodulate/decode signals transmitted to the autonomous driving system 1600. In addition, the autonomous driving system 1600 checks whether a vehicle hailing service/passenger pick-up service request is received (S2216), turns on system power of the vehicle (S2220) when the hailing request message is received in S2218, and then transitions to an active state (S2222). When the autonomous driving system 1600 transitions to the active state in S2222, the autonomous driving system 1600 supplies operating power for driving each part of the vehicle for autonomous driving of the vehicle, and generates a control command for vehicle control.

The autonomous driving system 1600 transitioning to the active state in S2222 transmits a vehicle hailing response message to the server 1800 for providing a service (S2224), and the server 1800 for providing a service transmits a vehicle hailing request success message to the user terminal apparatus 1700 as response to the vehicle hailing service request message in S2206 (S2226). The user terminal apparatus 1700 receiving the vehicle hailing request success message in S2226 displays a push notification message notifying the user that the vehicle hailing has been successful (S2228).

Then, the server 1800 for providing a service that has transmitted the vehicle hailing request success message to the user terminal apparatus 1700 in S2226 transfers a message including hailing place information to the autonomous driving system 1600 (S2230). The autonomous driving system 1600 calculates a route for autonomous driving to the hailing place (S2232), and transmits a departure notification message to the server 1800 for providing a service (S2236) when the vehicle starts to be driven (S2234).

The server 1800 for providing a service transmits a vehicle departure notification message to the user terminal apparatus 1700 (S2238), and the server 1800 for providing a service transfers estimated time of arrival (ETA) information and current location information of the vehicle to the user terminal apparatus 1700 (S2244) when an ETA and current location information transmitted by the autonomous driving system 1600 while the autonomous driving system 1600 performs autonomous driving (S2240) is transferred (S2242).

Then, when the vehicle arrives at the hailing location (S2246), the autonomous driving system 1600 transfers an arrival notification to the server 1800 for providing a service (S2248), and the server 1800 for providing a service transfers the arrival notification to the user terminal apparatus 1700 (S2250).

In addition, when the vehicle deviates from a service possible area (S2252), the user terminal apparatus 1700 transmits a service possible area deviation message to the server 1800 for providing a service (S2254), the server 1800 for providing a service deletes a vehicle ID and related information included in the service possible area deviation message (S2256), and the user terminal apparatus 1700 may automatically delete a vehicle hailing service application (S2258).

On the other hand, it has been described that S2252, S2254, and S2258 are performed by the user terminal apparatus 1700 in FIGS. 22A and 22B, but S2252, S2254, and S2258 may also be performed by the autonomous driving system 1600 of the vehicle.

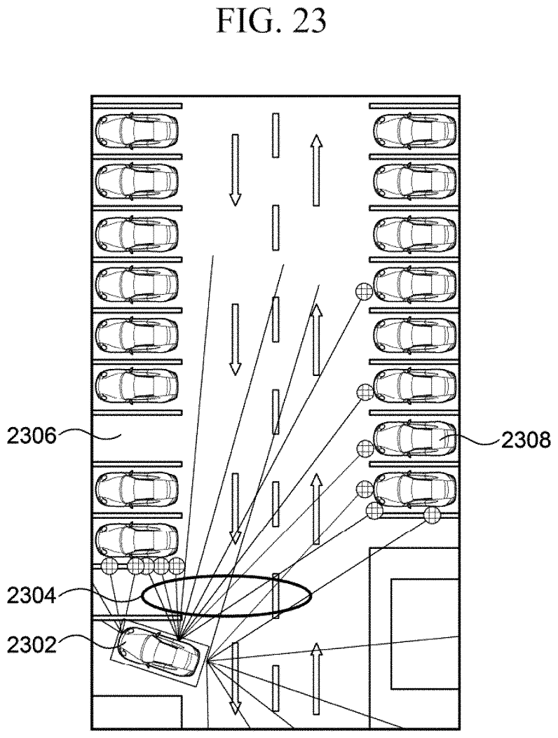

FIG. 23 is a view for describing a process in which an autonomous driving system of a vehicle performs autonomous parking according to another embodiment of the present invention.

An autonomous driving system of a vehicle 2302 recognizes the existence of a parking possible space 2306 and a parked vehicle 2308 by data 2304 sensed by the sensors 1602 attached to the vehicle 2302 and a deep learning result by learning of the deep learning network 1606, and then performs autonomous parking to the parking possible space.

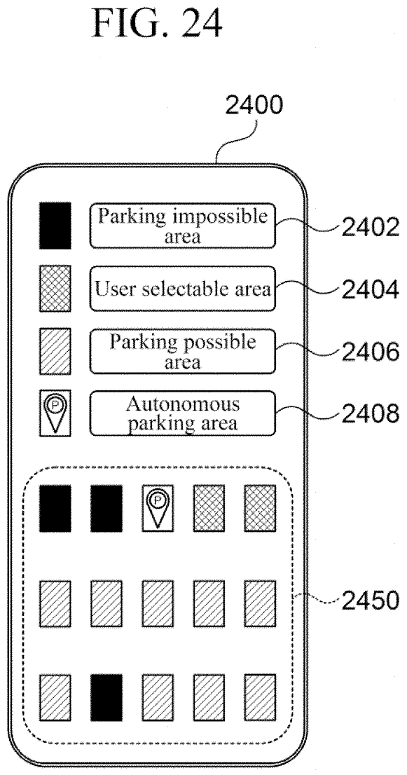

FIG. 24 is a view illustrating a UX screen 2400 displayed on the user terminal apparatus 1700 when an autonomous parking system of the vehicle performs autonomous parking according to another embodiment of the present invention.

In FIG. 24, reference number 2402 denotes an area where parking is impossible due to parking of other vehicles, or the like, in a parking lot in which the vehicle is to perform autonomous parking, reference number 2404 denotes an autonomous parking area selectable by a user, reference number 2406 denotes an empty space area in which parking is possible, and reference numeral 2408 denotes an area in which the vehicle is autonomously parked.

Reference number 2450 is a screen visually showing a parking space in which the vehicle has completed autonomous parking in the parking lot. An area denoted by reference number 2450 may move and display the parking space of the parking lot on the display unit 1706 of the user terminal apparatus 1700 according to a user's touch gesture (drag, pinch-to-zoom, etc.).

In addition, the processor 1704 of the user terminal apparatus 1700 according to another embodiment of the present invention may transmit a parking lot ID and a parking slot ID corresponding to the parking area selected by the user through the display unit 1706 to the server 1800 for providing a service through the communication unit 1702.

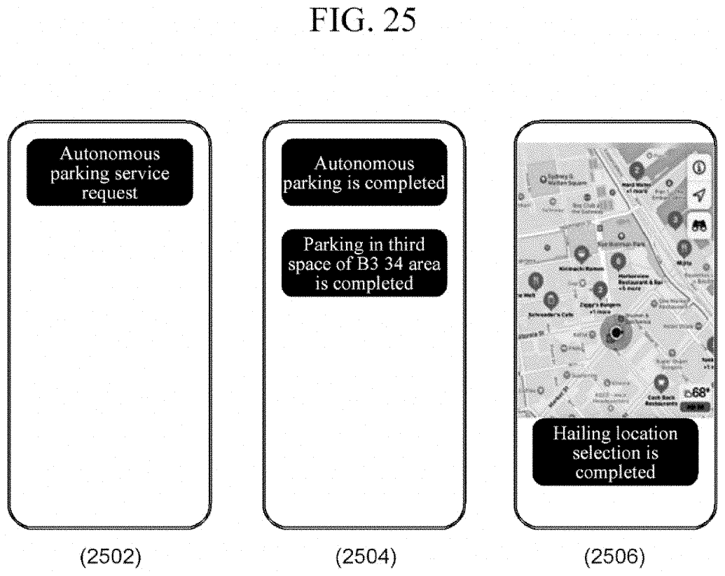

FIG. 25 is a view illustrating an example of a push notification or a push message displayed on a user terminal apparatus 1700 of a user using an autonomous parking service/vehicle hailing service of a vehicle according to another embodiment of the present invention.

Reference numeral 2502 is a view illustrating a message for receiving an autonomous parking service request function, and when the user selects the message through a touch gesture, the user terminal apparatus transmits an autonomous parking service request message to the server for providing a service.

Reference numeral 2504 is a view illustrating a message notifying the user that autonomous parking of the vehicle in the parking lot by a request of the user has been completed and a space location at which the vehicle is parked in a text form. In addition, a push notification displayed in the text form of reference number 2504 may be linked to a hyperlink capable of displaying a location at which the vehicle is parked on a map. That is, when the user selects a push notification message of reference number 2504 indicating a location at which the vehicle is parked, the processor 1704 of the user terminal apparatus 1700 may display a location at which the vehicle is parked on the map data in a symbol form while running a map data application.

Reference numeral 2506 is a view illustrating that selection of the hailing location has been completed while displaying a hailing location on the map when a vehicle hailing location is selected on the map by a request of the user. The vehicle hailing location of reference number 2506 may be moved on the map by a user's touch gesture.

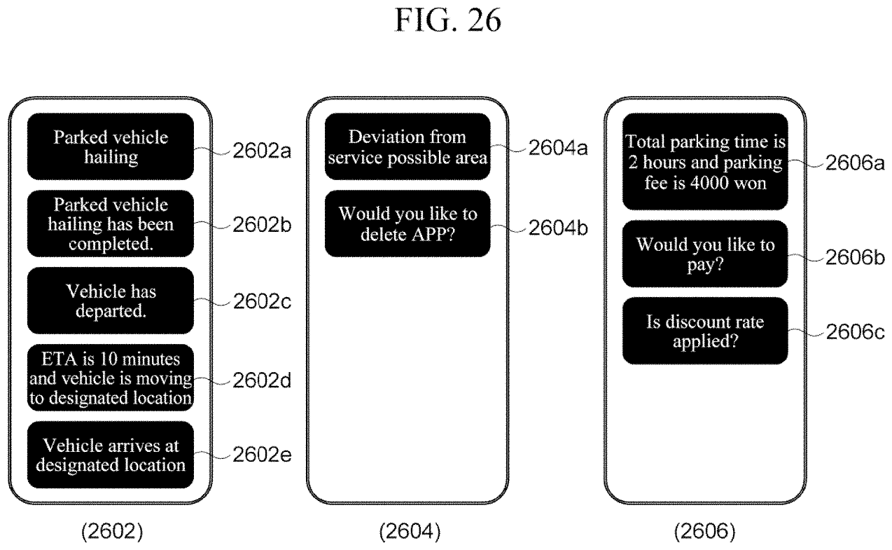

FIG. 26 is a view illustrating an example of a push notification or a push message displayed on a user terminal apparatus 1700 of a user using an autonomous parking service of a vehicle according to another embodiment of the present invention.

Reference numeral 2602 is a view for describing a message displayed on the user terminal apparatus 1700 when a user hails a parked vehicle, and when the user selects a parked vehicle hailing message 2602a, the user terminal apparatus 1700 sends a vehicle hailing request message to the server for providing a service. In addition, the user terminal apparatus 1700 may display a parked vehicle hailing completion message 2602b, a vehicle departure notification message 2602c, an ETA and movement information display message 2602d, and an arrival notification message 2602e.

Reference numeral 2604 is a view in which the user terminal apparatus 1700 displays a message 2604a notifying the user that the vehicle has deviated from a service possible area and a vehicle hailing application deletion message 2604b that may be used only in a designated service possible area. When the application deletion message 2604b is selected by a request of the user, the corresponding application is deleted.

Reference numeral 2606 is a view in which the user terminal apparatus 1700 displays a message 2606a for displaying a parking time and a parking fee, a payment progress message 2606b, and a discount rate application notification message 2606c. In order for the user to be applied with a discount rate for the parking fee, the user may input a QR code through a camera of the user terminal apparatus 1700 or input a discount code through an input unit of the user terminal apparatus 1700.

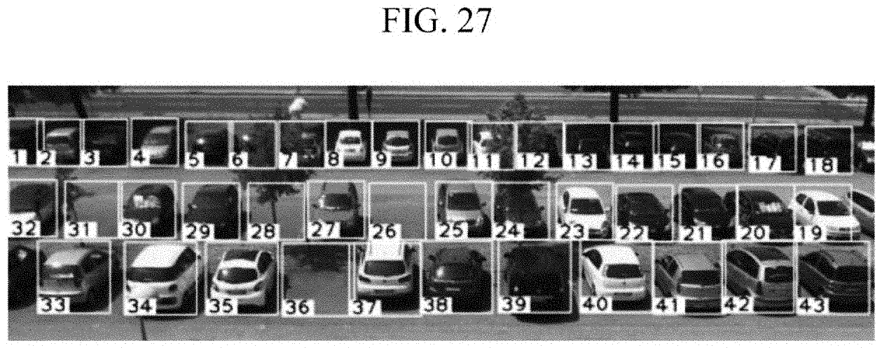

FIG. 27 is a view for describing an example in which the server 1800 for providing a service identifies a parking possible space through deep learning analysis when an autonomous parking service of a vehicle is requested according to another embodiment of the present invention.

When a parking lot image is input through an image obtaining apparatus such as a CCTV located in a parking lot, the server 1800 for providing a service identifies parking slots of a parking lot through analysis of the parking lot image through deep learning according to another embodiment of the present invention, and determines whether or not vehicles have been parked for each identified parking slot. In FIG. 27, Nos. 1 to 43 are parking slot IDs assigned to each parking slot, and the server 1800 for providing a service may recognize parking lines marked on a road from the obtained parking lot image, and identify the parking slots through a recognized result. In addition, the server 1800 for providing a service may identify a parking space in which a vehicle requesting autonomous parking may be parked by additionally analyzing whether or not a vehicle learned through deep learning is located in each parking slot. In FIG. 27, parking slots of Nos. 26, 31, and 36 may be determined as parking possible locations.

In addition, the server 1800 for providing a service may transmit a parking lot ID of a parking lot determined as a parking lot in which the vehicle may be parked, location information of the parking lot, and a parking slot ID in the parking lot ID to the autonomous driving system 1600. The parking lot ID of the parking lot determined as the parking lot in which the vehicle may be parked, the location information of the parking lot, and the parking slot ID in the parking lot ID may be included in parking possible information. Then, after the parking possible information is transmitted to the autonomous driving system 1600, the server 1800 for providing a service sets the parking slot ID of the parking lot ID included in the transmitted parking possible information to parking reservation completion to prevent a duplicate service by not providing the service even though a parking service provision request using the corresponding parking slot ID is received from another vehicle.

In addition, when the vehicle deviates from the parking lot, the server 1800 for providing a service updates vehicle parking state information of the parking slot by resetting a parking slot ID of the parking slot in which the vehicle was parked to an empty space.

### II. Autonomous Driving System

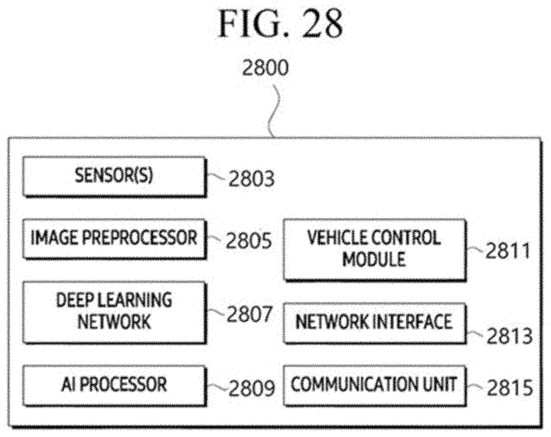

FIG. 28 is a block diagram illustrating an autonomous driving system 2800 of a vehicle according to an embodiment.

The autonomous driving system 2800 of the vehicle according to FIG. 28 may be a deep learning network including sensors 2803, an image preprocessor 2805, a deep learning network 2807, an artificial intelligence (AI) processor 2809, a vehicle control module 2811, a network interface 2813, and a communication unit 2815. In various embodiments, each element may be connected through various interfaces. For example, sensor data sensed and output by the sensors 2803 may be fed to the image preprocessor 2805. The sensor data processed by the image preprocessor 2805 may be fed to the deep learning network 2807 executed by the AI processor 2809. The output of the deep learning network 2807 executed by the AI processor 2809 may be fed to the vehicle control module 2811. Intermediate results of the deep learning network 2807 executed by the AI processor 2807 may be fed to the AI processor 2809. In various embodiments, the network interface 2813 transmits autonomous driving route information and/or autonomous driving control commands for autonomous driving of the vehicle to internal block configurations by performing communication with the electronic device of the vehicle. In an embodiment, the network interface 2813 may be used to transmit sensor data obtained through the sensor(s) 2803 to an external server. In some embodiments, autonomous driving control system 2800 may include additional or fewer components as appropriate. For example, in some embodiments, the image preprocessor 2805 may be an optional component. For another example, the post-processing component (not shown in FIG. 28) may be included in the autonomous driving control system 2800 to perform post-processing in the output of the deep learning network 2807 before the output is provided to the vehicle control module 2811.

In some embodiments, sensors 2803 may include one or more sensors. In various embodiments, sensors 2803 may be attached to different locations of the vehicle. Sensors 2803 may face one or more different directions. For example, the sensors 2803 may be directed toward the front, sides, rear and/or roof of the vehicle to face forward-facing, rear-facing, side-facing, etc. directions. In some embodiments, sensors 2803 may be image sensors such as high dynamic range cameras. In some embodiments, sensors 2803 include non-visual sensors. In some embodiments, sensors 2803 include RADAR, light detection and ranging (LiDAR), and/or ultrasonic sensors in addition to the image sensor. In some embodiments, the sensors 2803 are not mounted on a vehicle having the vehicle control module 2811. For example, sensors 2803 are included as part of a deep learning system for capturing sensor data and may be attached to the environment or road and/or mounted on surrounding vehicles.

In some embodiments, the image pre-processor 2805 may be used to preprocess sensor data of sensors 2803. For example, image preprocessor 2805 may be used to preprocess sensor data, to split sensor data into one or more components, and/or to post-process one or more components. In some embodiments, the image preprocessor 2805 may be a graphics processing unit (GPU), a central processing unit (CPU), an image signal processor, or a specialized image processor (GPP). In various embodiments, the image preprocessor 2805 may be a tone-mapper processor for processing high dynamic range data. In some embodiments, the image preprocessor 2805 may be a component of the AI processor 2809.

In some embodiments, a deep learning network 2807 may be a deep learning network for implementing control commands for controlling an autonomous vehicle. For example, the deep learning network 2807 may be an artificial neural network such as a convolutional neural network (CNN) trained using sensor data, and the output of the deep learning network 2807 is provided to the vehicle control module 2811.

In some embodiments, the artificial intelligence (AI) processor 2809 may be a hardware processor for running the deep learning network 2807. In some embodiments, AI processor 2809 is a specialized AI processor for performing inference over convolutional neural networks (CNNs) on sensor data. In some embodiments, the AI processor 2809 may be optimized for a bit depth of sensor data. In some embodiments, AI processor 2809 may be optimized for deep learning operations such as operations of a neural network including convolution, inner, vector and/or matrix operations. In some embodiments, the AI processor 2809 may be implemented through a plurality of graphic processing units (GPUs) that can effectively perform parallel processing.

While the AI processor 2809 is executed, the AI processor 2809, in various embodiments, may perform deep learning analysis on sensor data received from the sensor(s) 2803 and be coupled through an input/output interface to a memory configured to provide an AI processor with instructions that cause determining the machine learning result used to operate the vehicle at least partially autonomously. In some embodiments, the vehicle control module 2811 may be used to process commands for vehicle control output from the artificial intelligence (AI) processor 2809 and translate the output of the AI processor 2809 into instructions for controlling the module of each vehicle to control various modules of the vehicle. In some embodiments, the vehicle control module 2811 is used to control a vehicle for autonomous driving. In some embodiments, the vehicle control module 2811 may adjust the steering and/or speed of the vehicle. For example, the vehicle control module 2811 may be used to control driving of a vehicle such as deceleration, acceleration, steering, lane change, and lane keeping. In some embodiments, the vehicle control module 2811 may generate control signals for controlling vehicle lighting, such as brake lights, turns signals, and headlights. In some embodiments, the vehicle control module 2811 may be used to control vehicle audio-related systems such as vehicle's sound system, vehicle's audio warning, vehicle's microphone system, vehicle's horn system, and the like.

In some configurations, vehicle control module 2811 may be used to control notification systems including warning systems for notifying passengers and/or drivers of driving events such as access to the intended destination or potential collision. In some embodiments, the vehicle control module 2811 may be used to adjust sensors such as sensors 2803 of the vehicle. For example, the vehicle control module 2811 may modify the orientation direction of the sensors 2803 and change output resolution and/or format type of sensors 2803, increase or decrease capture rate, adjust dynamic range and the focus of the camera. In addition, the vehicle control module 2811 may individually or collectively turn on/off the operations of the sensors.

In some embodiments, vehicle control module 2811 may be used to change parameters of image preprocessor 2805 in such a way as modifying the frequency range of filters or adjusting features and/or edge detection parameters for object detection, or adjusting channels and bit depths. In various embodiments, the vehicle control module 2811 may be used to control autonomous driving and/or driver assistance functions of the vehicle.

In some embodiments, the network interface 2813 may serve as an internal interface between the block configurations of the autonomous driving control system 2800 and the communication unit 2815. Specifically, the network interface 2813 may be a communication interface for receiving and/or transmitting data including voice data. In various embodiments, the network interface 2813 may be connected to external servers to connect voice calls, receive and/or send text messages, transmit sensor data, or update the vehicle's software to an autonomous driving system and update software of the autonomous driving system of the vehicle through the communication unit 2815.

In various embodiments, the communication unit 2815 may include various wireless interfaces of a cellular or WiFi. For example, the network interface 2813 may be used to receive updates on operating parameters and/or instructions for sensors 2803, image preprocessor 2805, deep learning network 2807, AI processor 2809, and vehicle control module 2811 from the external servers connected through communication unit 2815. For example, the machine learning model of the deep learning network 2807 may be updated using the communication unit 2815. According to another example, the communication unit 2815 may be used to update operating parameters of the image preprocessor 2805 such as image processing parameters and/or firmware of the sensors 2803.

In another embodiment, communication unit 2815 may be used to activate communication for emergency services and emergency contact in an accident or a near-accident event. For example, in a collision event, communication unit 2815 may be used to call emergency services for assistance, and may be used to inform the outside of the collision details and the location of the vehicle for emergency services. In various embodiments, the communication unit 2815 may update or obtain the expected arrival time and/or destination location.

According to an embodiment, the autonomous driving system 2800 illustrated in FIG. 28 may be configured as an electronic device of a vehicle. According to an embodiment, when an autonomous driving release event occurs from a user during autonomous driving of a vehicle, the AI processor 2809 of the autonomous driving system 2800 may control the autonomous driving software of the vehicle to be learned by controlling to input information related to the autonomous driving release event into training set data of the deep learning network.

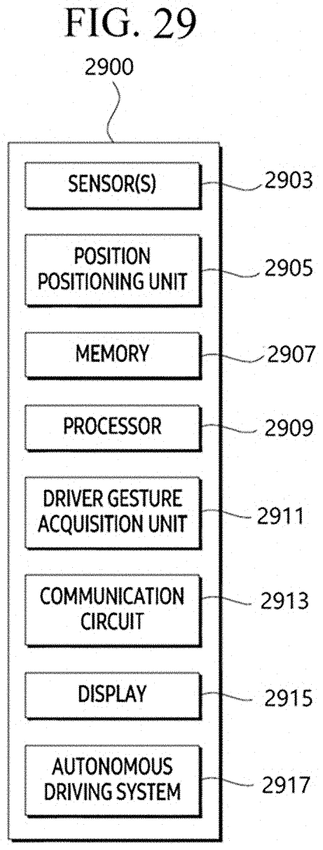

FIG. 29 is a block diagram of an electronic device 2900 according to an embodiment.

Referring to FIG. 29, an electronic device 2900 according to an embodiment may include at least one of sensors 2903, a position positioning unit 2905, a memory 2907, a processor 2909, a driver gesture acquisition unit 2911, a communication circuit 2913, a display unit 2915, and an autonomous driving system 2917. In various embodiments, each element may be connected through various interfaces. In some embodiments, the electronic device 2900 may include additional or fewer components as appropriate. For example, the sensor(s) 2903 may be a component of an external device separate from the electronic device 2900. In some embodiments, sensors 293 include RADAR, light detection and ranging (LiDAR), and/or ultrasonic sensors in addition to the image sensor.

The position positioning unit 2905 may position the vehicle in real time through a global positioning system (GPS), a global navigation satellite system (GNSS) such as GLONASS, or communication with a base station of a cellular network, and provide the positioned position to the processor 2909.

The memory 2907 may store at least one of various control information for driving a vehicle, driving information generated according to driving of the vehicle, operating system software of the vehicle, and electronic map data for driving the vehicle.

Processor 2909 may include hardware components for processing data based on one or more instructions. In an embodiment, the processor 2909 may transmit autonomous driving disengagement event associated information to the server through the communication circuit 2913 on a condition that satisfies a specified criterion.

Before transmitting the autonomous driving disengagement event associated information, the processor 2909 needs to agreement information for providing the information from the driver or the user to the server. The agreement process for providing information may be desirably displayed on the display 2915 that the driving disengagement event associated information may be transmitted to the server at the time of occurrence of driving disengagement event before providing the autonomous driving function by the electronic device 2900.

In an embodiment, the processor 2909 may store sensor data and location information obtained by the sensor(s) 2903 during autonomous driving of the vehicle in the memory 2907.

In an embodiment, the autonomous driving disengagement event associated information includes at least one of sensor data obtained by sensor(s) 2903 at the time when the autonomous driving release event occurs, location information from which the sensor data is acquired, and driver driving information. In an embodiment, the sensor data may include at least one of image sensors, radar, LiDAR, and data obtained by ultrasonic sensors. In an embodiment, autonomous driving disengagement event associated information may be processed independently of driver identification information (User ID, Driver license information, driver name, etc.) and/or vehicle identification information (License plate information, Vehicle Identification Number) that may identify the driver in order to protect the driver's privacy.

In one embodiment, the autonomous driving disengagement event associated information may be encrypted through a secret key received from the server in advance to be transmitted. At this time, the secret key may use a public key cryptography or also use a symmetric key cryptography.

In an embodiment, the designated criterion may be a time point at which an autonomous driving disengagement event occurs. For example, it may be a time when a driver intervention occurs while the vehicle is driving in the autonomous driving mode or a driver gesture requesting to change the driving mode from the autonomous driving mode to the manual driving mode occurs. In an embodiment, the driver's intervention may be determined based on identifying that the driver operates the steering wheel of the vehicle or the accelerator pedal/decelerator pedal of the vehicle, the gear of the vehicle by the driver gesture acquisition unit 2911. In an embodiment, the driver gesture acquisition unit 2911 may determine the driver's intervention based on identifying the driver's hand motion or body motion indicating the conversion of the driving mode from the autonomous driving mode to the manual driving mode. In an embodiment, the autonomous driving disengagement event may occur at a point where the autonomous driving system 2917 of the vehicle fails to smoothly autonomously drive according to a pre-trained autonomous driving algorithm. For example, the driver gesture acquisition unit 2911 may determine driver intervention for changing the mode to the autonomous driving release mode by the driver gesture generated at the time identified by the processor 2909, when a vehicle traveling on a predetermined driving route according to an autonomous driving mode enters a roundabout without a traffic light, based on detecting the presence of another vehicle entering the roundabout, and the processor 2909 identifying that the another vehicle does not proceed in the predicted direction and speed. In another example, based on the processor 2909 identifying unexpected road conditions (during road construction), traffic conditions, road accidents, and vehicle failure notification of a vehicle driving on a set driving route according to an autonomous driving mode, the driver gesture acquisition unit 2911 may determine driver intervention for changing a mode to the autonomous driving release mode by a driver gesture generated at a time point identified by the processor 2909.

In an embodiment, the driver gesture acquisition unit 2911 may determine whether the user gesture recognized through the visible light camera and/or infrared camera mounted inside the vehicle is a gesture corresponding to the release of a predetermined autonomous driving mode. In addition, in an embodiment, the driver gesture acquisition unit 2911 may identify occurrence of an autonomous driving release event by a user input selected through a user eXperience (UX) displayed on the display 2913.

In an embodiment, the processor 2909 may acquire driver driving information on a condition that satisfies a specified criterion, and transmit the obtained driving information and the obtained location information to the server 3000 through the communication circuit 2913. In this case, the driver driving information may include at least one of a steering wheel operation angle manipulated by the driver, accelerator pedal operation information, decelerator pedal operation information, gear information at the time when the autonomous driving release event occurs.

In an embodiment, the processor 2909 may transmit only some of the data obtained by the sensor(s) 2903 to the autonomous driving disengagement event aggregated information when autonomous driving disengagement event aggregated information obtained at the time of autonomous driving disengagement event occurrence to reduce congestion of reverse traffic.

For example, when a total of 10 sensors are installed in the vehicle, and each sensor acquires sensor data at 30 frames per second (30 fps), the processor 2909 may transmit only some frames (100 frames) (10 seconds×10 frames) out of a total of 300 frames (10 seconds×30 frames) generated for a specific time (e.g., 10 seconds), based on the time when the autonomous driving release event occurs, among sensor data obtained from the 10 sensors to the server.

In another embodiment, when transmitting autonomous driving disengagement event associated information obtained at the time the autonomous driving disengagement event occurs to the server, the processor 2909 may transmit full data of the data acquired by the sensor(s) 2903 as transmitting autonomous driving disengagement event associated information. For example, when a total of 10 sensors are installed in the vehicle, and each sensor acquires sensor data at 30 frames per second (30 fps), the processor 2909 may store only some of the sensor data (10 frames per second) obtained from the 10 sensors in the memory 2907 and transmit the entire 300 frames (10 seconds×30 frames) generated for a specific time (e.g., 10 seconds), based on the time when the autonomous driving disengagement event occurs to the server.

Alternatively, in another embodiment, when the autonomous driving disengagement event occurs while the communication circuit 2913 is not connected to the network, the processor 2909 temporarily stores autonomous driving disengagement event associated information acquired at the time when the autonomous driving disengagement event occurs in the memory 2907 and then transmits the information to the server while the communication circuit 2913 is connected to the network.

Of course, it is natural that the processor 2909 matches the time synchronization of sensor data obtained from each sensor 2903. The autonomous driving system 2917, according to an embodiment, may provide an autonomous driving function to the vehicle using a neural network learned using sensor data acquired by the sensor(s) or update or download autonomous driving software in an Over The Air (OTA) manner through the communication circuit 2913.

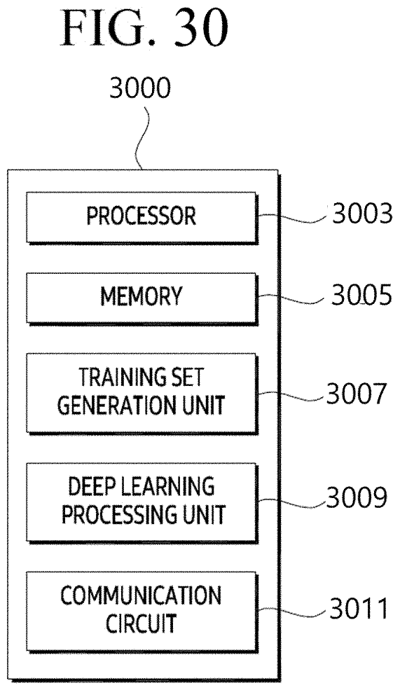

FIG. 30 is a block diagram of a server 3000 according to an embodiment.

Referring to FIG. 30, the server 3000 according to an embodiment may include at least one of a processor 3003, a memory 3005, a training set generation unit 3007, a deep learning processing unit 3009, and a communication circuit 3011. In various embodiments, each element may be connected through various interfaces. In some embodiments, server 3000 may include additional or fewer components as appropriate.

In an embodiment, the processor 3003 distributes the software (algorithm) for learned autonomous driving by the deep learning processing unit 3009 to the electronic device 2900 in an OTA method through the communication circuit 3011. In an embodiment, the processor 3003 transmits information related to the autonomous driving release event received from the electronic device 2900 to the training set generation unit 3007 and controls the generation of training data for learning of the deep learning processing unit 3009.

In an embodiment, the memory 3005 stores electronic map data, sensor data obtained from vehicles connected to a network and performing autonomous driving, and location information required for autonomous driving of the vehicle regardless of identification information of the user and/or the vehicle.

According to an embodiment, the memory 3005 may store only sensor data and location information generated when an autonomous driving disengagement event occurs during autonomous driving of the vehicle.

In an embodiment, the deep learning processing unit 3009 performs deep learning algorithm learning of autonomous driving using the training data generated by the training set generating unit 3007, and updates the autonomous driving algorithm using the performed learning result.

In an embodiment, the processor 3003 may distribute the autonomous driving algorithm updated by the deep learning processing unit 3009 to the electronic device 2900 connected to the network through an OTA method.

According to an embodiment, the processor 3003 is an autonomous driving control system of the vehicle B passing through a location where information related to the autonomous driving release event received from the vehicle A through the communication circuit 3011 is generated and require updating the autonomous driving software; and vehicle B may download the updated autonomous driving software.

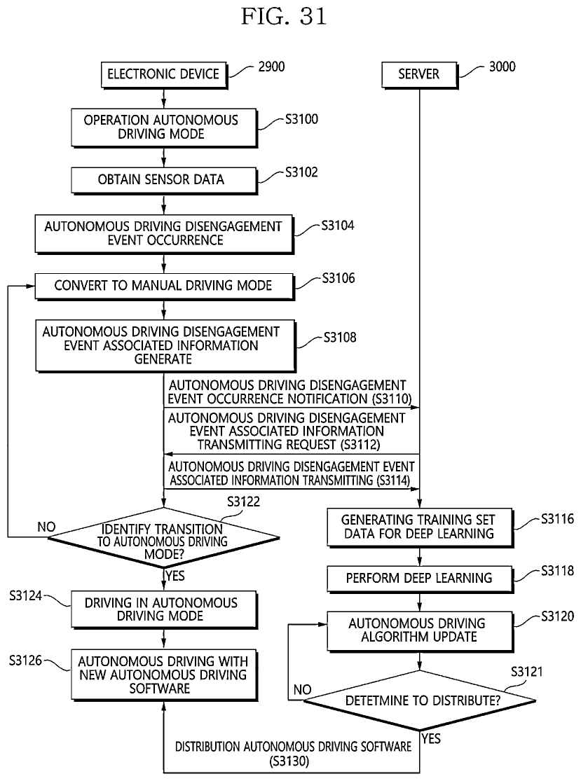

FIG. 31 is a signal flowchart illustrating an operation of an electronic device according to various embodiments.

Referring to FIG. 31, in operation S3100, the electronic device 2900 according to an embodiment operates in an autonomous driving mode, and obtains sensor data by sensor(s) in operation S3102. In operation S3104, when an autonomous driving disengagement event occurs, the electronic device 2900 according to an embodiment converts the autonomous driving mode into a manual driving mode and performs driving according to a control command generated by a user's manual operation in operation S3106.

In operation S3108, the electronic device 2900 according to an embodiment generates information related to the autonomous driving disengagement event, and transmits the autonomous driving disengagement event occurrence notification message to the server 3000 in operation S3110.

In response to obtaining the autonomous driving disengagement event occurrence notification message, in operation S3112, the server 3000 transmits an information transmission request message related to the autonomous driving disengagement event to the electronic device 2900.

In response to the acquisition of the information transmission request message related to the autonomous driving disengagement event, in operation S3114, the electronic device 2900 transmits information related to the autonomous driving disengagement event to the server 3000.

In response to the acquisition of the autonomous driving disengagement event-related information, in operation S3116, the server 3000 generates training set data for deep learning using the autonomous driving disengagement event-related information.

In operation S3118, the server 3000 performs deep learning using the training set data, and in operation S3120, the server 3000 updates the autonomous driving algorithm.

In operation S3121, when the server 3000 determines to distribute the updated autonomous driving algorithm (Y of S3122), the server 3000 transmits software of the updated autonomous driving algorithm to the electronic device 2900 through OTA. At this time, in operation S3130, the server 3000 determines whether the electronic device 2900 is connected to a network or the electronic device 2900 is a subscriber subscribing the autonomous driving software and determines to distribute the updated autonomous driving software only to the electronic device 2900 of a user who subscribes the corresponding service. Further, in operation S3130, the server 3000 checks that a version of the autonomous driving software stored in the electronic device 2900 is a version requiring upgrade to distribute the autonomous driving software to the electronic device 2900 connected to the network.

In operation S3122, when it is switched to an autonomous driving mode by the user (S3122—Yes), the electronic device 2900 drives in an autonomous driving mode in operation S3124 and when it is not switched to the autonomous driving mode (S3122—No), makes the autonomous driving system disabled to be driven in a manual driving mode in operation S3106. In response to the reception of a new version of autonomous driving software from the server 3000 in operation S3126, the electronic device 2900 performs the autonomous driving using a new version of autonomous driving software.

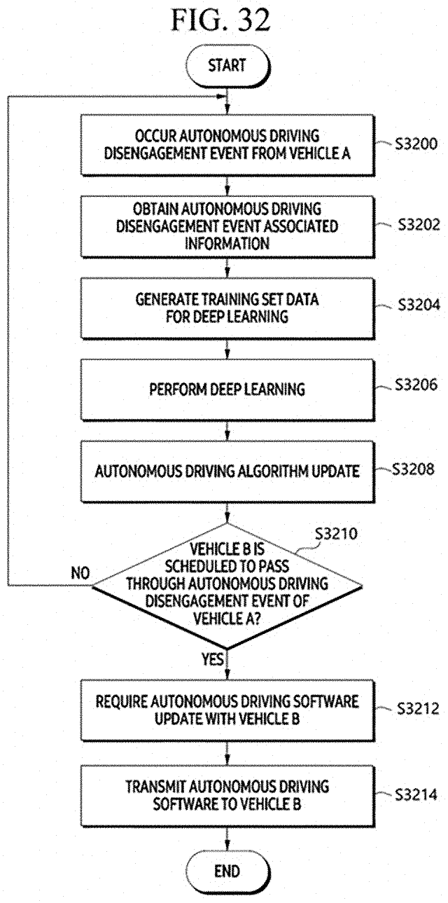

FIG. 32 is a signal flowchart illustrating an operation of a server according to various embodiments.

In operation S3200, when it is confirmed that the autonomous driving disengagement event occurs from vehicle A, the server 3000 obtains information related to the autonomous driving disengagement event from vehicle A in operation S3202.

When the information related to the autonomous driving disengagement event is obtained, the server 3000 generates the autonomous driving event-related information as training set data for deep learning in operation S3204, performs deep learning with the training set data generated in operation S3206, and updates the autonomous software through the performed deep learning result in operation S3208.

In operation S3210, when it is confirmed in the server 3000 that the vehicle B will pass through a point where the autonomous driving disengagement event occurs in the vehicle A (S3210—Yes), the server 3000 may require updating of autonomous driving software to the vehicle B in operation S3212, and transmit autonomous driving software to the vehicle B in operation S3214 to prevent occurrence of an autonomous driving disengagement event similar to that of the vehicle A. In operation S3210, the server 3000 may determine whether the following vehicle enters/passes a point where the autonomous driving disengagement event occurs according to an embodiment since the server 3000 is connected to the autonomous vehicles through a network, and the path and location of each autonomous vehicle may be checked in real time. Of course, in order to protect the driver's personal information, the server 3000 may obtain location information obtained from each vehicle regardless of identification information of the driver and/or the vehicle.

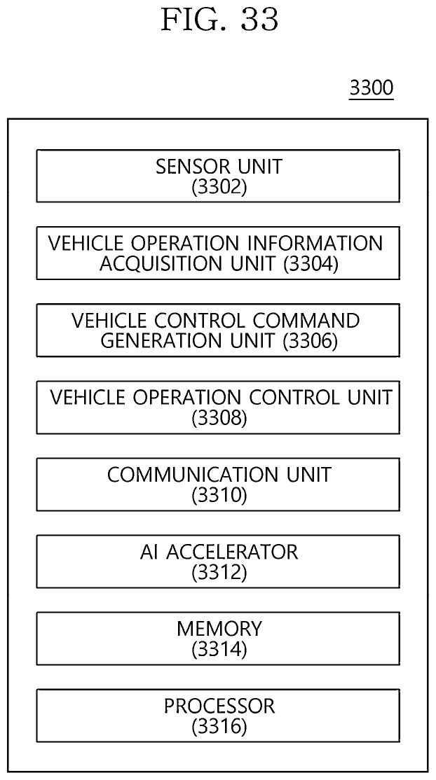

FIG. 33 is a block diagram of an autonomous driving system 3300 according to an embodiment.

Referring to FIG. 33, the autonomous driving system 3300 according to the embodiment includes a sensor unit 3302, a vehicle operation information acquisition unit 3304, a vehicle control command generation unit 3306, a vehicle operation control unit 3308, a communication unit 3310, an AI accelerator 3312, a memory 3314, and a processor 3316.

The sensor unit 3302 may include a vision sensor such as a camera that uses a charge coupled device (CCD) and a complementary metal oxide semiconductor (CMOS) sensor and a non-vision sensor such as an electromagnetic sensor, an acoustic sensor, a vibration sensor, a radiation sensor, a radio wave sensor, or a thermal sensor.

The vehicle operation information acquisition unit 3304 acquires operating information required to drive the vehicle such as a speed, braking, a driving direction, a turn signal, a headlight, or a steering, from an odometer or ECU of the vehicle.

The vehicle control command generating unit 3306 generates and outputs a control command to control a vehicle operation ordered by the processor 3316 as an instruction corresponding to each component of the vehicle.

The communication unit 3310 communicates with an external server through a wireless network such as a cellular or WiFi or communicates with the other vehicle, pedestrians, or infrastructure or cyclist on the road through C-V2X.

The artificial intelligence (AI) accelerator 3312 is hardware which accelerates the machine learning and an artificial intelligent function and is implemented as a GPU, an FPGA, or an ASIC in the vehicle as an auxiliary arithmetic unit which supplements the processor 3316. The AI accelerator 3312 is desirably designed using an architecture capable of performing parallel processing which may easily implement a deep learning model for the autonomous driving system 3300. According to the embodiment, a deep learning model for autonomous driving may be implemented using a CNN (Convolutional. Neural Network) or an RNN (Recurrent Neural Network).

The memory 3314 may store various software for an autonomous driving system, a deep learning model, sensor data acquired by the sensor unit 3302, position information, a high precision map, and unique information for encryption.

The processor 3316 controls each block to provide an autonomous driving system according to the embodiment and when an autonomous driving disengagement event occurs, generates time synchronization to acquire data from each sensors of the sensor unit 3302. Further, when the autonomous driving disengagement event occurs, the processor 3316 controls to determine labels for sensor data acquired by the sensor unit 3302 and transmit the labeled data sets to the server through the communication unit 3310.

In contrast, when a new version of autonomous driving software is released from the server, the processor 3316 downloads the new version of autonomous driving software through the communication unit 3310 to store the software in the memory 3314 and controls the AI accelerator 3312 to drive a machine learning model corresponding to the new version of autonomous driving software.

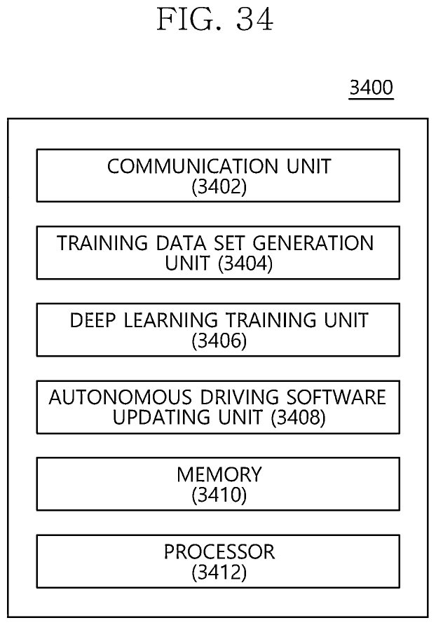

FIG. 34 is a block diagram of a server 3400 according to an embodiment.

The communication unit 3402 communicates with a communication unit of a vehicle or infrastructures installed around the road to transmit and receive data and a training data set generation unit 3404 generates a training data set using labeled data sets acquired from the vehicle. The infrastructures installed around the road may include a base station eNode B which is installed around the road to communicate with wireless communication devices within a predetermined coverage by a wireless connection technique of a mobile communication method such as 5G/5G NR/6G or road side equipment (RSE) installed on the road to support the communication such as Dedicated Short Range Communication (DSRC), IEEE 802.11p WAVE (Wireless Access in Vehicular Environment).

The deep learning training unit 3406 performs the learning using a training data set which is newly generated in the training data set generation unit 3404 and generates an inference model through the learning result.

The autonomous driving software updating unit 3408 releases a new version of autonomous driving software to which a newly generated inference model is reflected to store the new version of autonomous driving software in the memory 3410 and the processor 3412 transmits the new version of autonomous driving software stored in the memory 3410 to a vehicle which is connected to a network through the communication unit 3402.

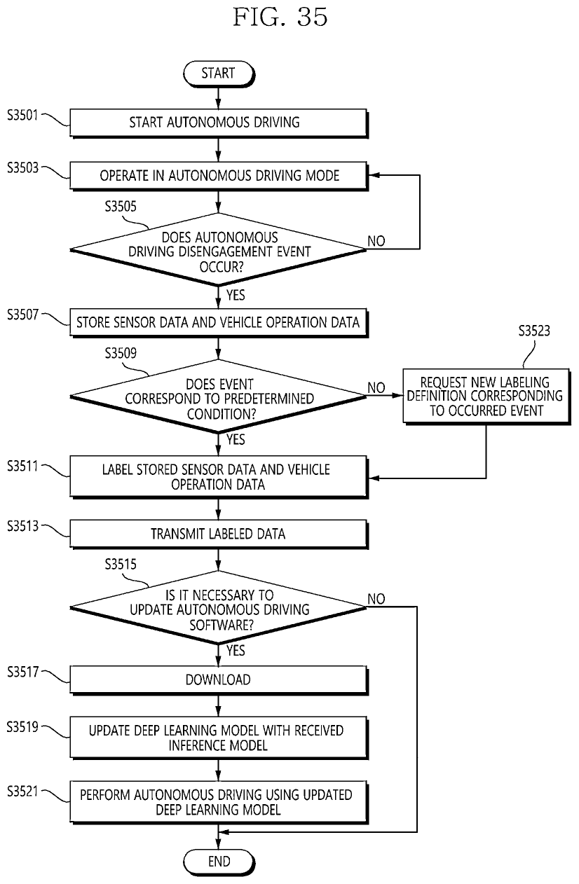

FIG. 35 is an operation flowchart of an autonomous driving vehicle system according to an embodiment.

In operation S3501, when a user/driver requests to start autonomous driving, the autonomous driving vehicle system operates the vehicle in an autonomous driving mode in operation S3503.

When occurrence of the autonomous driving disengagement event is sensed in operation S3505 (S3505—Yes), the autonomous driving vehicle system stores sensor data and vehicle operation data acquired at the time when the autonomous driving disengagement event occurs in operation S3507. At this time, in operation S3507, the autonomous driving vehicle system may store sensor data and vehicle operation data acquired for a predetermined time interval (for example, one minute or 30 seconds) including the time when the autonomous driving disengagement event occurs in response to identification of the occurrence of the autonomous driving disengagement event. For example, when the autonomous driving disengagement event occurs at 4:20 PM on Mar. 11, 2021, the sensor data and the vehicle operation data acquired between 4:15 PM and 4:25 PM.

Further, in operation S3507, the autonomous driving vehicle system may store sensor data and vehicle operation data acquired before operating in the autonomous driving mode after the time that the autonomous driving disengagement event occurs to operate in a manual driving mode in response to the identification of occurrence of the autonomous driving disengagement event.

In operation S3509, the autonomous driving vehicle system determines whether the autonomous driving event occurred in operation S3505 corresponds to a predetermined condition, when the occurred autonomous driving event corresponds to the predetermined condition (S3509—Yes), in operation S3511, labels the stored sensor data and vehicle operation data and in operation S3513, transmits the labeled data (sensor data and vehicle operation data) to the server.

The predetermined condition in operation S3509 is conditions which are defined in advance when an autonomous driving vehicle system manufacturing company develops the autonomous driving software and includes situations described in the following Table 2. Further, in order to distinguish the situations of Table 2, separate labeling corresponding to the sensor data and the vehicle operation data collected in each situation may be performed.

TABLE 2
Rapid deceleration, rapid acceleration, lane change, center line violation, overtaking,
cut in, obstacle avoidance, driving path interruption event occurrence, construction
situation, accident situation, intrusion of center of opposite vehicle, Traffic Light and
Stop Sign Control, Stop sign violation, Traffic light and stop signal recognition, sharp
steering change, entrance of yield intersection

In contrast, in operation S3509, when the occurred autonomous driving event does not correspond to the predetermined condition (S3509—No), the event corresponding to the sensor data and the vehicle operation data stored in operation S3507 is not a previously defined event, so that in operation S3523, the autonomous driving vehicle system requests new labeling definition corresponding to the new event to the server and when the new labeling definition is received, labels the sensor data and the vehicle operation data stored according to the new labeling definition in operation S3511, and transmits the labeled data (sensor data and the vehicle operation data) to the server in operation S3513.

When in operation S3515, it is necessary to update the autonomous driving software (S3515—Yes), the autonomous driving vehicle system downloads the updated autonomous driving software from the server in operation S3517 and updates the deep learning model with an inference model of the updated autonomous driving software in operation S3519, and then performs the autonomous driving using the updated deep learning model in operation S3521.

The event and the condition in step S3509 of FIG. 35 may be set in advance in a design/manufacturing step of the autonomous driving vehicle or at the time when the autonomous driving software is developed. For example, the event may be triggered by a situation when an unexpected obstacle appears during the autonomous driving of the vehicle, when a driving direction of the detected object is different from a previously learned driving direction of an object, round about entering situation, intersection without traffic signals, when a sign of the traffic signal does not match the flow of the vehicles, tunnel entry and exit, bridge entry or exit, change of driving environment such as snow or rain, black ice situation, construction situation, traffic congestion situation, or accident situation.

The conditions of S3509 are conditions of the event to be labeled among the events and are necessary to update the inference model for the autonomous driving software. Data corresponding to the conditions which are determined by the developer in advance is automatically labeled to be transmitted to the server as a training data set.

In an embodiment, when the autonomous driving disengagement event occurs, the autonomous driving disengagement event related information generated by the processor may include data represented in the following Table 3.

TABLE 3

| Name | Description |
|---|---|
| Labeling Type | Predetermined labeling type to generate training |
| | data set |
| Driver | Information that driver intervenes to manipulate |
| behavior data | operation of vehicle when event occurs (for |
| | example, steering information, braking pressure, |
| | accelerator position manipulated by driver) |
| Vehicle | Acceleration system output value, braking system |
| Driving data | output value, braking pressure, speed, gear |
| | position, acceleration information, pitch, yaw, |
| | roll information of vehicle, wheel RPM, |
| | tire pressure |
| Vehicle | Driving direction, driving speed information, |
| operation data | driving distance information of vehicle which |
| | is manually manipulated by driver when |
| | event occurs |
| Vehicle | Command generated by ECU to control operation |
| control | of each component of vehicle by intervention |
| command | of driver when event occurs |
| Sensor data | Data acquired from vision sensor or non-vision |
| | sensor |
| Positioning | Positioning information where event occurs |
| information | acquired by GPS |
| Time | Time information when event occurs |
| information | |

Data of Table 3 may be acquired by the processor at a predetermined interval (for example, 100 Hz).

In another embodiment, when information (a position of an object or identification information of the object) of an object located on a high precision map is different from information of the object acquired by the sensor unit, the processor may transmit the information of the acquired object and vehicle operation information, driver operation information, vehicle driving data generated at the time when the object is acquired to the server through the communication unit.

In another embodiment, the processor selects objects located in the traveling direction of the vehicle among the surrounding environments of the vehicle acquired from the sensor unit as target objects and processes sensor data corresponding to data corresponding to the selected target object to reduce an overall computational amount of the autonomous driving system. To be more specific, the processor predicts a movement direction for each object using a series of time-series data for the entire object present in the surrounding environment acquired by the sensor unit and when the predicted movement direction of the object is located on the driving path of the vehicle, selects only the object as a target object and uses the information about the target object as an input of the deep learning model for autonomous driving of the vehicle.

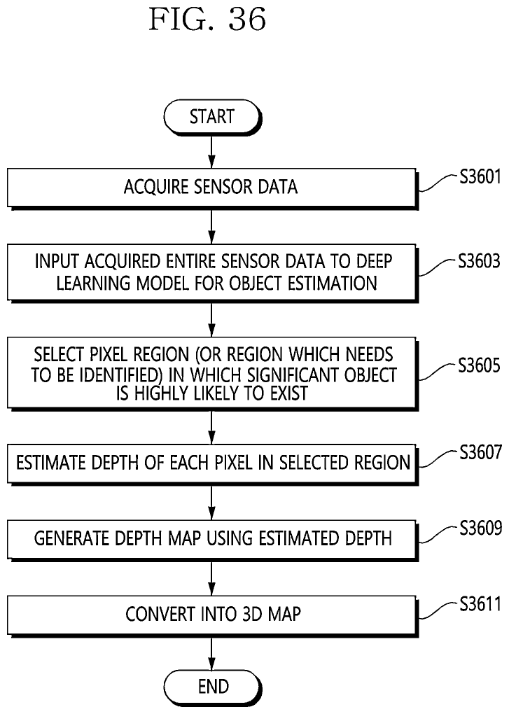

FIG. 36 is an operation flowchart of an electronic device according to an embodiment.

In operation S3601, when the sensor data is acquired by the vision sensor mounted in the vehicle, the electronic device inputs the acquired entire sensor data to a deep learning model for object prediction in operation S3603.

In operation S3605, the electronic device selects a pixel region (or a region needs to be identified) having a high probability of having a significant object, among entire sensor data and estimates a depth of each pixel in the selected region in operation S3607.

In operation S3609, the electronic device generates a depth map using a depth of the estimated pixel and in operation S3611, converts the generated map depth into a 3D map to output the 3D map to the user through a display.

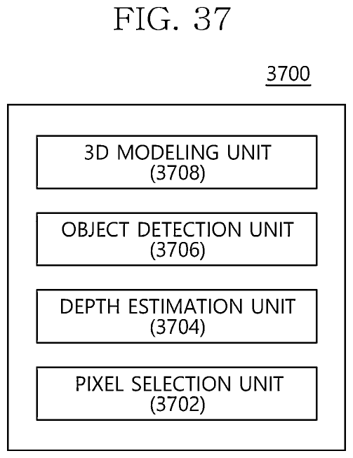

FIG. 37 is a block diagram of an object detection module that detects an object through image data acquired from a vision sensor mounted in a vehicle by an electronic device 3700 according to an embodiment.

The pixel selection unit 3702 selects only a region which needs to be identified among the entire pixels acquired by the camera and outputs the selected pixel value to the depth estimation unit 3704. According to an embodiment, the reason that the pixel selection unit 3702 selects only the region which needs to be identified among the frame acquired by the vision sensor is because objects present on the moving direction of the vehicle which needs to be noted while driving the vehicle, such as other vehicles, pedestrians, cyclist, road infrastructures, among objects included in a viewing angle of the vision sensor, are present only in a partial region of the entire frame. That is, a road region in which the vehicle drives or a background region such as sky is not an object (an object which is highly likely to collide the vehicle) present on the moving direction of the vehicle so that when the machine learning is applied to estimate a depth of a pixel of a region which is determined as an unnecessary object, a computing resource of the vehicle, and power consumption of the vehicle is undesirably increased.

A depth estimation unit 3704 estimates a depth using a pixel value selected by the deep learning model. At this time, as a method of estimating a depth by the depth estimation unit 3704, a stereo depth network (SDN) or a graphic based depth correction (GDC) is used.

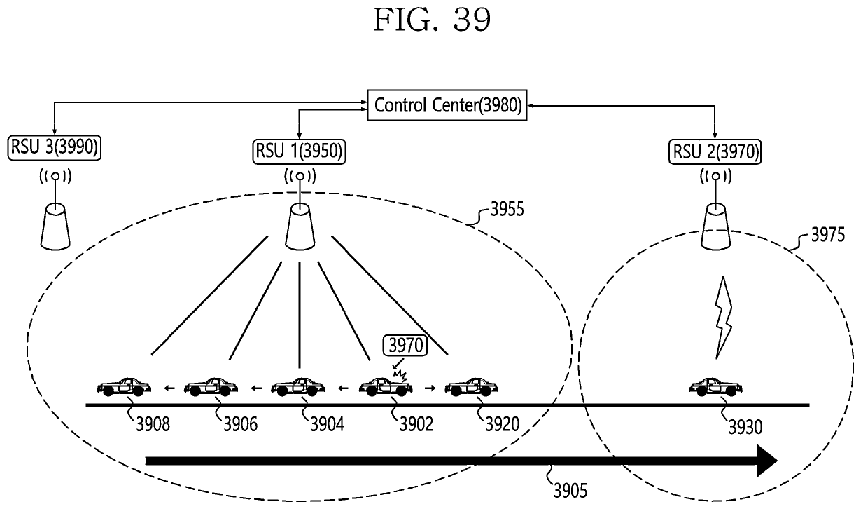

As another example, when the depth estimation unit 3704 estimates a depth of the selected pixel value, voxelization of the input image may be used. The method of estimating a depth of the pixel value using voxelization of the image by the depth estimation unit 3704 will be described with reference to the following FIG. 39.

A voxel indicates a value of a regular grid in a 3D space in a medical and science field and this values are used as very important elements to analyze and visualize the data. This is because the voxel is an array of a volume element which configures a notational 3D space and is generally used in a computer based modeling and graphic simulation. In the 3D printing, the voxel is widely used because of its own depth. In one embodiment, the voxelization divides point cloud into 3D voxels having the same space and converts points in a predetermined group in each voxel into a unified feature representation through a voxel feature encoding (VFE) layer.

In one embodiment, a sensor for detecting and recognizing obstacles as objects during the driving needs to emit at least two beams to locate at least two points on the object for a total of four points. In one embodiment, the sensor may include a LiDAR sensor mounted in the vehicle.

According to an embodiment, a smallest object which is detectable by a sensor needs to be an object which is sufficiently larger than the sensor to locate at least four points on the object from two different beams.

In one embodiment, a depth of the object may be acquired by a single lens based camera or a stereo lens based camera.

When the single lens based camera is used, even though one physical camera is mounted in the camera, the position of the camera varies according to the time so that the depth of the recognized object may be estimated using a principle that a position of the camera which recognizes the same object is changed after a predetermined time (t) is elapsed.

In contrast, when two or more cameras such as stereo cameras are physically mounted in different positions of the vehicle, a depth of the same object which is simultaneously recognized by different cameras is estimated using a characteristic that fields of view of the same object in each camera are different.

The object detection unit 3708 identifies and distinguishes an object using the depth of the estimated pixel to detect the object. The 3D modeling unit 3708 three-dimensionally models the detected object to represent the 3D modeled object to the user. At this time, the 3D modeling unit 3708 three-dimensionally models the map data around the vehicle and the detected object to output through the display.

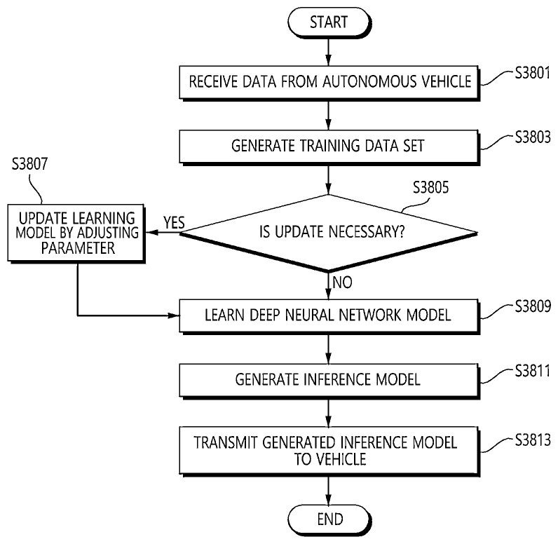

FIG. 38 is an operation flowchart of a server according to an embodiment.

In operation S3801, when the server receives data from the autonomous vehicle connected to the network, the server generates a training data set in operation S3803 and determines whether it is necessary to update the learning model of the autonomous driving software in operation S3805.

In operation 3805, when the update is necessary (S3805—Yes), the server adjusts a parameter which controls the model learning process to update the learning model in operation S3807 and performs deep neural network model learning in operation S3809. At this time, the parameter may include a number of layers and a number of nodes of the layer. Alternatively, the parameter may include hyperparameters such as a neural network size, learning rates, or exploration.

In operation S3811, the server generates an inference model through the deep neural network model and in operation S3813, transmits the generated inference model to vehicles connected to the network.

According to still another embodiment of the present invention, the electronic device of the autonomous driving vehicle adaptively updates the artificial neural network according to a driving period. For adaptive update, the server may forward update information of the artificial neural network to the vehicle through a roadside base station or a mobile communication station. The vehicle updates the artificial neural network according to the forwarded update information in real-time or non-real-time.

In the present embodiment, the entire driving section in which the autonomous vehicle drives includes a plurality of sub sections obtained by dividing the driving section and the artificial neural network desirably includes a plurality of artificial neural networks provided differently for every sub section. Here, the “adaptive update” refers to update that an updating time is differently set according to an update priority differently allocated to every sub section. For example, in a sub section, when an event related to the safety such as traffic accident or construction occurs, the artificial neural network needs to be preferentially updated for the sub section in which the event occurs. To this end, the update information transmitted by the server may include layout information of nodes which configure the artificial neural network, connection weight information connecting nodes, and update priority information for every section.

The processor of the electronic device determines a real-time updating order for the plurality of artificial neural networks according to the priority information. Further, the processor of the electronic device may readjust the updating order for every sub section by further considering position/time relationship between a sub section according to the current position and the sub section where the event occurs as well as the priority information. The readjustment of the priority is desirably applied in a driving environment and a dynamic environment in which the driving direction of the vehicle is changed in real time. Further, the real-time update is desirably performed in an adjacent section located before the event occurrence section, rather than in the event occurrence section, on the driving route. To this end, the processor identifies adjacent sub sections located before the event occurrence section on the driving route and determines some adjacent sub sections as an update target in consideration of a time for update. In the embodiment, the electronic device updates the artificial neural network included in the electronic device in the vehicle in non-real-time using update information distributed from the server. The non-real-time update is performed before being switched to the autonomous driving mode after turning on the power of the electronic device of the driving vehicle or before turning off the power of the electronic device after the driving of the autonomous vehicle ends, or when the electric vehicle is being charged.

The server of the present invention may perform the learning to update the autonomous driving software during “after autonomous driving disengagement event occurs-a time when autonomous driving conversion event occurs”. Here, the software may be implemented as an artificial neural network programmed to determine an autonomous driving situation and determine a driving route for the autonomous driving. The artificial neural network includes an artificial neural network for determining a situation for a positional relationship between dynamic objects (surrounding vehicles or pedestrians) located around the driving route and an artificial neural network for determining a situation for a positional relationship between static objects (road signs or a curb stone) located around the driving route. Further, the artificial neural network may further include an artificial neural network trained to determine different situations according to the driving section.

In the embodiment, even before the autonomous driving disengagement event occurs, the server may perform the training to update the software using sensor information acquired since an uncertainty score in the driving route determination is higher than a predetermined reference value. Here, the meaning of the uncertainty score of the driving route determination includes an uncertainty score for object recognition and an uncertainty score for object operation recognition. The predetermined reference value may vary depending on transitory or non-transitory intervention of the driver, a number of times of manipulating deceleration/acceleration/steering, degree thereof during the driving process. For example, even though it is transitory, when the driver's intervention is frequent or emergency braking or deceleration frequently occurs, the electronic device of the autonomous vehicle adds additional information related to this event to the sensor data to transmit the data to the server and the server may adjust the reference value to be lower by further considering the received additional information. That is, even before the autonomous driving disengagement event occurs, the server may further perform the learning on the basis of the uncertainty score and additional information which is variably adjusted.

In the present embodiment, the learning unit or the artificial neural network may be configured by a deep neural network (DNN) and for example, may be implemented by a convolutional neural network (CNN) or a recurrent neural network (RNN). Further, the learning unit of the present embodiment may be implemented by a reinforcement learning model which maximizes a cumulative reward. In this case, the processor calculates a risk score as a result of an action called a driving operation (braking, acceleration, or steering) of the vehicle determined according to the reinforcement learning model in a given driving situation. The risk score may be calculated by considering a distance between preceding vehicles, an expected collision time (TTC: Time To Collision), a distance between rear vehicles, a distance between next vehicles, a distance between front and rear vehicles in a diagonal direction while lane change, and a relative speed of the vehicle. The TTC of the present embodiment may have a plurality of values such as an expected collision time with objects located at the side or diagonal direction, as well as the front and rear sides and a final risk score is a value obtained by adding a plurality of TTC values according to a predetermined weight in accordance with the driving operation (acceleration, deceleration, steering) of the vehicle. During the reinforcement learning process, when the risk score becomes lower according to the current driving operation, the learning unit gives a positive reward and when the risk score becomes higher, gives a negative reward and updates the determination weight between nodes so as to maximize the cumulative reward. The reinforcement learning may be performed in the server or the processor of the electronic device in the vehicle. In order to perform the reinforcement learning during the driving, it is desirable to optimize the neural network in accordance with the change of the situation by parallel operation through a separate processor.

In the present embodiment, the learning unit may be classified into a main learning unit and a sub learning unit. The main learning unit is a learning unit determine a driving situation and a driving control operation in a driving process which is currently being performed. The sub learning unit is a learning unit which performs an operation to update a determination weight to connect the nodes. When the update is completed in the sub learning unit and the vehicle approaches the updated sub section, the sub learning unit is changed to the main learning unit. After being changed to the main learning unit, an existing main learning unit and the updated main learning unit simultaneously calculate feature values according to the sensor input for a predetermined time. That is, before the starting point of the sub section, there is a duplication period in which two learning units operate in the same way, and this is defined as a hand-off period. The hand-off period is provided to exchange the roles between the updated learning unit and the existing main learning.

### III. Vehicular Communication Security

In the above-described embodiments, the vehicle independently performs the autonomous driving without sharing information for autonomous driving from the other entity through vehicle to everything (V2X) communication such as vehicle to vehicle (V2V) or vehicle to road side communication (V2R). However, in order to prevent the accident of the vehicle which drives on the road and minimize the traffic congestion, it is the most ideal to transmit and receive information between vehicles or between the vehicle and infrastructures through the V2V communication and/or V2R communication.

However, when the vehicle transmits and receives data with the other entity through a network, problems of data integrity and security vulnerability need to be solved.

First, an intelligent transportation system specification which is being currently discussed is representatively an IEEE 802.11p standard based dedicated short-range communication (DRSC) and cellular network based cellular-vehicle to everything (C-V2X).

Hereinafter, a way to provide a security function for data transmitted and received in a vehicle communication system based on two methods will be discussed.

FIG. 39 is a view for showing a conception of transmitting/receiving information about a generated event when an event occurs in a vehicle driving on a road according to an embodiment.

In FIG. 39, reference number 3905 denotes a driving direction of vehicles located on the road.

In FIG. 39, when an event occurs in a specific vehicle 3902 among vehicles driving on the road, the occurrence of the event needs to be notified to vehicles 3904, 3906, and 3908 located behind the specific vehicle 3902 in the driving direction for the safety of the vehicles driving on the road.

For the convenience of description, the event is assumed that the accident occurs in the vehicle 3902, and the vehicle in which the accident occurs to occur the event is referred to as a source vehicle (for example, a crashed vehicle or an event issue vehicle).

In one embodiment, the event 3970 includes cases when a vehicle encounter with another vehicle on the road, a vehicle has an abnormal movement, a vehicle has unexpected or improper movements, or mechanical failures occur in the vehicle.

In one embodiment, when the event occurs, the source vehicle 3902 generates and transmits a warning message to notify collision prevention or emergency situation to the other vehicles which are located behind the source vehicle on the road and have the same driving direction.

In one embodiment, the source vehicle 3902 transmits the generated warning message using V2V communication and V2R (R2V) communication.

Specifically, in one embodiment, when the source vehicle 3902 uses the V2V communication, the generated warning message may be transmitted from one vehicle to the other vehicles through a plurality of channels without having intervention of RSU1 3950 and when the source vehicle uses the V2R (R2V) communication, the source vehicle 3902 transmits the generated warning message in a period to which a resource is allocated and the RSU1 3950 retransmits this to vehicles 3902, 3904, 3906, 3908, and 3920 in the network coverage 3955.

However, in one embodiment, in order to efficiently use the limited frequency resource and reduce a delay according to the message processing at a reception side, the processing method desirably changed depending on whether the location of the vehicle that receives the waring message is the front or the back of the source vehicle 3902.

Specifically, the source vehicle 3902 generates a warning message in response to the identification that the event occurs to transmit through the V2V communication and the V2R (R2V) communication. At this time, the V2V communication and the V2R (R2V) communication may simultaneously transmit through different channels (frequencies) or transmit in different time zones in the same frequency resource to reduce the interference therebetween.

In one embodiment, desirably, vehicles which receive the warning message are vehicles which perform the platooning driving with the source vehicle and set an operation mode.

Further, in one embodiment, the receiving vehicle which receives the warning message identifies that the warning message is generated in an opposite direction to the driving direction of the receiving vehicle to ignore or discard the received warning message.

In one embodiment, the receiving vehicle which receives the waring message identifies that the warning message is generated from the other vehicles which drives on the route of the receiving vehicle to avoid the collision according to the received warning message or generate a control command to perform the vehicle control to prevent the accident.

The vehicle which receives the warning message using V2V communication needs to transmit the received warning message to a road side unit (RSU) and if a vehicle ID is not included in the waring message transmitted through the V2V communication, requests the road side unit RSU to generate a new warning message.

The structure of the warning message according to the exemplary embodiment is configured as represented in Table 4.

TABLE 4

| Field name | Description |
|---|---|
| Source Vehicle | Indicate whether the vehicle is a vehicle that |
| | generated the warning message (True/False) |
| Location | Location information where message is generated |
| information | |
| Serving RSU | Serving RSU ID |
| information | |
| Event | Define event type corresponding to warning |
| type/event ID | message |
| Priority | Defined in advance depending on event which |
| | may occur on road (for example, collision |
| | accident or vehicle fire is “1”, malfunction of |
| | source device is “2”, and dangerous object |
| | on road is “3”) |
| Generated time | Time of generating warning message |
| Vehicle ID | Unique identifier of vehicle |
| Transmitter | Information of transmitter that transmits warning |
| information | message (necessary to identify whether to receive |
| | through V2V communication or V2R (R2V) |
| | communication |
| Driving direction | Information indicating driving direction of |
| | vehicle which generates warning message |

Table 4 shows a structure of a warning message according to the embodiment, and includes all the information required to prevent collision of the vehicle or other accidents.

Referring to FIG. 39, according to the embodiment, the vehicles is assumed to simultaneously perform the communication using the V2V and V2R (R2V) manner to improve the safety on the road.

In the embodiment of FIG. 39, when an event occurs in the source vehicle 3902 (3907), the source vehicle 3902 transmits the warning message generated with regard to the event to the vehicles 3904, 3906, 3908, and 3920 and the RSU1 3950 simultaneously using the V2V communication channel and the V2R(R2V) communication channel. In order to simultaneously use the V2V communication channel and the V2R (R2V) communication channel, in the source vehicle 3902, the V2V communication channel and the V2R (R2V) communication channel desirably have different frequency channels.

According to another embodiment, when the event occurs in the source vehicle 3902 (3970), the warning message generated with regard to the event may be transmitted through only any one of the V2V communication and the V2R (R2V) communication.

Referring to FIG. 39 again, RSU 1 3950, RSU2 3970, RSU3 3990 have coverages 3955 and 3975 which perform the V2R (R2V) communication with vehicles and each RSU acquires and stores an identifier ID (RSU ID) to identify the RSU managed by the control center 3980, location information of RSU, time information, frequency information, and channel information. Further, each RSU generates a list of vehicles present in its coverage and transmits the list to vehicles in the coverage to identify IDs of vehicles in the vicinity thereof. The list of the vehicles needs to be reflected in real time and when some vehicle moves to a coverage of a neighboring RSU in its coverage, it is desirable to generate a vehicle list again to broadcast the list to the vehicles in the coverage.

Each of RSUs 3950, 3970, 3990 manages vehicles which newly enter their regions or leave the regions and store identifiers of the managed vehicles. Referring to FIG. 39, it is illustrated that the vehicle 3930 leaves the region 3955 of the RSU 1 3950 to enter the region 3975 of the RSU2 3970. The vehicle 3930 is located in front of the source vehicle 3902 on the driving route 3905 and accesses a different RSU from the RSU accessed by the source vehicle 3902, so that the vehicle 3903 does not receive the warning message not only through the V2V communication, but also through the V2R (R2V) communication. The vehicle 3930 leaves the region of the existing serving RSU1 3950 to enter a region of a new RSU2 3970, so that the message broadcasted from the RSU1 3950 is discarded and the message broadcasted from the RSU2 3970 is used to perform the V2V communication and/or V2R communication and receives a message generated by the event occurring in the coverage 3070 of the RSU2 3970 to perform manipulation to avoid the collision or prevent the accident.

In contrast, the RSU3 3990 which covers the region located behind on the driving route 3905 of the source vehicle 3902 needs to broadcast the warning message to the vehicles located in its region through the V2R (R2V) communication. As described above, the control center 3980 desirably controls to determine whether to broadcast the warning message generated from the source vehicle for every RSU present on the driving route of the vehicle.

This is because when the source vehicle 3902 drives, route information to a destination is requested to the server and if the server can manage the driving routes of the vehicles, it is easy for the control center 3980 to select RSUs (RSU in which the source vehicle is located and RSUs in which the following vehicles of the source vehicle are located) which broadcast the warning message generated by the source vehicle in a specific location and to control for broadcasting the warning message to the selected RSU.

The source vehicle 3902 transmits the generated warning message to adjacent vehicles 3904, 3906, 3908, 3020 through the V2V communication and to the RSU1 3950 which allocates the channel thereto through the V2R (R2V) communication, simultaneously.

In one embodiment, in order to increase the reliability and the low latency for the warning message, the V2V channel and the V2R (R2V) channel are simultaneously used to transmit the warning message.

First, a vehicle (front vehicle) 3920 located in front of the source vehicle 3902 among vehicles 3904 and 3920 most adjacent to the source vehicle 3902 is less likely to be affected by the event occurring in the source vehicle 3902 so that the received warning message is ignored or discarded. Specifically, the front vehicle 3920 may check whether to be a warning message generated in the following vehicle using direction information and location information in the warning message received from the source vehicle 3902 through the V2V communication and/or from the RSU1 3902 through the V2R(R2V) communication.

The receiving vehicles which receive the warning message through the V2R (R2V) communication check the ID of the RSU included in the warning message so that if the ID is not the ID of the RSU located on the driving route of the receiving vehicle, it is determined that the information is wrong information or unnecessary information to ignore or discard the received warning message. It is possible because the receiving vehicles receive and store in advance information (RSU ID) about all or a part of RSUs located on the moving route from the server.

Accordingly, the receiving vehicles which receive the warning message confirm the integrity for the warning message using information about the RSU included in the warning message received through the V2R (R2V) communication and confirms the integrity for the warning message using the identifier and the location information of the source vehicle with respect to the warning message received through the V2V communication. That is, for more higher data integrity, only when the warning message received through the V2R (R2V) communication and the warning message received through the V2V communication have the same information and the integrity of the data is confirmed according to each communication method, the control device (processor) of the receiving vehicle may generate a control command for preventing the accident according to the received warning message.

In the meantime, since collision or accident may be generated in rear vehicles 3904, 3906, 3908 located behind the source vehicle 3902 by the event occurred in the source vehicle 3902, the rear vehicles 3904, 3906, 3908 receive the warning message received in the source vehicle 3902 from the adjacent vehicles through the V2V communication and/or the RSU1 3950 through the V2R (R2V) communication and perform an appropriate operation such as deceleration or lane change to avoid collision or accident.

In one embodiment, in order to transmit or receive the warning message between vehicles, a vehicular ad-hoc network (VANET) may be used.

In the above-described embodiment, it has been described that when the warning message is transmitted/received through the V2V communication or V2R (R2V) communication, encryption is not performed to quickly perform data processing and reduce a computational amount according to the data processing, an encryption algorithm may be applied to the warning message for security.

According to one embodiment, the source vehicle 3902 encrypts the warning message with a public key broadcasted by an RSU1 3950 to which the source vehicle 3902 accesses to transmit the encrypted warning message to the RSU1 3950 through the V2R (R2V) communication channel. When the encrypted warning message is received, the RSU1 3950 decrypts the encrypted warning message with an own secret key and encrypts the warning message in which an ID of the source vehicle included in the warning message is replaced with an ID of the RSU1 3950 with a secret key again to broadcasted to the encrypted warning message to the vehicles in the coverage 3955. The vehicles which receive the encrypted warning message from the RSU1 3950 decrypt the encrypted warning message with the public key of the RSU1 3950 received from the RSU1 3950 to operate various operations related to the warning message.

According to one embodiment, a structure of the broadcast message which is broadcasted by the RSU is configured as represented in Table 5.

TABLE 5

| Field | Description |
|---|---|
| Message Type | Broadcast |
| RSU ID | RSU Identifier |
| RSU location | RSU's location information |
| information | |
| Neighbor RSU's | List of adjacent RSU |
| information | |
| Public key | Decryption/Encryption key |
| Public key | Public Key Issue date, Public key validation date, |
| information | certificate authority information, Public key version |

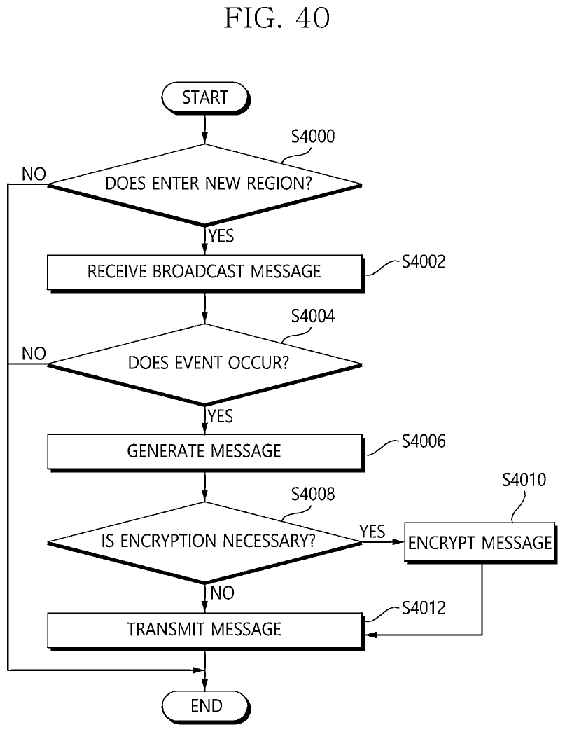

FIG. 40 is an operation flowchart of a source vehicle in which event occurs according to an embodiment.

In operation S4000, when the source vehicle which is driving enters a region of a new RSU (S4000—Yes), in operation S4002, a message received from the existing RSU is discarded and a broadcast message is received from a new serving RSU which controls a region where the source vehicle newly enters.

In operation S4004, when an event occurs in the source vehicle (S4004—Yes), the source vehicle generates a warning message related to the generated event in operation S4006 and determines whether encryption for the warning message is necessary or not in operation S4008.

When the encryption is necessary in operation S4008 (S4008—Yes), in operation S4010, the source vehicle encrypts the warning message with the public key included in the broadcast message and in operation S4012, transmits the encrypted message through V2V communication or V2R (R2V) communication.

In contrast, when the encryption is not necessary in operation S4008 (S4008—No), the source vehicle transmits the message through V2V communication or V2R (R2V) communication without encrypting the generated warning message in operation S4012.

The operation S4012 is periodically or aperiodically repeated until a response message is received from the vehicle which receives the message or the RSU.

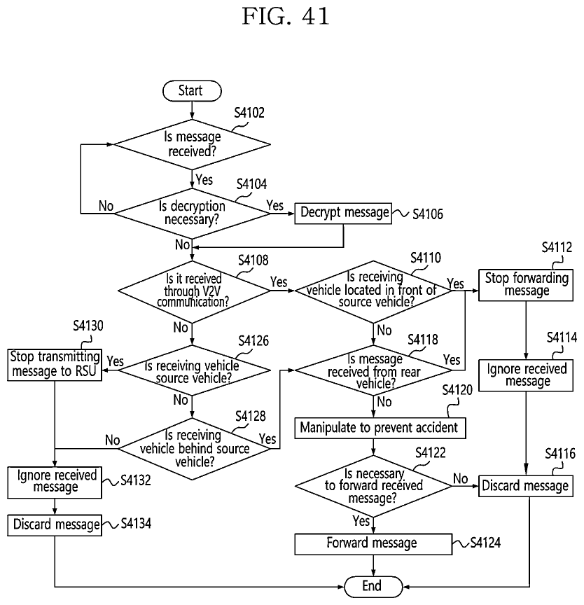

FIG. 41 is an operation flowchart of a receiving vehicle according to an embodiment.

In operation S4102, when the message is received (S4102—Yes), the receiving vehicle determines whether the received message is necessary to be decrypted in operation S4104. In operation S4104, if the decryption is necessary (S4104—Yes), the receiving vehicle decrypts the message using the predetermined encryption/decryption algorithm in operation S4106, and if the decryption is not necessary (S4104—No), determines that the message decryption is not necessary to go to operation S4108. In operation S4108, the receiving vehicle determines whether the received message is received through the V2V communication. The receiving vehicle may identify the communication band at which the message is received based on whether the message is received through the V2V communication band or received through the V2R (R2V) communication band.

In operation S4108, if the message is received through the V2V communication (S4108—Yes), it is checked whether the receiving vehicle is located in front of the source vehicle on the basis of the location information of the source vehicle included in the message in operation S4110. In operation S4110, if the receiving vehicle is located in front of the source vehicle (S4110—Yes), the event generated in the source vehicle is less likely to affect the driving of the receiving vehicle. Therefore, the receiving vehicle stops forwarding of the received message in operation S4112, ignores the received message in operation S4114, and discards the message in operation S4116.

In operation S4110, it is confirmed whether the receiving vehicle is located in front of the source vehicle on the basis of the location information of the source vehicle included in the message and when the receiving vehicle is not located in front of the source vehicle (that is, the receiving vehicle is located behind the source vehicle) (S4110—No), in operation S4118, it is determined whether the received message is received from a rear vehicle of the receiving vehicle.

In operation S4118, when the message is received from the rear vehicle (S4118—Yes), the event generated in the rear vehicle is less likely to be affected to the driving, so that the receiving vehicle goes to operation S4112.

In contrast, in operation S4118, when the message is not received from the rear vehicle (S4118—No), the received message is highly likely to affect the driving of the receiving vehicle so that the receiving vehicle performs the vehicle manipulation to prevent the accident in operation S4120. Specifically, in operation S4120, the vehicle manipulation performed by the receiving vehicle to prevent the accident of the receiving vehicle may include generation of a control command from the processor to perform deceleration, lane change, stop, steering wheel angle adjustment. In operation S4122, when it is necessary to forward the received message (S4122—Yes), in operation S4124, the receiving vehicle transmits the received message to the other vehicle and/or the RSU through the V2V communication and/or the V2R (R2V) communication.

In operation S4108, the receiving vehicle checks whether the message received in operation S4102 is received through the V2V communication and when the message is received through the V2V communication (S4108—Yes), the receiving vehicle goes to operation S4110.

In contrast, in operation S4108, the receiving vehicle checks whether the message received in operation S4102 is received through the V2V communication and when the message is not received through the V2V communication (S4108—No), determines that the message is received through the V2R (R2V) communication and checks whether the receiving vehicle is the source vehicle in operation S4126. At this time, in operation S4126, the receiving vehicle compares the source vehicle ID included in the received message and its own ID and when two IDs are identical, it is determined that the received message is a message generated by the event generated therein.

In operation S4126, when the receiving vehicle is a source vehicle (S4126—Yes), the receiving vehicle stops the message forwarding to the RSU in operation S4130 and ignores the received message in operation S4132, and discards the message in operation S4134.

In contrast, in operation S4126, when the receiving vehicle is not a source vehicle (S4126—No), it is checked that the receiving vehicle is located behind the source vehicle in operation S4128.

In operation S4128, when the receiving vehicle is behind the source vehicle (S4128—Yes), the event generated in the source vehicle may affect the driving situation so that the receiving vehicle goes to operation S4118 and when the receiving vehicle is not behind the source vehicle operation (S4128—No), goes to the operation S4132.

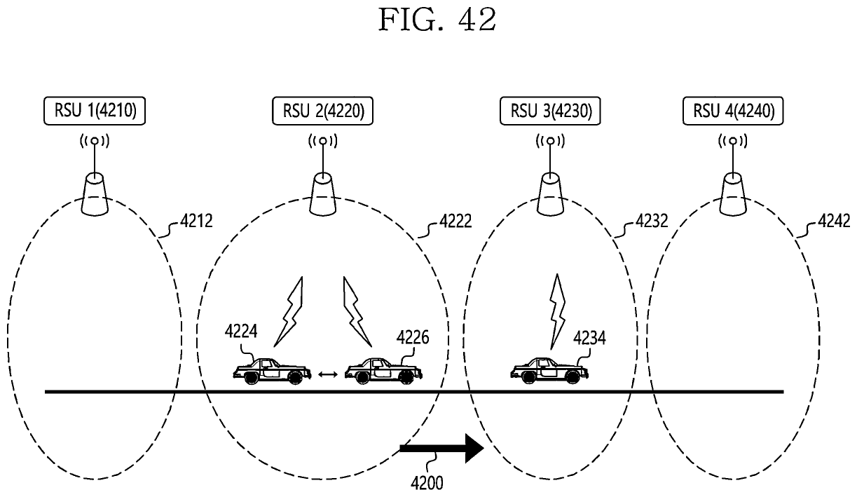

FIG. 42 is a view for explaining a vehicle communication system structure according to an embodiment.

FIG. 42 is a view for explaining that when encryption procedure is performed during V2V communication and V2R (R2V) communication, RSUs 4120, 4220, 4230, 4240 insert a key for encryption to a message broadcasted to vehicles located in its coverage according to an embodiment

In one embodiment, both the methods for using symmetric cryptography and asymmetric cryptograph will be described.

Referring to FIG. 42 again, the RSU2 4220 transmits a broadcast message broadcasted to the vehicles 4224 and 4226 in the coverage 4222 with encryption keys for V2V communication and V2R communication. In FIG. 42, reference number 4200 denotes a driving direction of vehicles 4224, 4226, 4234.

The RSU2 4220 may insert identifiers ID of the RSUs 4230 and 4240 present on the driving direction and encryption keys to be used for the coverages 4232 and 4242 of the RSUs 4230 and 4240 in the broadcast message and encryption keys used in the coverages 4232 and 4242 of the RSUs 4230 and 4240, by considering the driving direction 4200 of the vehicles 4224 and 4226, as well as the encryption key to be used in the coverage 4222 of the RSU2 4220.

In one embodiment, for the convenience of description, a key used by the vehicles 4224 and 4226 located in the coverage 4222 of the RSU2 4220 for encryption/decryption is defined as an encryption key and a key used for encryption/decryption in vehicles located in the coverages 4232 and 4242 of the RSUs 4230 and 4240 located on the driving direction 4200 of the vehicles 4224, 4226, 4234 is defined as a pre-encryption key.

In one embodiment, an RSU which performs communication with the vehicle notifies the pre-encryption key used for the RSUs located on the driving direction of the vehicle to the vehicle in advance to reduce the time consumed for the encryption/decryption procedure.

Specifically, the RSU2 4220 may insert the RSU2 (4220) identifier, a secret key corresponding thereto, an RSU3 (4230) identifier, a pre-encryption key corresponding thereto, an RSU4 (4240) identifier (ID) and a pre-encryption key corresponding thereto in the broadcast message broadcasted to the vehicles 4224 and 4226.

The broadcast message broadcasted by the RSU2 4220 includes fields in the following Table 6.

TABLE 6

| Field | Description |
|---|---|
| Serving RSU | ID of Serving RSU 4220 |
| Encryption | Encryption policy information (whether to perform |
| Policy | encryption) |
| Encryption | Type of encryption algorithm to be used (symmetric |
| Algorithm | algorithm, asymmetric algorithm) |
| Encryption Key | Encryption key information used to encrypt V2V and |
| | V2R communication in coverage of serving RSU 4220 |
| Neighbor RSUs | List of N neighbor RSUs 4230 and 4240 located on |
| | driving direction of vehicle |
| Pre-Encryption | N pre-encryption key information allocated to every |
| Key | neighbor RSUs |

In Table 6, the management such as generation, extinction, allocation of encryption key/decryption key used in the RSU may be performed in a control center 3980 of the RSUs or the certificated authority agency.

The RSU ID and the encryption key corresponding thereto may be reused in a predetermined distance unit or a predetermined group unit.

Specifically, in FIG. 42, the vehicle 4224 and the vehicle 4226 may encrypt/decrypt messages transmitted/received from each vehicle using the encryption key in the broadcast message received from the RSU2 4220 which is the serving RSU. Further, in FIG. 42, the vehicle 4224 and the vehicle 4226 may encrypt/decrypt messages transmitted/received from the RSU2 4220 using the encryption key in the broadcast message received from the RSU2 4220 which is the serving RSU.

In one embodiment of FIG. 42, both the methods using symmetric cryptography and asymmetric cryptography will be described.

Specifically, when the message is exchanged through the V2V communication between the vehicle 4224 and the vehicle 4226, the encryption/decryption is performed using the encryption key included in the broadcast message as a symmetric key to ensure the integrity for the message.

In contrast, when the message is exchanged through the V2R (R2V) communication between the vehicles 4224 and 4226 and the RSU2 4220, the encryption/decryption is performed using the encryption key included in the broadcast message as an asymmetric key. That is, specifically, when the message is exchanged through the V2R (R2V) communication between the vehicles 4224 and 4226 and the RSU2 4220 using the asymmetric algorithm, the RSU2 4220 inserts the own public key in the broadcast message to broadcast and the vehicles 4224 and 4226 which received the broadcast message encrypt the message generated at the time of event occurrence with the public key of the RSU2 4220 and transmits the encrypted message to the RSU2 4220. The RSU2 4220 decrypts the encrypted message received from the vehicles 4224 and 4226 with its own secret key. In contrast, when a message to be broadcasted to the vehicles 4224 and 4226 is generated, the RSU2 4220 encrypts the generated message with the secret key and broadcasts the encrypted message. The vehicles 4224 and 4226 which receive the message encrypted with the secret key of the RSU2 4220 decrypt the encrypted message with the public key of the RSU2 4220 to confirm the integrity of the data and manipulate to avoid the collision or prevent the accident.

The vehicles 4224 and 4226 have already known a pre-encryption key used in the neighbor RSUs (RSU3 4230 and RSU4 4240) in the broadcast message broadcasted from the serving RSU2 4220 so that as soon as the vehicles 4224 and 4226 enter the neighbor RSUs, the vehicles 4224 and 4226 encrypt or decrypt using a pre-obtained pre-encryption key the message generated in the neighbor RSU coverage, to minimize the time delay according to the encryption/decryption.

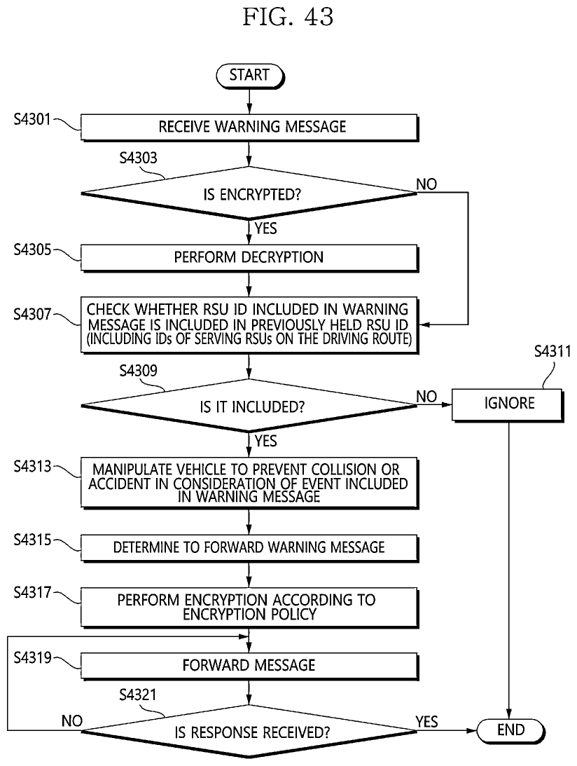

FIG. 43 is an operation flowchart of a receiving vehicle according to an embodiment.

In operation S4301, when the receiving vehicle receives the warning message, in operation S4303, the receiving vehicle identifies whether the received message is encrypted and if the message is encrypted (S4303—Yes), in operation S4305, decrypts the message using a predetermined encryption algorithm (symmetric encryption key or asymmetric encryption key) and in operation S4307, identifies whether the RSU ID included in the received warning message is included in a previously held RSU ID (including IDs of RSUs located on the driving route).

In operation S4309, when the RSU ID included in the received warning message is not included in the previously held RSU ID (S4309—No), the receiving vehicle ignores the message in operation S4311 and when the RSU ID included in the received warning message is included in the previously held RSU ID (S4309—Yes), performs the vehicle manipulation to prevent the collision or accident in consideration of the event included in the warning message in operation S4313.

In operation S4315, when it is determined that it is necessary to forward the warning message to the other vehicle or infrastructures on the road, the receiving vehicle performs the encryption according to the encryption policy in operation S4317 and then forwards the message through the V2V channel and/or the V2R (R2V) channel in operation S4319. The process of forwarding the warning message through the V2V channel and/or the V2R (R2V) channel is simultaneously performed.

In operation S4321, when a response message is not received from the reception side which receives the warning message (S4321—No), the receiving vehicle forwards the warning message again in operation S4319.

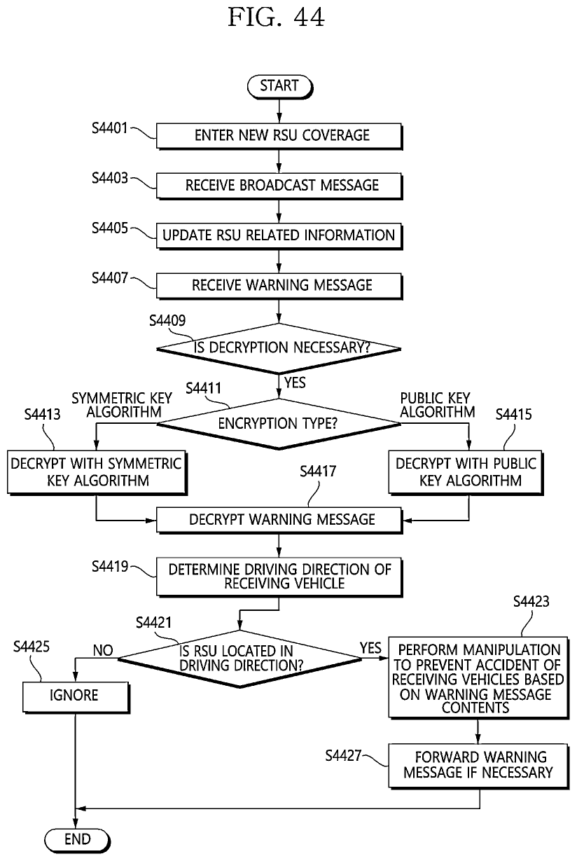

FIG. 44 is an operation flowchart of a receiving vehicle according to an embodiment.

In operation S4401, when the receiving vehicle enters a coverage of a new RSU, the receiving vehicle receives a broadcast message from the newly entering RSU based on identifying of the entering to the new RSU's coverage in operation S4403. In operation S4405, the receiving vehicle update RSU related contents using the RSU related information included in the received broadcast message and when the warning message is received in operation S4407, it is determined whether the decryption of the warning message is necessary in operation S4409.

When it is determined that the decryption is necessary in operation S4409 (S4409—Yes), the receiving vehicle identifies an encryption method applied for the communication in the currently entering RSU coverage and if the symmetric key algorithm is applied, in operation S4413, the received warning message is decrypted with the symmetric key algorithm and if the public key algorithm is applied, in operation S4413, the received warning message is decrypted with the public key algorithm.

In operation S4417, when the warning message is decrypted, the receiving vehicle determines a driving direction of the receiving vehicle in operation 54419. In operation S4421, if the receiving vehicle identifies the location where the event included in the warning message occurs or that the RSU which transmits the warning message is located in the driving direction of the receiving vehicle (S4421—Yes), the receiving vehicle performs the manipulation to prevent the accident of the receiving vehicle on the basis of the received warning message in operation S4423 and when it is necessary to forward the warning message in operation S4427, forwards the warning message through the V2V and/or V2R (R2V).

In contrast, in operation S4421, when the location where the event included in the warning message occurs or the RSU which transmits the warning message is not equal to the driving direction of the receiving vehicle (S4421—No), the receiving vehicle ignores the received warning message in operation S4425.

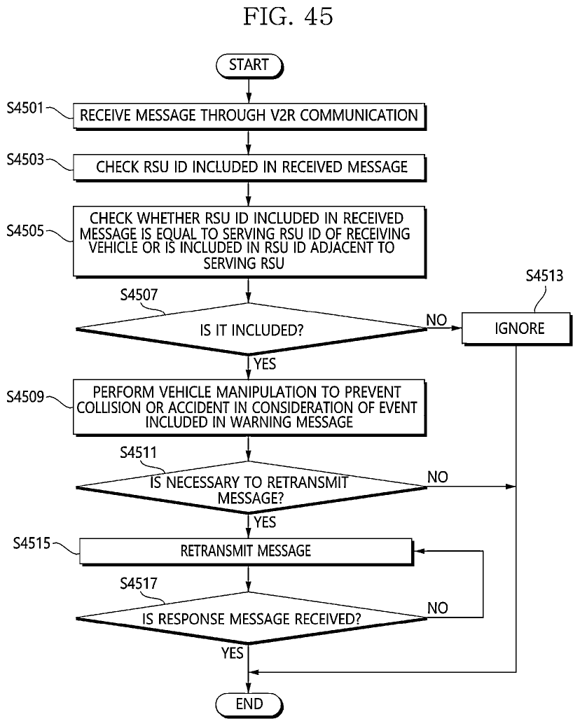

FIG. 45 is an operation flowchart of a receiving vehicle according to an embodiment.

In operation S4501, if the receiving vehicle receives a message through the V2R communication, in operation S4503, the receiving vehicle checks an RSU ID included in the received message. The receiving vehicle checks whether the RSU ID included in the received message is equal to an RSU ID (serving RSU ID) corresponding to a coverage to which the receiving vehicle belongs or equal to any one of adjacent RSU IDs.

In operation S4507, if the RSU ID included in the received message is included in previously held RSU IDs (S4507—Yes), in operation S4509, the receiving vehicle performs manipulation of a vehicle to prevent collision or accident in consideration of an event included in the warning message and in step S4511, determines whether it is necessary to forward (retransmit) the message. In operation S4511, if it is necessary to retransmit (forward) the message (S4511—Yes), in operation S4515, the receiving vehicle retransmits the message and in operation S4517, checks whether the response message for the message is received from the receiving side. If the response message is not received (S4517—No), the receiving vehicle proceeds to the operation S4515 to periodically retransmit the message until the response message is received.

In contrast, in operation S4507, if the RSU ID included in the received message is not included in the previously held RSU IDs (S4507—No), in operation 54513, the receiving vehicle ignores the received message.

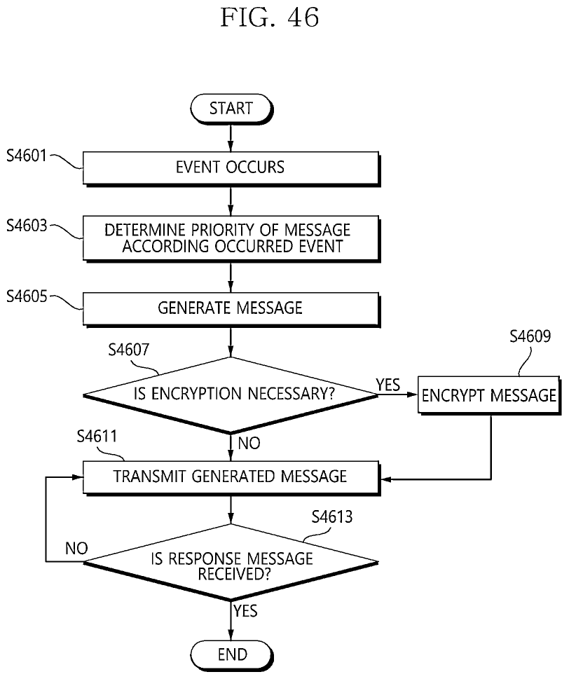

FIG. 46 is an operation flowchart of a source vehicle according to an embodiment.

In operation S4601, if an event occurs, in operation S4603, the source vehicle determines a priority of a message according to the occurred event and in operation S4605, generates a warning message.

In operation S4607, if it is necessary to encrypt the generated warning message, in operation S4609, the source vehicle encrypts the message and in operation S4611, transmits the generated message by the V2V and/or V2R (R2V) communication method.

In operation S4613, if the response message for the message transmitted in operation S4611 has not been received (S4613—No), the source vehicle retransmits the message in operation S4611.

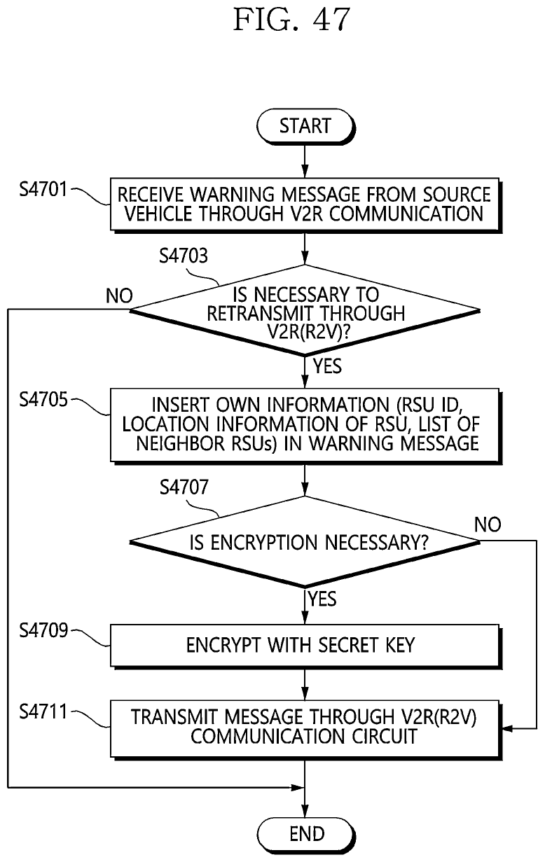

FIG. 47 is an operation flowchart of a RSU according to an embodiment.

In operation S4701, if the warning message is received from the source vehicle through V2R communication, in operation S4703, the RSU determines whether it is necessary to retransmit the warning message to the other vehicle or the other RSU through V2R (R2V) communication.

In operation S4703, if it is necessary to retransmit the warning message through V2R (R2V) (S4703—Yes), the RSU inserts its own information (RSU ID, location information of RSU, and a list of neighbor RSUs) in the warning message in operation S4705. In operation S4707, if the encryption is not necessary (S4707—No), the RSU transmits the message through a V2R (R2V) communication circuit in operation S4711 and if the encryption is necessary (S4707—Yes), after encrypting the message with its own secret key in operation S4709, the RSU transmits the message through the V2R (R2V) communication circuit in operation S4711.

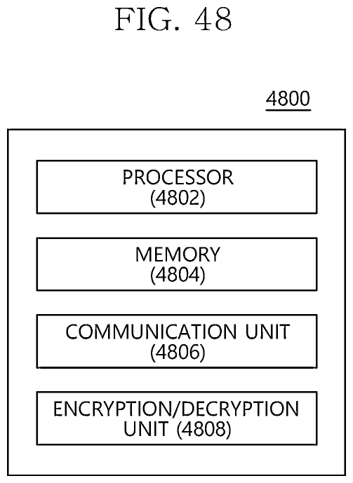

FIG. 48 is a block diagram of a RSU 4800 according to an embodiment.

The RSU 4800 according to an embodiment may include a processor 4802, a memory 4804, a communication unit 4806, and an encryption unit/decryption unit 4808.

The processor 4802 controls the above-described overall operation of the RSU 4800 and checks whether to enter the coverage of the vehicle or leave the coverage through a V2R (R2V) message received through the communication unit 4806 and generates a list of vehicle identifiers within the coverage checked thereby to store the list in the memory 4804. The processor 4802 checks the IDs and location information of adjacent RSUs received from the control center as well as the ID and location information of the RSU 4800 and acquires information of RSUs located on the driving route of the receiving vehicle which will receive the message as well as information of the ID of a RSU (a serving RSU) which allocates a channel to the receiving vehicle, and transmits the information as a broadcast message through the communication unit 4806.

Further, it is necessary to encrypt or decrypt the V2R (R2V) message, the processor 4802 controls the encryption/decryption unit 4808 to encrypt/decrypt the message using a predetermined encryption method.

The communication unit 4806 is connected to the vehicle through the V2R (R2V) communication to transmit a message to the vehicle or receive a message from the vehicle.

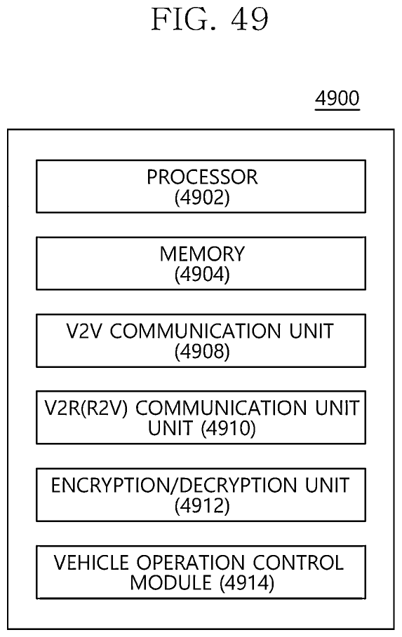

FIG. 49 is a block diagram of an electronic device 4900 of a vehicle according to an embodiment.

An electronic device 4900 of the vehicle according to an embodiment may include a processor 4902, a memory 4904, a V2V communication unit 4908, a V2R (R2V) communication unit 4910, an encryption/decryption unit 4912, and a vehicle operation control module 4914.

The processor 4902 controls an operation of the electronic device of a vehicle according to the above-described embodiments. When an event such as impact detection, rapid deceleration, road construction, or traffic accident occurs, the processor 4902 generates a warning message including at least one of an event type indicating a type of the event, a location where the event occurs, an ID of the vehicle, and a RSU ID and transmits the warning message to the other vehicle or the RSU through the V2V communication unit 4908 and/or the V2R (R2V) communication unit 4910. At this time, the event type according to the type of the event, the vehicle ID, and ID information of the serving RSU which provides a service to the vehicle are acquired by the processor 4902 from the contents of the broadcast message received through the V2R (R2V) communication unit 4910 and then stored in the memory 4904.

The V2V communication unit 4908 transmits/receives a message between the electronic device 4900 of the vehicle and an electronic device of the other vehicle through the V2V communication and the V2R (R2V) communication unit 4910 transmits/receives a message between the electronic device of the vehicle and an electronic device of the RSU through the V2R (R2V) communication.

When an encryption policy is determined in the message transmitted/received through the V2V communication and/or the V2R (R2V) communication, the encryption/decryption unit 4912 may encrypt/decrypt the transmitted/received message using the determined encryption policy (a symmetric algorithm or an asymmetric algorithm).

Specifically, when a request to decrypt the received message is received from the processor 4902 through the V2V communication unit 4908 and/or the V2R (R2V) communication unit 4910, the encryption/decryption unit 4912 decrypts the message using a previously stored secret key or symmetric key and then stores the decrypted message in the memory 4904. The processor 4902 identifies contents related to the event generated in the source vehicle from the decrypted message stored in the memory 4904, detects a risk present on the driving direction of the vehicle in advance and controls the vehicle operation control module 4914 to generate a vehicle operation control command to mitigate the collision or the accident.

In contrast, the processor 4902 of the electronic device 4900 of the source vehicle generates a warning message including information such as an event type corresponding to the occurred event, a location where the event occurs, a source vehicle ID, and an event occurrence time based on detection of event occurrence such as deceleration, rapid deceleration, rapid acceleration, sharp lane change, a road construction zone, a risky road zone, or traffic accident occurrence and stores the warning message in the memory 4904. Further, the processor 4902 controls to transmit the generated warning message to the other vehicle or RSU through the V2V communication unit 4908 and/or the V2R (R2V) communication unit 4910.

Further, in the electronic device 4900 of the source vehicle, if the encryption for the generated warning message is necessary, the processor 4902 controls an encryption/decryption unit 4912 to encrypt the message with the encryption key and transmit the encrypted message to the other vehicle and/or RSU through the V2V communication unit 4908 and/or the V2R (R2V) communication unit 4910.

According to the embodiment, as a road infrastructure which communicates with the vehicle, an RSU is used, but the present invention is not limited thereto so that any entity which allocates a backward channel to the vehicle through a vehicle and a cellular network and performs the scheduling may be allowed.

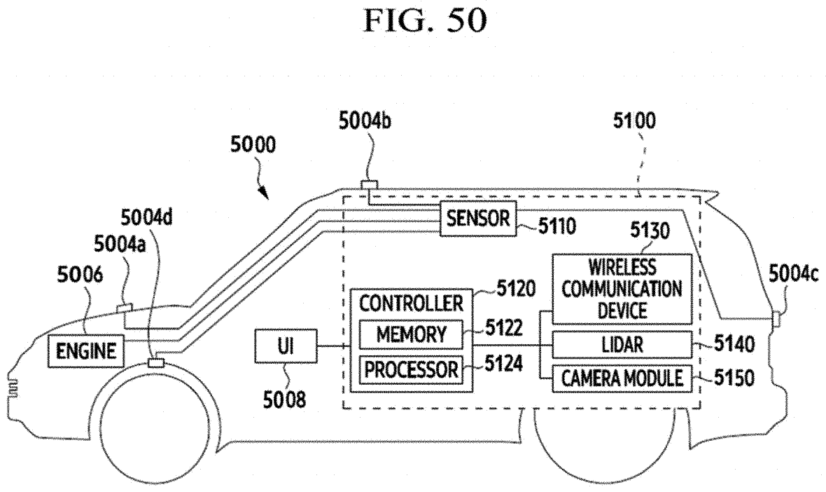

FIG. 50 illustrates an example of a vehicle including an electronic device according to various embodiments. For example, the vehicle may be the vehicle illustrated in FIG. 39.

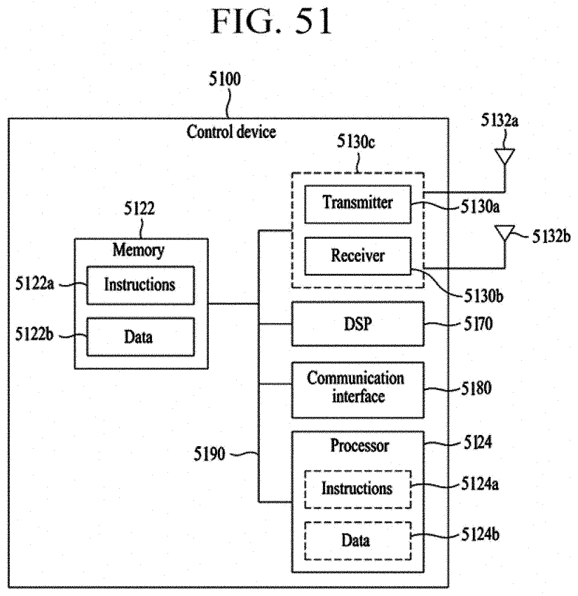

FIG. 51 illustrates an example of a functional configuration of an electronic device according to various embodiments. Such a functional configuration may be included in the electronic device 2900 illustrated in FIG. 29.

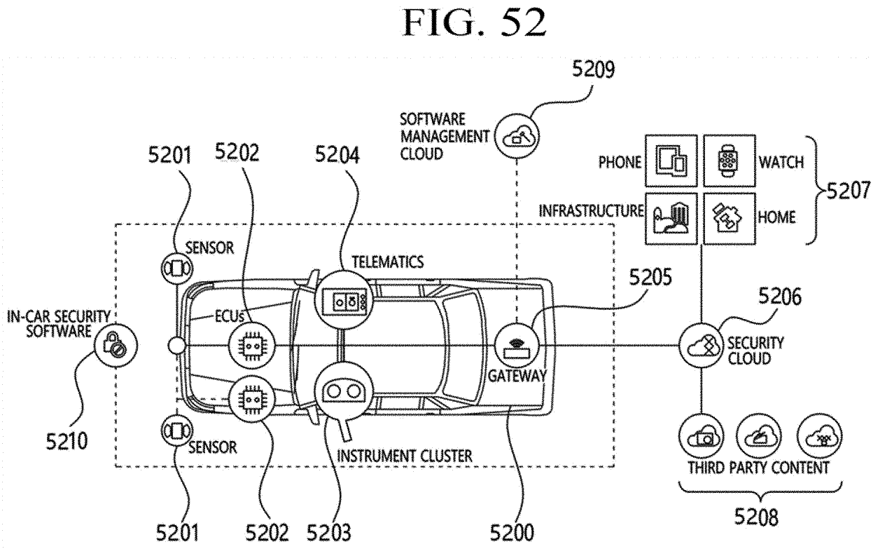

FIG. 52 illustrates an example of a gateway related to an electronic device according to various embodiments. Such a gateway may be related to the electronic device 2900 illustrated in FIG. 29.

Referring to FIGS. 50 and 51, the control device 5100 (e.g., the electronic device 2900 of FIG. 29) according to various embodiments may be mounted on the vehicle 5000.

In various embodiments, the control device 5100 may include a controller 5120 including a memory 5122 and a processor 5124, and a sensor 5130.

According to various embodiments, the controller 5120 may be configured by a manufacturer of a vehicle or may be additionally configured to perform a function of autonomous driving after manufacturing. Alternatively, a configuration for continuously performing additional functions may be included through an upgrade of the controller 5120 configured during manufacturing.

The controller 5120 may transmit the control signal to the sensor 5110, the engine 5006, the user interface 5008, the wireless communication device 5130, the LIDAR 5140, and the camera module 5150 included in other components in the vehicle. In addition, although not shown, the controller 5120 may transmit a control signal to an acceleration device, a braking system, a steering device, or a navigation device related to driving of the vehicle.

In various embodiments, the controller 5120 may control the engine 5006, for example, detect the speed limit on the road where the autonomous vehicle 5000 is traveling, control the engine 5006 so that the driving speed does not exceed the speed limit, or control the engine 5006 to accelerate the driving speed of the autonomous vehicle 5000 within a speed limit. In addition, when sensing modules 5004a, 5004b, 5004c, and 5004d detect the environment outside the vehicle and transmit it to the sensor 5110, the controller 5120 may receive it and generate a signal for controlling the engine 5006 or the steering device (not shown) to control driving of the vehicle.

When there is another vehicle or obstruction in front of the vehicle, the controller 5120 may control the engine 5006 or the braking system to decelerate the driving vehicle and in addition to speed, control a trajectory, a driving path, and a steering angle. Alternatively, the controller 5120 may control driving of the vehicle by generating a necessary control signal according to recognition information of other external environments such as a driving lane of the vehicle and a driving signal.

By performing communication with neighboring vehicles or central servers in addition to generating their own control signals and transmitting commands for controlling peripheral devices through the received information, the controller 5120 may also control driving of the vehicle.

In addition, when the position of the camera module 5150 is changed or the angle of view is changed, accurate vehicle or lane recognition may be difficult, to prevent this, the controller 5120 may generate a control signal for controlling the camera module 5150 to perform calibration. In other words, even when the mounting position of the camera module 5150 is changed due to vibration or impact generated by the movement of the autonomous vehicle 5000, the controller 5120 may continuously maintain a normal mounting position, direction, and angle of view of the camera module 5150 by generating a calibration control signal to the camera module 5150. When the initial mounting position, direction, and angle of view information of the camera module 5120 stored in advance and the initial mounting position, direction, and angle of view information of the camera module 5120 measured while driving of the autonomous vehicle 5000 vary above a threshold value, the controller 5120 may generate a control signal to perform calibration of the camera module 5120.

According to various embodiments, the controller 5120 may comprise a memory 5122 and a processor 5124. The processor 5124 may execute the software stored in the memory 5122 according to the control signal of the controller 5120. Specifically, the controller 5120 stores data and instructions for scrambling audio data according to various embodiments in the memory 5122, and the instructions may be executed by processor 5124 to implement one or more methods disclosed herein.

In various embodiments, the memory 5122 may be stored in a recording medium executable by the processor 5124. The memory 5122 may store software and data through an appropriate internal and external device. The memory 5122 may be configured as a device connected to random access memory (RAM), read only memory (ROM), hard disk, and dongle.

The memory 5122 may store at least an operating system (OS), a user application, and executable commands. The memory 5122 may also store application data and array data structures.

The processor 5124 may be a controller, microcontroller, or state machine as a microprocessor or an appropriate electronic processor.

The processor 5124 may be implemented as a combination of computing devices, the computing device may be a digital signal processor, microprocessor, or configured in an appropriate combination thereof.

In addition, according to various embodiments, the control device 5100 may monitor internal and external features of the autonomous vehicle 5000 and detect a state thereof with at least one sensor 5110.

The sensor 5110 may be configured with at least one sensing module 5004 (e.g., sensor 5004a, sensor 5004b, sensor 5004c, and sensor 5004d), the sensing module 5004 may be implemented at a specific location of the autonomous vehicle 5000 according to the sensing purpose. For example, the sensing module 2004 may be located at a lower end, a rear end, a front end, an upper end, or a side end of the autonomous vehicle 2000, and may also be located at an internal component or tire of the vehicle.

Through this, the sensing module 5004 may detect information related to driving, such as engine 5006, tire, steering angle, speed, vehicle weight, and the like, as internal information of the vehicle. In addition, at least one sensing module 5004 may include an acceleration sensor, a gyroscope, an image sensor, a RADAR, an ultrasonic sensor, a LiDAR sensor and the like, and detect movement information of the autonomous vehicle 5000.

The sensing module 5004 may receive specific data on an external environmental state such as state information of a road on which the autonomous vehicle 5000 is located, surrounding vehicle information, weather, and the like, and may detect vehicle parameters accordingly. The detected information may be stored in the memory 5122, temporarily or in the long term, depending on the purpose.

According to various embodiments, the sensor 5110 may integrate and collect information of sensing modules 5004 for collecting information generated inside and outside the autonomous vehicle 5000.

The control device 5100 may further comprise a wireless communication device 5130.

The wireless communication device 5130 is configured to implement wireless communication between autonomous vehicles 5000. For example, the autonomous vehicle 5000 may communicate with a user's mobile phone, another wireless communication device 5130, another vehicle, a central device (traffic control device), a server, and the like. The wireless communication device 5130 may transmit and receive a wireless signal according to a connection wireless protocol. A wireless communication protocols may be Wi-Fi, Bluetooth, Long-Term Evolution (LTE), Code Division Multiple Access (CDMA), Wideband Code Division Multiple Access (WCDMA), Global Systems for Mobile Communications (GSM), and the communication protocol is not limited thereto.

In addition, according to various embodiments, in addition, according to various embodiments, the autonomous vehicle 5000 may implement communication between vehicles through the wireless communication device 5130. In other words, the wireless communication device 5130 may communicate with other vehicles and other vehicles on the road through V2V (vehicle-to-vehicle communication or V2X). The autonomous vehicle 5000 may transmit and receive information such as a driving warning and traffic information through communication between vehicles and may request information or receive requests from other vehicles. For example, the wireless communication device 5130 may perform V2V communication with a dedicated short-range communication (DSRC) device or a cellular-V2V (C-V2V) device. Besides communication between vehicles, V2X (vehicle to everything communication) between the vehicle and other objects (e.g., electronic devices carried by pedestrians) may also be implemented through the wireless communication device 5130.

In addition, the control device 5100 may comprise the LIDAR device 5140. The LIDAR device 5140 may detect an object around the autonomous vehicle 5000 during operation Using data sensed through a LIDAR sensor. The LIDAR device 5140 may transmit the detected information to the controller 5120, and the controller 5120 may operate the autonomous vehicle 5000 according to the detection information. For example, when there is a vehicle ahead moving at low speed in the detection information, the controller 5120 may command the vehicle to slow down through the engine 5006. Alternatively, the vehicle may be ordered to slow down according to the curvature of the curve into which it is entering.

The control device 5100 may further comprise a camera module 5150. The controller 5120 may extract object information from an external image photographed by the camera module 5150 and allow the controller 5120 to process information on the information.

In addition, the control device 5100 may further comprise imaging devices for recognizing an external environment. In addition to the LIDAR 5140, RADAR, GPS devices, driving distance measuring devices (Odometry), and other computer vision devices may be used, and these devices operate selectively or simultaneously as needed to enable more precise detection.

The autonomous vehicle 5000 may further comprise a user interface 5008 for user input to the control device 5100 described above. User interface 5008 may allow the user to input information with appropriate interaction. For example, it may be implemented as a touch screen, a keypad, an operation button, or the like. The user interface 5008 may transmit an input or command to the controller 5120, and the controller 5120 may perform a vehicle control operation in response to the input or command.

In addition, the user interface 5008 may perform communication with the autonomous vehicle 5000 through the wireless communication device 5130 which is a device outside the autonomous vehicle 5000. For example, the user interface 5008 may enable interworking with a mobile phone, tablet, or other computer device.

Furthermore, according to various embodiments, although the autonomous vehicle 5000 is described as including the engine 5006, may also comprise other types of propulsion systems. For example, the vehicle may be operated with electrical energy and may be operated through hydrogen energy, or a hybrid system combined with the same. Accordingly, the controller 5120 may include a propulsion mechanism according to a propulsion system of the autonomous vehicle 5000 and provide a control signal accordingly to the components of each propulsion mechanism.

Hereinafter, a detailed configuration of the control device 5100 for scrambling audio data according to various embodiments will be described in more detail with reference to FIG. 51.

The control device 5100 includes a processor 5124. The processor 5124 may be a general purpose single or multi-chip microprocessor, a dedicated microprocessor, a microcontroller, a programmable gate array, or the like. The processor may be referred to as a central processing unit (CPU). In addition, according to various embodiments, the processor 5124 may be used as a combination of a plurality of processors.

The control device 5100 also comprises a memory 5122. The memory 5122 may be any electronic component capable of storing electronic information. The memory 5122 may also include a combination of memories 5122 in addition to a single memory.

According to various embodiments, data and instructions 5122a for scrambling audio data may be stored in the memory 5122. When the processor 5124 executes the instructions 5122a, the instructions 5122a and all or part of the data 5122b required for executing the instructions may be loaded onto the processor 5124 (e.g., the instructions 5124aA, the data 5124b).

The control device 5100 may include a transmitter 5130a, a receiver 5130b, or a transceiver 5130c for allowing transmission and reception of signals. One or more antennas 5132a and 5132b may be electrically connected to a transmitter 5130a, a receiver 5130b, or each transceiver 5130c, and may additionally comprise antennas.

The control device 5100 may comprise a digital signal processor DSP 5170. The DSP 5170 may enable the vehicle to quickly process the digital signal.

The control device 5100 may comprise a communication interface 5180. The communication interface 5180 may comprise one or more ports and/or communication modules for connecting other devices to the control device 5100. The communication interface 5180 may allow the user and the control device 5100 to interact.

Various configurations of the control device 5100 may be connected together by one or more buses 5190, the buses 5190 may comprise a power bus, a control signal bus, a state signal bus, a data bus, and the like. Under the control of the processor 5124, the configurations may transmit mutual information and perform a desired function through the bus 5190.

Meanwhile, in various embodiments, the control device 5100 may be related to a gateway for communication with the secure cloud. For example, referring to FIG. 52, the control device 5100 may be related to the gateway 5205 for providing information obtained from at least one of the components 5201 to 5204 of the vehicle 5200 to the secure cloud 5206. For example, the gateway 5205 may be comprised in the control device 5100. For another example, gateway 5205 may be configured as a separate device in vehicle 5200 distinguished from control device 5100. Gateway 5205 connects software management cloud 5209 having different networks, secure cloud 5206 and network in secured vehicle 5200 by in-vehicle security software 5210 to be enable communication.

For example, component 5201 may be a sensor. For example, the sensor may be used to obtain information on at least one of a state of the vehicle 5200 or a state around the vehicle 5200. For example, component 5201 may comprise a sensor 5110.

For example, component 5202 may be electronic control units (ECUs). For example, the ECUs may be used for engine control, transmission control, airbag control, and tire pressure management.

For example, component 5203 may be an instrument cluster. For example, the instrument cluster may refer to a panel positioned in front of a driver's seat among dashboards. For example, the instrument cluster may be configured to show information necessary for driving to a driver (or passenger). For example, the instrument cluster may be used to display at least one of Visual elements for indicating revolution per minute (RPM), the speed of the vehicle 5200, the amount of residual fuel, gear conditions and information obtained through component 5201.

For example, component 5204 may be a telematics device. For example, the telematics device may refer to a device that provides various mobile communication services such as location information and safe driving in a vehicle 5200 by combining wireless communication technology and global positioning system (GPS) technology. For example, the telematics device may be used to connect the driver, the cloud (e.g., secure cloud 5206), and/or the surrounding environment to the vehicle 5200. For example, the telematics device may be configured to support high bandwidth and low latency for technology of 5G NR standard (e.g., V2X technology of 5G NR). For example, the telematics device may be configured to support autonomous driving of the vehicle 5200.

For example, gateway 5205 may be used to connect a network in the vehicle 5200 to a software management cloud 5209, which are out-of-vehicle networks and a secure cloud 5206. For example, the software management cloud 5209 may be used to update or manage at least one software required for driving and managing the vehicle 5200. For example, the software management cloud 5209 may be linked with in-car security software 5210 installed in the vehicle. For example, in-vehicle security software 5210 may be used to provide a security function in the vehicle 5200. For example, the in-vehicle security software 5210 may encrypt data transmitted and received through the in-vehicle network using an encryption key obtained from an external authorized server for encryption of the in-vehicle network. In various embodiments, the encryption key used by in-vehicle security software 5210 may be generated corresponding to vehicle identification information (vehicle license plate, or information uniquely assigned to each user (e.g., user identification information, vehicle identification number).

In various embodiments, gateway 5205 may transmit data encrypted by in-vehicle security software 5210 to software management cloud 5209 and/or secure cloud 5206 based on the encryption key. Software management cloud 5209 and/or secure cloud 5206 may identify that data was received from which vehicle or from which user, by decrypting the data encrypted by the encryption key of the security software 5210 in the vehicle using a decryption key capable of decrypting the data. For example, since the decryption key is a unique key corresponding to the encryption key, the software management cloud 5209 and/or the secure cloud 5206 may identify a sender (e.g., a vehicle or a user) of data based on the decryption key.

For example, gateway 5205 may be configured to support in-vehicle security software 5210 and may be related to control device 5100. For example, gateway 5205 may be related to control device 5100 to support a connection between client device 5207 connected to secure cloud 5206 and control device 5100. For another example, gateway 5205 may be related to control device 5100 to support a connection between third-party cloud 5208 connected to secure cloud 5206 and control device 5100. However, it is not limited thereto.

In various embodiments, the gateway 5205 may be used to connect the vehicle 5200 with the software management cloud 5209 for managing the operating software of the vehicle 5200. For example, the software management cloud 5209 may monitor whether update of the operating software of the vehicle 5200 is required and provide data for updating the operating software of the vehicle 5200 through the gateway 5205 based on monitoring the request for updating the operating software of the vehicle 5200. For another example, the software management cloud 5209 may receive a user request for updating the operating software of the vehicle 5200 from the vehicle 5200 through the gateway 5205 and provide data for updating the operating software of the vehicle 5200 based on the reception. However, it is not limited thereto.

The cloud described in the above-described embodiment may be implemented by server devices connected to the network.

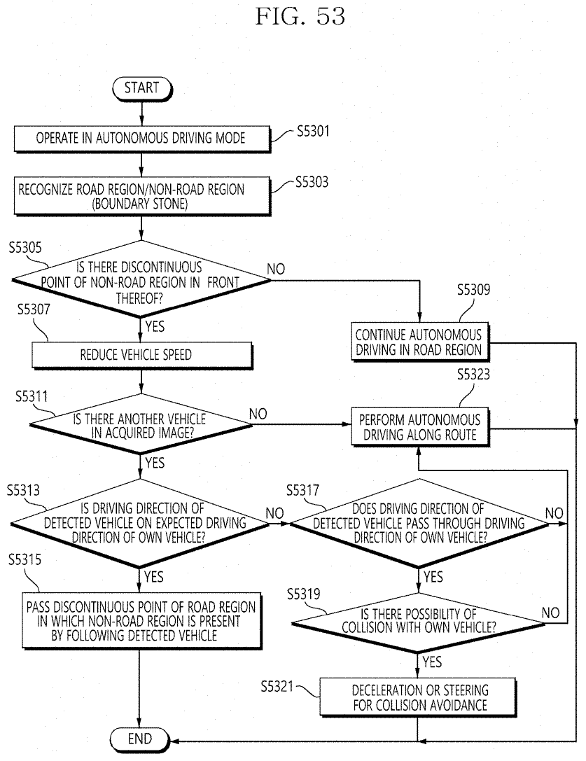

FIG. 53 is an operation flowchart of an autonomous driving system of a vehicle according to an embodiment.

In operation S5301, the autonomous driving system operates in an autonomous mode and in operation S5303, performs the autonomous driving while continuously recognizing a road region/non-road region (a boundary stone).

In operation S5305, when there is a discontinuous point of the non-road region in front thereof (S5305—Yes), the autonomous driving system reduces a vehicle speed in operation S5307. At this time, the discontinuous point of the non-road region includes a section in which other roads are connected, such as intersection including a crossroad or a roundabout.

In operation S5311, when the autonomous driving system detects the presence of the other vehicle from the acquired image (S5311—Yes), in operation S5313, it is determined whether the driving direction of the detected vehicle is located on an expected driving direction of the own vehicle.

In operation S5313, if the driving direction of the detected vehicle is located on an expected driving direction of the own vehicle, in operation S5315, the autonomous driving system follows the detected vehicle to pass through the discontinuous point with a non-road region.

In operation S5305, when there is no discontinuous point of the non-road region in front (S5305—No), the autonomous driving system continuously performs the autonomous driving in the road region in operation S5309.

In operation S5311, when the other vehicle is not detected from the acquired image (S5311—No), the autonomous driving system performs the autonomous driving along the route in operation S5323.

In operation S5313, when the driving direction of the detected vehicle is not located on the expected driving direction of the own vehicle (S5313—No) and in operation S5317, the driving direction of the detected vehicle does not pass through the driving direction of the own vehicle (S5317—No), the autonomous driving system performs the autonomous driving along the route in operation S5323.

In operation S5317, when the driving direction of the detected vehicle passes through the driving direction of the own vehicle (S5317—Yes) and in operation S5319, when there is a collision possibility with the own vehicle, the autonomous driving system adjusts deceleration or steering device to mitigate the collision in operation S5321.

### IV. UAM (Urban Air Mobility)

Hereinafter, in one embodiment of the present invention, a total of three technical fields with regard to UAM will be described.

A first technical field is a technical field which provides a service of transporting human and cargo using UAM and a technical field which controls the UAM which are techniques related to a method of operating the UAM.

A second technical field relates to a method of generating an aerial map required to fly the UAM.

A third technical field is a technique related to a UAM design and structure.

In order to operate the UAM which needs to fly over various terrain features such as high-rise buildings, low-rise buildings, roads, and mountains, the safety of the passenger and UAM is the most important factor to be considered. Safety considerations to be considered for the operation of the UAM in the future may include prevention of air collision between UAMs, handling of emergency of UAM, or handling of flight control failure such as crash of flight. Among them, the prevention of air collision is very important matter in a circumstance in which a large number of UAMs are flying over limited urban areas.

To this end, in the present invention, it is determined that regardless of the unmanned/manned control of the UAM, it is very important to provide psychological stability to passengers by displaying a flight route of the UAM in the air on the display in augmented reality (AR).

At this time, by displaying not only the route of the UAM on which the passenger is boarding, but also the flight routes of UAMs flying within a predetermined radius among UAMs flying around the boarded UAM in the AR, it is desirable to visually provide that the UAM flies along a route that the collision does not occur, to the passengers.

Accordingly, the UAM desirably provides the flight route and surrounding environments of the UAM by augmented reality (AR).

At the beginning of the introduction of UAM, it is desirable to perform flight with a pilot boarding on the UAM. However, in accordance with the development of the technology, the autonomous flying technology is introduced to the UAM like the vehicle and specifically, it is desirable to develop in a way that additionally considers a characteristic of the urban (avoiding high-rise buildings, electric wires, birds, gusts, or clouds) to an automatic navigation technology which has been already applied to commercial aircraft.

However, if the UAM is operated by autonomous flight without a pilot, passengers boarding on the UAM may feel uncomfortable so that it is important to intuitively provide information that the UAM is safely flying.

Accordingly, in one embodiment, it is disclosed that the flight route and the surrounding information of the UAM is provided through the AR. In the present invention, in order to display the flight route of the UAM by the AR to the passengers on the UAM, it is necessary to display the AR in consideration of the flight altitude of the UAM. Therefore, a virtual sphere is generated on the UAM and an AR indication line is mapped to a virtual point implemented thereby to display the AR indication line for the natural flight route of the UAM to the user.

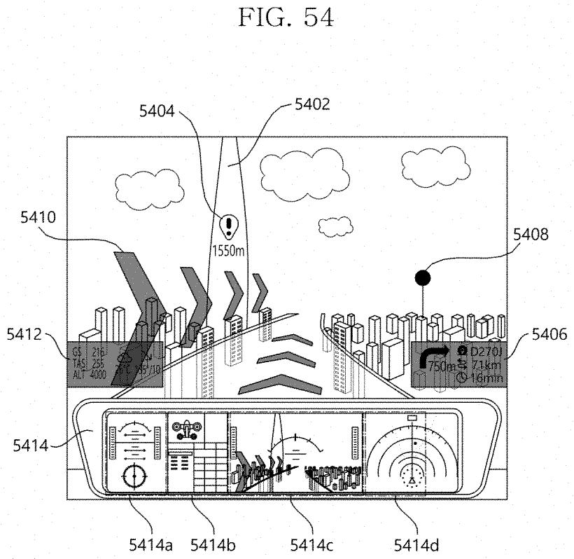

FIG. 54 is a view illustrating a screen on which information necessary for flight and a flight route are displayed in UAM according to an embodiment.

Reference number 5402 denotes an obstacle during the flight on the flight route of the UAM and displays the identified object to be visually emphasized. Reference number 5404 denotes distance information to the detected obstacle 5402 by the AR. Reference number 5406 denotes information (speed, estimated time of arrival, turn information) about the flight information during the flight of the UAM and reference number 5408 denotes that a POI (point of interest) on the flight route is displayed. Here, the POI may be a vertiport on which the UAM may land or a stopover.

Reference number 5410 denotes that the flight route of the UAM is displayed in the AR and reference number 5412 denotes that weather, temperature, altitude information which may affect the flight of the UAM is displayed in the AR.

Reference number 5414 denotes a dashboard that displays various information required for flight of the UAM to a pilot of the UAM.

Reference number 5414a denotes information to identify a driving direction of UAM and a flying attitude of the UAM by identifying a pitch, roll, and yaw of the UAM. Reference number 5414b denotes that information about an operation state or abnormality of each rotor of a flight power source (for example, a quadcopter flying with four rotors) of the UAM is displayed in real time.

Reference number 5414c denotes that a flight route of the UAM is displayed to overlap a front image of the UAM acquired by a camera mounted in the UAM and reference number 5414d denotes that directions or distances of obstacles (objects) in the driving direction of the UAM is displayed by a RADAR mounted in the UAM.

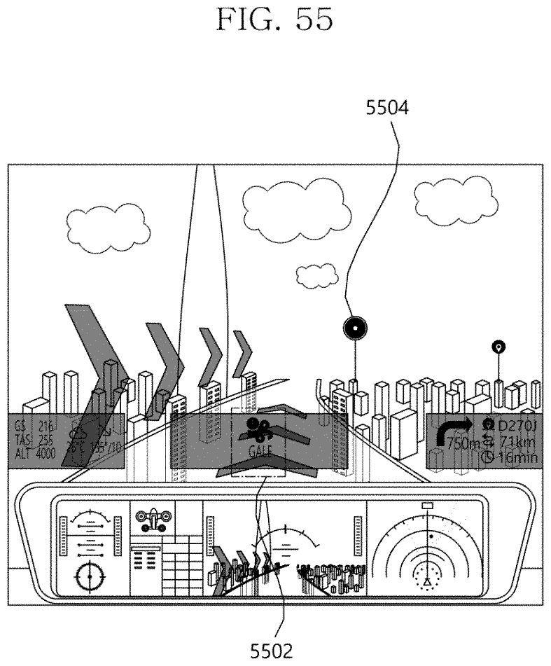

FIG. 55 illustrates that weather information (for example, gale) which may affect the flight of UAM is represented by AR according to an embodiment.

Reference number 5502 denotes that gale which is one of elements affecting the flight of the UAM is generated on the flight route and reference number 5504 denotes a location where the gale is generated.

Hereinafter, an architecture which controls the UAM and provides an UAM service to the user will be described according to an embodiment.

In a preferred embodiment, a specific urban is divided into predetermined areas and a surface (a flight surface) at a predetermined altitude in which the UAM flies is defined as a layer and a route that the UAM flies on the layer is displayed by way points at a predetermined interval.

In order to generate the layer, first, various structures (buildings, roads, and bridges) located in a flying target area where the UAM will fly and heights of the structures need to be measured and stored in a database and the information may be periodically/aperiodically updated. A restricted flight altitude of the area where the UAM flies may be set from data collected in the database and a layer where each UAM may fly may be set from the information.

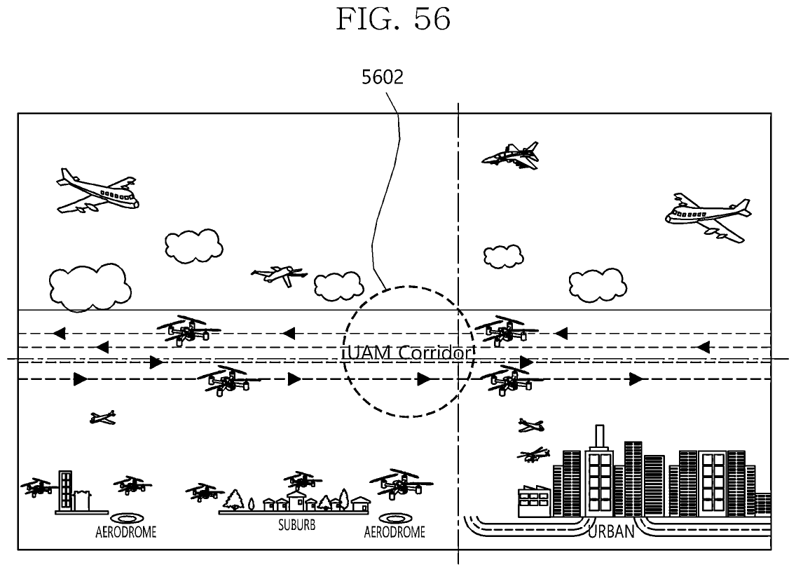

FIG. 56 is a view for describing that as a flight route of the UAM, a corridor 5602 which is a flight passage for every altitude is set and UAM flies only through the set flight passage 5602 according to an embodiment.

As illustrated in FIG. 56, it is important that the UAM flies only through a flight passage permitted in advance by an UAM operating system to prevent the collision with the other UAM.

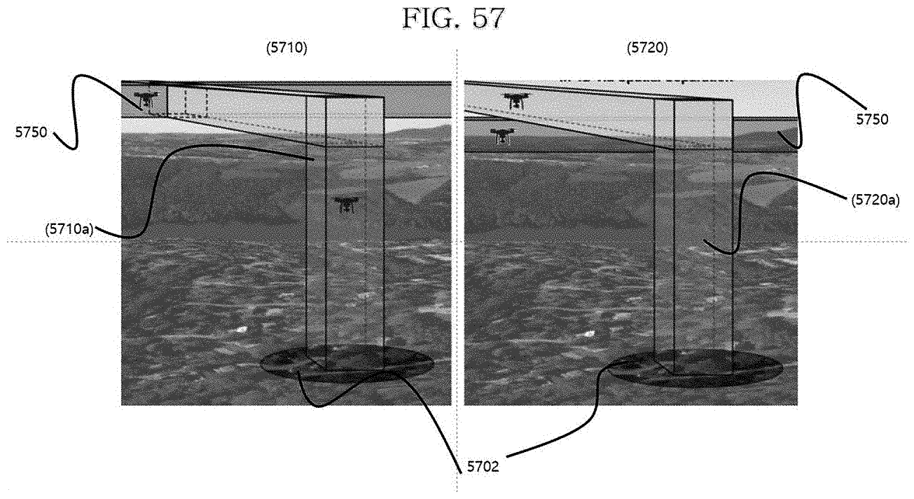

FIG. 57 is a view for describing a flight passage allocated to allow the UAM to take off and land at a vertiport according to an embodiment.

As illustrated in FIG. 57, in order to operate the UAM, it is desirable to designate a vertiport 5702 which is an area where the UAM loads or unloads passengers/cargo in a target area where the UAM flies, in advance. The vertiport 5702 may be used not only for the purpose of taking off/landing to load or unload the passengers/cargo of the UAM, but also for the purpose of emergency landing of the UAM or maintenance of the UAM and is desirably mainly located on a high-rise building.

In FIG. 57, reference number 5710a is a corridor which is a flight passage allocated to allow the UAM to land at the vertiport 5702 from the flight passage 5750 and reference number 5720a is a flight passage allocated to allow the UAM to land at the vertiport 5702 without overlapping the flight passage 5750 of the other UAM.

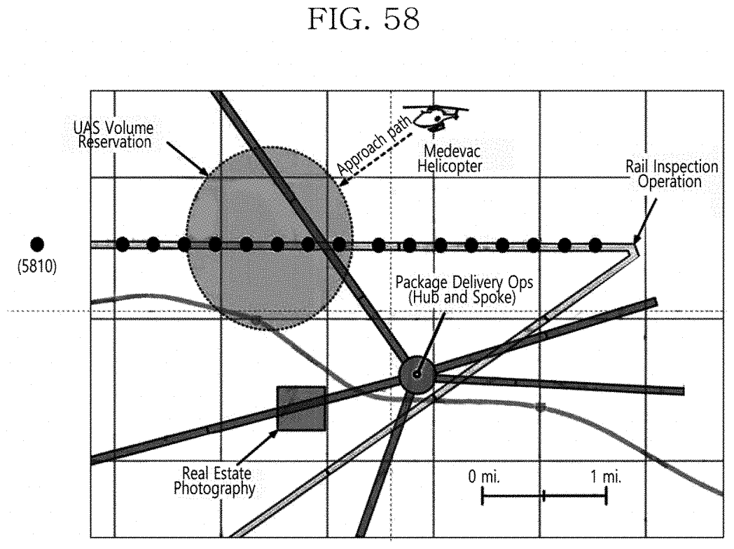

FIG. 58 is a view illustrating that a flight path recommended to the UAM is represented by way points 5810 at every interval according to an embodiment.

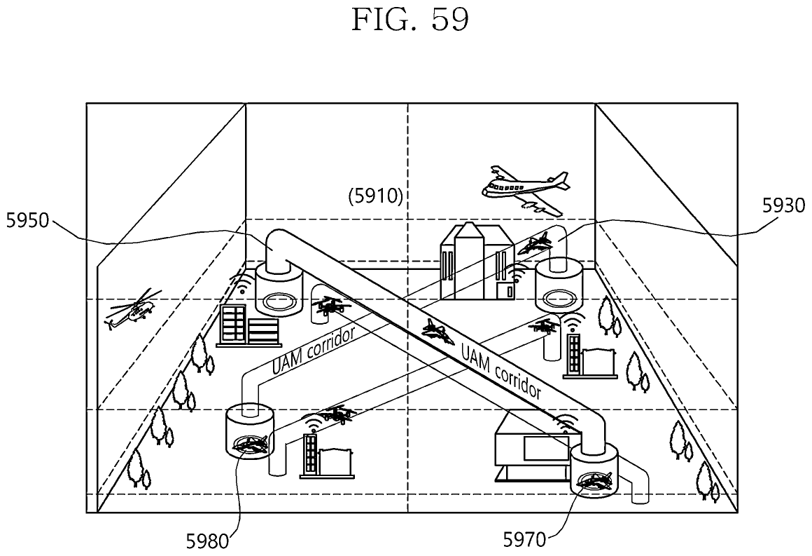

FIG. 59 is a view illustrating that flight passages 5930 and 5950 having different flight altitudes are set to every UAM departing from vertiports 5970 and 5980 according to an embodiment. The flight passages 5930 and 5950 of the UAM are desirably set so as not to collide with the flight route 5910 of a commercial aircraft which flies at a high altitude.

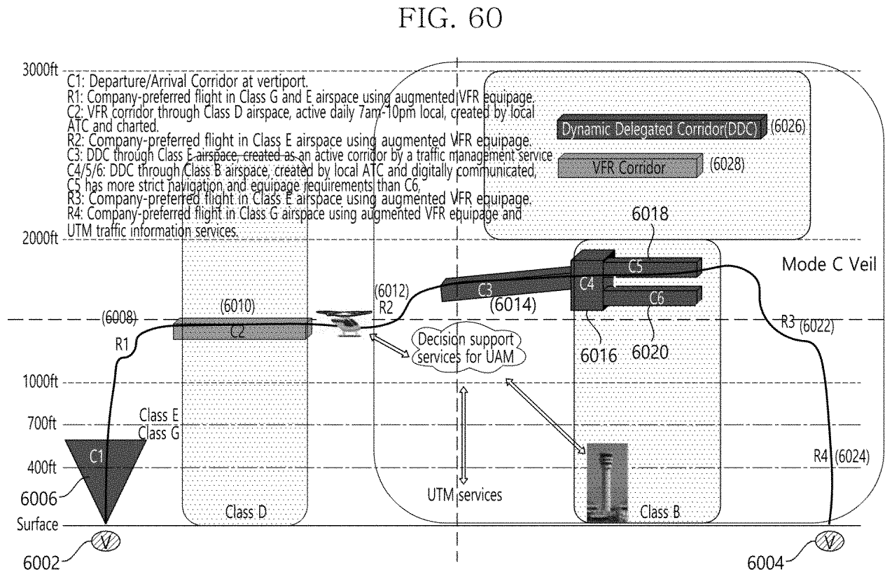

FIG. 60 is a view illustrating a flight route allocated to an UAM flying between vertiports 6002 and 6004 according to an embodiment.

In FIG. 60, reference numbers 6002 and 6004 denote vertiports where the UAM may take off/land and reference number 6006 denotes a flight corridor set to allow the UAM to take off/land on the vertiport 6002.

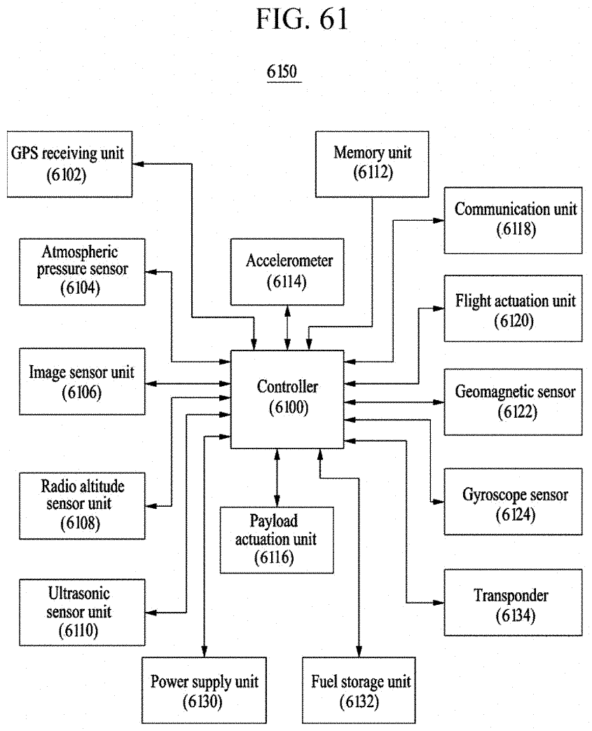

FIG. 61 is a block diagram illustrating a configuration of an unmanned aerial vehicle according to an embodiment.

Referring to FIG. 61, an unmanned aerial vehicle 6150 according to another embodiment may include a controller 6100, a GPS receiving unit 6102, an atmospheric pressure sensor 6104, an image sensor unit 6106, a radio altitude sensor unit 6108, an ultrasonic sensor unit 6110, a memory unit 6112, an accelerometer 6114, a payload actuation unit 6116, a communication unit 6118, a flight actuation unit 6120, a geomagnetic sensor 6122, and a gyroscope sensor 6124.

The GPS receiving unit 6102 may receive a signal from a GPS satellite and may measure a current location of the unmanned aerial vehicle 6150. The controller 6100 may ascertain a location of the unmanned aerial vehicle 6150 using the current location of the unmanned aerial vehicle 6150. The controller 6100 may include at least one central processing unit (CPU) which is a general purpose processor and/or a dedicated processor such as an application specific integrated circuit (ASIC), a field-programmable gate way (FPGA), or a digital signal processor (DSP).

The atmospheric pressure sensor 6104 may measure an atmospheric pressure around the unmanned aerial vehicle 6150 and may transmit the measured value to the controller 6100 to measure a flight altitude of the unmanned aerial vehicle 6150.

The image sensor unit 6106 may capture objects via optical equipment such as a camera, may convert an optical image signal incident from the captured image into an electric image signal, and may transmit the converted electric image signal to the controller 6100.

The radio altitude sensor unit 6108 may transmit microwaves to the earth's surface and may measure a distance based on a time of arrival (TOA) according to a signal reflected from the earth's surface, thus transmitting the measured value to the controller 6100. An ultrasonic sensor unit a synthetic aperture radar (SAR) may be used as the radio altitude sensor unit 6108. Thus, the controller 3000 of the unmanned aerial vehicle 6150 may observe a ground object and the earth's surface concurrently with measuring an altitude using the radio altitude sensor unit 6108.

The ultrasonic sensor unit 6110 may include a transmitter which transmits ultrasonic waves and a receiver which receives ultrasonic waves, and may measure a time until transmitted ultrasonic waves are received and may transmit the measured time to the controller 6100. Thus, the controller 6100 may ascertain whether there is an object around the unmanned aerial vehicle 6150. Therefore, if there is an obstacle around the unmanned aerial vehicle 6150 through a value measured by the ultrasonic sensor unit 6110, the controller 6100 may control the flight actuation unit 6120 for collision avoidance to control a location and speed.

The memory unit 6112 may store information (e.g., program instructions) necessary for an operation of the unmanned aerial vehicle 6150, a route map, flight information associated with autonomous flight, and a variety of flight information ascertained during flight. Also, the memory unit 6112 may store resolution height information measured for each way point and a value measured by the radio altitude sensor unit 6108.

The accelerometer 6114 may be a sensor which measures acceleration of the unmanned aerial vehicle 6150, and may measure acceleration of an x-, y-, and z-axis direction and may transmit the measured acceleration to the controller 6100.

The communication unit 6118 may communicate with a ground control center and a company which operates the unmanned aerial vehicle 6150 through wireless communication and may transmit and receive flight information and control information on a periodic basis with the control center and the company. Also, the communication unit 6118 may access a mobile communication network via a base station around the unmanned aerial vehicle 6150 and may communicate with the control center or the company. The controller 6100 may communicate with an operation system or a control system via the communication unit 6118. If a remote control command is received from the operation system, the controller 6100 may transmit a control signal for controlling flight of the unmanned aerial vehicle 6150 to the flight actuation unit 6120 or may provide a control signal for actuating the payload actuation unit 6116 to the payload actuation unit 6116 to collect or deliver an object, based on the received remote control command.

Further, the controller 6100 may transmit an image collected by the image sensor unit 6106 to the operation system or the control system via the communication unit 6118.

The geomagnetic sensor 6122 may be a sensor which measures the earth's magnetic field and may transmit the measured value to the controller 6100 to be used to measure an orientation of the unmanned aerial vehicle 6150.

A gyro sensor 6124 may measure an angular speed of the unmanned aerial vehicle 6150 and may transmit the measured value to the controller 6100. The controller 6100 may measure a tilt of the unmanned aerial vehicle 6150.

The controller 6100 may control overall functions of the unmanned aerial vehicle 6150 according to an embodiment. The controller 6100 may perform overall control such that the unmanned aerial vehicle 3050 flies along corridors stored in the memory unit 6112 and may compare an altitude value measured by the radio altitude sensor unit 6108 with a resolution height obtained by the image sensor unit 6106 per predetermined way point. Although there is a ground object on a way point, the controller 6100 may allow the unmanned aerial vehicle 6150 to maintain a specified flight altitude.

The controller 6100 may control the payload actuation unit 6116 to drop or collect a cargo based on a cargo delivery manner of the unmanned aerial vehicle 3050 when the unmanned aerial vehicle 6150 collects or deliver the cargo loaded into a payload of the unmanned aerial vehicle 6150 from or to a specific point.

In this case, if a hoist is included in the payload actuation unit 6116 of the unmanned aerial vehicle 6150, when the unmanned aerial vehicle 6150 drops or collects the cargo, the controller 6100 may control the payload actuation unit 6116 to lower the cargo to a delivery point or collect the cargo from a collection point using the hoist. In detail, the unmanned aerial vehicle 6150 may deliver the cargo by lowering a rope to the cargo is fixed by a distance between a flight altitude and a delivery point to deliver the cargo to the delivery point using the hoist while maintaining the flight altitude corresponding to a specified layer. After lowering the rope by a distance between a flight altitude and a collection point in case of collecting the cargo, if verifying that the cargo is fixed to a hook of the rope, the controller 6100 may control the payload actuation unit 6116 such that the hoist winds up the rope.

Further, the controller 6100 may control the flight actuation unit 6120 to control a lift force and a flight speed of the unmanned aerial vehicle 6150. The controller 6100 may control the flight actuation unit 6120 such that a current flight altitude does not depart from a specified layer in consideration of a flight altitude measured by the radio altitude sensor unit 6108 and a resolution height.

The controller 6100 may control the flight actuation unit 6120 to move to a layer changeable zone. After moving to the layer changeable zone, the controller 6100 may control the flight actuation unit 6120 such that the unmanned aerial vehicle 6150 performs flight for a layer change procedure based on information included in layer movement information after the unmanned aerial vehicle 6150 moves to the layer changeable zone.

The flight actuation unit 6120 may generate a lift force and a flight force of the unmanned aerial vehicle 6150 and may include a plurality of propellers, a motor for adjusting each of the plurality of propellers, or an engine. The flight actuation unit 6120 may maintain a movement direction, an attitude, and a flight altitude of the unmanned aerial vehicle 6150 by adjusting a roll, a yaw, and a pitch which is three movement directions of the unmanned aerial vehicle 6150 based on control of the controller 6100.

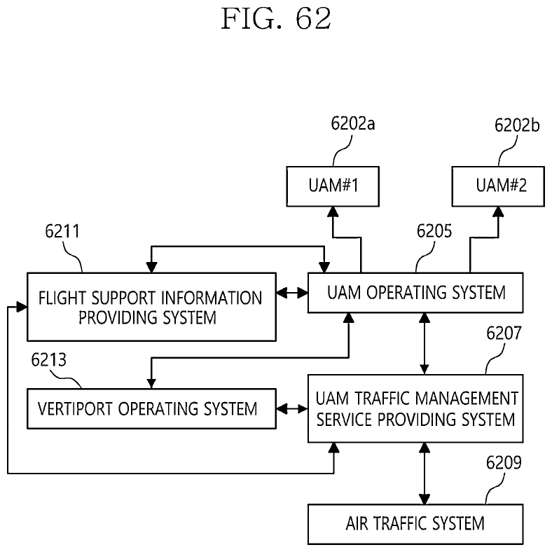

FIG. 62 is a view for describing an architecture of a system for managing flight of an UAMs 6202a and 6202b according to an embodiment.

An UAM operating system 6205 provides a service for transporting passengers or cargo for a fee using an UAM aircraft in accordance with a customer demand. The UAM operating system 6205 needs to comply with the matters presented in the operation certificate and operation specifications. The UAM operating system 6205 is responsible for all aspects of actual UAM operations including maintaining of airworthiness of an UAM fleet. Further, the UAM operating system 6205 is responsible for establishment, submission, and sharing of flight plans, sharing of status information (flight preparation, take-off, cruising, landing, normal, malfunction, defect) of the UAM fleet, UAM aircraft security management, ground service, passenger reservation, boarding, and safety management. The UAM operating system 6205 needs to reflect an emergency landing site in accordance with the regulations to the flight plan in preparation for an emergency situation. The UAM operating system 6205 shares status and performance information of the UAM aircraft which is being operated with relevant stakeholders through an UAM traffic management service providing system 6207.

The UAM traffic management service providing system 6207 provides a traffic management service to allow an UAM operating system 6205 to safely and efficiently operate in the UAM corridor and to this end, builds, operates, and maintains navigational Aid (excluding a vertiport related facility) around the corridor. When the UAM aircraft leaves the corridor during the navigation, the UAM traffic management service providing system 6207 immediately transmits the related information to the air traffic control system 6209. In this case, when the left airspace corresponds to the controlled airspace, the traffic control task of the corresponding UAM aircraft may be supervised by the air traffic control system 6209. If necessary, a plurality of UAM traffic management service providing systems may provide UAM traffic management service of the same area or corridor.

The UAM traffic management service providing system 6207 consistently shares operational safety information such as an UAM aircraft operating state in the corridor, whether there is airspace restrictions, or weather conditions with the UAM operating system 6205 and related stakeholders. When it is necessary to tactically separate due to an abnormal situations according to an UAM operation, the UAM traffic management service providing 6 system 6207 cooperates with the UAM operating system 6205 or captains and supports rapid separation and evasion response. The UAM traffic management service providing system 6207 confirms a vertiport availability (FATO or a landing field) from the vertiport operating system 6213 or to safely land the UAM aircraft to share the information with the related stakeholders. If necessary, the UAM traffic management service providing system 6207 shares operating safety information with an air traffic controller and an UAS traffic management service provider. The UAM traffic management service providing system 6207 may store operating information collected for public purposes, such as system establishment, improvement and accident investigation. The UAM traffic management service providing system 6207 may share this information through a network between PSU.

The UAM traffic management service providing system 6207 determines whether to approve a flight plan presented by the UAM operator using the operating safety information. The UAM traffic management service provide system 6207 shares various information such as a flight plan with the other UAM traffic management service providing system through a network between PSU and mediates the flight plan. If necessary, the UAM traffic management service providing system 6207 shares and mediates the flight plan with the UAS traffic management service provider. The UAM traffic management service providing system 6207 constantly monitors the track, speed, and flight plan conformity of the UAM aircraft. When the inconsistent matter is found, follow-up actions are notified to the corresponding UAM aircraft and the information is shared with the air traffic controllers, the UAM operating system 6205, the other UAM traffic management service providing system, and vertiport operating system 6213.

Further, the UAM traffic management service providing system 6213 or the UAM operating system 6205 collect a scheduled flight route of each UAM through the communication between UAMs and this is transmitted to the UAM which is being flied to allow the UAM to avoid the collision possibility during the flight and visually separate the flight route of the other UAM to represent with the AR indication line.

The flight support information providing system 6211 provides flight support information such as terrain, obstacles, weather conditions, weather forecast information, and UAM operation noise situations to the related stakeholders such as UAM operating system 6205 and the UAM traffic management service providing system 6207 for the purpose of safe and efficient UAM operation and traffic management. This information is updated to be provided even during flight, as well as a flight plan stage.

Further, in one embodiment, a system which makes a reservation of boarding the UAM and makes a payment of the UAM may be implemented with a mobile device such as a smart phone of the user.

If a user searches for a point (destination) to move using a mobile device connected to a server, the server searches an UAM which is scheduled to fly to a destination among ports located around the user and then provides information about a position of the UAM and a position of a port where the user boards and a departure time to the mobile device of the user.

The UAM operating system 6205 according to the embodiment of the present invention may be installed and operated in the unit of urban area or installed and operated nationwide.

Basically, even though the UAM is likely to be manufactured to be manned controlled, in the future, it is more likely to be developed to be autonomously flied or remotely controlled to load more passengers/cargo.

For the purpose the stable flight of the UAM and status monitoring of the UAM, the UAM operating system 6205 builds a communication infrastructure in each flight zone to enable direct communication with each UAM or share data through a data link for communication between UAMs, or configures the ad hoc network in which an UAM which is closest to the UAM operating system 6205 provides this data to the UAM operating system 6205.

Further, in order to provide the UAM service, the service providing system which provides an UAM boarding service not only includes a financial infrastructure to enable the payment for an UAM boarding service on the user's mobile device, but also provides the information related to the UAM reservation and boarding to the user. By doing this, the user may confirm information such as a port location of the UAM to board, a boarding time, and a scheduled arrival time to the destination through the UX of the mobile device.

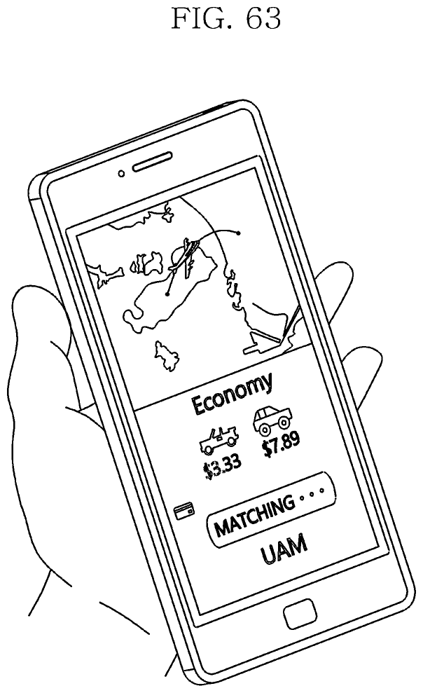

FIG. 63 is a view illustrating an UX screen for reserving an UAM operating to a location desired by a user through an electronic device according to an embodiment.

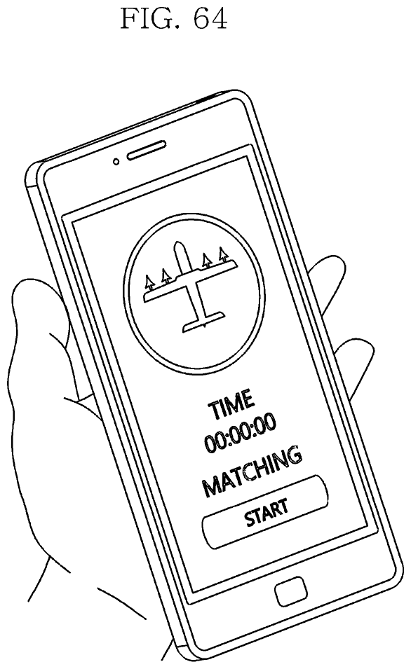

FIG. 64 is a view illustrating an UX screen for providing information related to an UAM reserved by a user through an electronic apparatus according to an embodiment.

The device described above may be implemented as a hardware component, a software component, and/or a combination of hardware components and software components. For example, the devices and components described in the embodiments may be implemented using one or more general purpose computers or special purpose computers such as processor, controller, ALU (arithmetic logic unit), digital signal processor, microcomputer, FPGA (field programmable gate array), PLU (programmable logic unit), microprocessor or any other device capable of executing and responding to instructions. The processing device may perform an operating system (OS) and one or more software applications performed on the operating system. In addition, the processing device may access, store, manipulate, process, and generate data in response to execution of the software. For convenience of understanding, although it may be described that one processing device is used, a person skilled in the art may see that the processing device may include a plurality of processing elements and/or a plurality of types of processing elements. For example, the processing device may include a plurality of processors or one processor and one controller. In addition, other processing configurations such as parallel processors are possible.

The software may comprise a computer program, code, instruction, or a combination of one or more of these, configure the processing device to operate as desired, or command the processing device independently or collectively. Software and/or data may be embodied in any type of machine, component, physical device, computer storage medium, or device to be interpreted by a processing device or to provide instructions or data to a processing device. The software may be distributed on networked computer systems and stored or executed in a distributed manner Software and data may be stored in one or more computer-readable recording media.

What is claimed is:

1. A method for providing a parking lot guidance service of an image capturing apparatus for a vehicle, comprising:
obtaining a parking lot image according to image capturing;
generating parking lot data including information of a parking space in a parking lot using the parking lot image; and
transmitting the generated parking lot data to a server for providing a parking lot guidance service,
wherein the parking lot data is used to generate a parking lot model for service provision in the server for providing a parking lot guidance service.

2. The method for providing a parking lot guidance service of claim 1, wherein the generating of the parking lot data includes:
recognizing a location identifier making a location of the parking space in the parking lot identifiable and a parked vehicle parked in the parking space from the parking lot image;
generating location information of the parking space based on the recognized location identifier; and
generating information on whether or not the vehicle has been parked in a parking slot included in the parking space according to a location of the recognized parked vehicle.

3. The method for providing a parking lot guidance service of claim 2, wherein the generating of the parking lot data further includes: generating parked vehicle information including at least one of vehicle type information and vehicle number information for the recognized parked vehicle, and
the parked vehicle information is generated separately for each of a plurality of parking slots constituting the parking space.

4. The method for providing a parking lot guidance service of claim 1, further comprising determining whether or not the parking lot data needs to be updated by sensing a change in the parking lot image as a parked vehicle exits from a parking slot included in the parking space or another vehicle enters a parking slot included in the parking space.

5. The method for providing a parking lot guidance service of claim 1, further comprising:
determining whether or not an impact event has occurred in a parked vehicle parked in the surrounding of an own vehicle;
updating the parking lot data when it is determined that the impact event has occurred in the parked vehicle; and
transmitting the updated parking lot data to the server for providing a parking lot guidance service,
wherein the updated parking lot data includes data a predetermined time before and after an occurrence point in time of the impact event.

6. An image capturing apparatus for a vehicle, comprising:
a communication unit;
an image capturing unit obtaining a parking lot image according to image capturing;
a parking lot data generation unit generating parking lot data including information of a parking space in a parking lot using the parking lot image; and
a control unit controlling the communication unit to transmit the generated parking lot data to a server for providing a parking lot guidance service,
wherein the parking lot data is used to generate a parking lot model for service provision in the server for providing a parking lot guidance service.

7. The image capturing apparatus for a vehicle of claim 6, wherein the parking lot data generation unit includes:
an image processor recognizing a location identifier making a location of the parking space in the parking lot identifiable and a parked vehicle parked in the parking space from the parking lot image; and
a parking lot location information generator generating location information of the parking space based on the recognized location identifier and generating information on whether or not the vehicle has been parked in a parking slot included in the parking space according to a location of the recognized parked vehicle.

8. The image capturing apparatus for a vehicle of claim 7, wherein the parking lot data generation unit further includes: a parked vehicle information generator generating parked vehicle information including at least one of vehicle type information and vehicle number information for the recognized parked vehicle, and
the parked vehicle information is generated separately for each of a plurality of parking slots constituting the parking space.

9. The image capturing apparatus for a vehicle of claim 6, wherein the control unit determines whether or not the parking lot data needs to be updated by sensing a change in the parking lot image as a parked vehicle exits from a parking slot included in the parking space or another vehicle enters a parking slot included in the parking space.

10. The image capturing apparatus for a vehicle of claim 6, wherein the control unit determines whether or not an impact event has occurred in a parked vehicle parked in the surrounding of an own vehicle, controls the parking lot data generation unit to update the parking lot data when it is determined that the impact event has occurred in the parked vehicle, and controls the communication unit to transmit the updated parking lot data to the server for providing a parking lot guidance service, and
the updated parking lot data includes data a predetermined time before and after an occurrence point in time of the impact event.

11. A method for providing a parking lot guidance service of a server, comprising:
receiving parking lot data including information of a parking space in a parking lot from an image capturing apparatus for a vehicle provided in the vehicle;
generating a parking lot model representing a real-time parking situation of the parking lot as an image based on the received parking lot data; and
providing the parking guidance service to a user terminal apparatus using the generated parking lot model.

12. The method for providing a parking lot guidance service of claim 11, wherein the information of the parking space includes location information of the parking space and information on whether or not a vehicle has been parked in a parking slot constituting the parking space, and
the generating of the parking lot model includes:
determining a location of the parking space in the parking lot based on the location information of the parking space;
determining whether or not to dispose a vehicle model in the parking slot based on the information on whether or not the vehicle has been parked in the parking slot; and
generating a parking lot model in which the vehicle model is disposed in the parking slot according to a determination result.

13. The method for providing a parking lot guidance service of claim 12, wherein the parking lot data includes parked vehicle information including at least one of type information of a parked vehicle and number information of the parked vehicle, and
the generating of the parking lot model further includes:
generating a vehicle model reflecting at least one of a license plate and a vehicle type based on the parked vehicle information.

14. The method for providing a parking lot guidance service of claim 11, wherein the generated parking lot model is a three-dimensional (3D) model.

15. The method for providing a parking lot guidance service of claim 11, further comprising updating the generated parking lot model,
wherein in the updating, the parking lot model is updated by extracting only a difference portion between the generated parking lot model and a subsequently generated parking lot model and reflecting only the extracted difference portion.

16. The method for providing a parking lot guidance service of claim 11, wherein the providing of the parking guidance service includes:
detecting the parking lot model and the parking lot data corresponding to a parking lot in which a vehicle of a user of the user terminal apparatus that has accessed the server is parked; and
providing at least one of a parking possible location guidance service, a vehicle parking location guidance service, and a parking lot route guidance service to the user terminal apparatus using the detected parking lot model and parking lot data.

17. The method for providing a parking lot guidance service of claim 11, wherein the providing of the parking guidance service includes:
transmitting a first vehicle impact event occurrence notification to an image capturing apparatus for a vehicle of a second vehicle located in the surrounding of a first vehicle parked in the parking lot when an impact event occurs in the first vehicle;
receiving parking data from the image capturing apparatus for a vehicle of the second vehicle according to the notification;
generating impact information on an impact situation of the first vehicle based on the parking data from the image capturing apparatus for a vehicle of the second vehicle; and
providing a parking impact event guidance service based on the generated impact information.

18. A server for providing a parking lot guidance service, comprising:
a communication unit receiving parking lot data including information of a parking space in a parking lot from an image capturing apparatus for a vehicle provided in the vehicle;
a parking lot model generation unit generating a parking lot model representing a real-time parking situation of the parking lot as an image based on the received parking lot data; and
a control unit providing the parking guidance service to a user terminal apparatus using the generated parking lot model.

19. The server for providing a parking lot guidance service of claim 18, wherein the information of the parking space includes location information of the parking space and information on whether or not a vehicle has been parked in a parking slot constituting the parking space, and
the parking lot model generation unit
determines a location of the parking space in the parking lot based on the location information of the parking space,
determines whether or not to dispose a vehicle model in the parking slot based on the information on whether or not the vehicle has been parked in the parking slot, and
generates a parking lot model in which the vehicle model is disposed in the parking slot according to a determination result.

20. The server for providing a parking lot guidance service of claim 19, wherein the parking lot data includes parked vehicle information including at least one of type information of a parked vehicle and number information of the parked vehicle, and
the parking lot model generation unit generates a vehicle model reflecting at least one of a license plate and a vehicle type based on the parked vehicle information.
